(19) United States
(12) Patent Application Publication
(10) Pub. No.: US 2026/0050140 A1
(43) Pub. Date: Feb. 19, 2026

(54) IMAGING OPTICAL LENS ASSEMBLY, IMAGE CAPTURING UNIT AND ELECTRONIC DEVICE

(71) Applicant: LARGAN PRECISION CO., LTD., Taichung City (TW)

(72) Inventors: Yu Jui LIN, Taichung City (TW); Yu-Han SHIH, Taichung City (TW)

(73) Assignee: LARGAN PRECISION CO., LTD., Taichung City (TW)

(21) Appl. No.: 18/898,657

(22) Filed: Sep. 26, 2024

(30) Foreign Application Priority Data
Aug. 14, 2024 (TW) 113130544

(51) Int. Cl. G02B 13/00; G02B 9/64; G03B 30/00

(52) U.S. Cl. CPC G02B 13/0045; G02B 9/64; G02B 13/0065; G03B 30/00

(57) ABSTRACT

An imaging optical lens assembly includes seven lens elements which are, in order from an object side to an image side along an optical path: a first lens element, a second lens element, a third lens element, a fourth lens element, a fifth lens element, a sixth lens element and a seventh lens element. The first lens element has positive refractive power. The second lens element has an object-side surface being convex in a paraxial region thereof. The fourth lens element with positive refractive power has an image-side surface being convex in a paraxial region thereof. The fifth lens element has an image-side surface being convex in a paraxial region thereof and having at least one inflection point.

### RELATED APPLICATIONS

This application claims priority to Taiwan Application 113130544, filed on Aug. 14, 2024, which is incorporated by reference herein in its entirety.

### BACKGROUND

### Technical Field

The present disclosure relates to an imaging optical lens assembly, an image capturing unit and an electronic device, more particularly to an imaging optical lens assembly and an image capturing unit applicable to an electronic device.

### Description of Related Art

With the development of semiconductor manufacturing technology, the performance of image sensors has improved, and the pixel size thereof has been scaled down. Therefore, featuring high image quality becomes one of the indispensable features of an optical system nowadays.

In recent years, the trend in electronic products has been towards slimmer and lighter designs, making it difficult for conventional camera lenses to meet the demands for both high specifications and miniaturization, especially in the case of micro lenses with large apertures or telephoto features. Conventional telephoto lens technologies are gradually becoming insufficient to meet the requirements (e.g., total length being too long, aperture being too small, lacking in quality, or not being compact enough). Therefore, different optical features or configurations with optical axis folding are required to overcome these challenges. Due to the thickness limitations of electronic devices, some optical systems are cut in the lens barrel or lens elements to reduce the length in a single axial direction, which helps save space in the module. Additionally, reflective elements can be utilized to provide different optical path directions in the optical system, providing the lens with more flexible space to achieve the telephoto effect of a long focal length.

As technology rapidly advances, electronic devices equipped with optical systems are trending towards multi-functionality for various applications, and therefore the functionality requirements for the optical systems have been increasing. However, it is difficult for conventional optical systems to obtain a balance between image quality, sensitivity, aperture size, size, or field of view. Therefore, the present disclosure provides an optical system equipped with a reflective element and achieves high image quality for both distant and close-up photography through the design of lens groupings, which not only meets market demands but also enhances the flexibility of the lens in capturing images.

### SUMMARY

According to one aspect of the present disclosure, an imaging optical lens assembly includes seven lens elements. The seven lens elements are, in order from an object side to an image side along an optical path, a first lens element, a second lens element, a third lens element, a fourth lens element, a fifth lens element, a sixth lens element and a seventh lens element. Each of the seven lens elements has an object-side surface facing toward the object side and an image-side surface facing toward the image side.

Preferably, the first lens element has positive refractive power. Preferably, the object-side surface of the second lens element is convex in a paraxial region thereof. Preferably, the fourth lens element has positive refractive power. Preferably, the image-side surface of the fourth lens element is convex in a paraxial region thereof. Preferably, the image-side surface of the fifth lens element is convex in a paraxial region thereof. Preferably, the image-side surface of the fifth lens element has at least one inflection point. When an imaged object is located at an infinite object distance, the imaging optical lens assembly is in a first state.

When a sum of central thicknesses of all lens elements of the imaging optical lens assembly is ΣCT, a central thickness of the first lens element is CT1, a sum of axial distances between each of all adjacent lens elements of the imaging optical lens assembly is ΣAT, an axial distance between the first lens element and the second lens element is T12, an axial distance between the object-side surface of the second lens element and an image surface is Dr3i, an axial distance between the image-side surface of the seventh lens element and the image surface is BL, a focal length of the imaging optical lens assembly in the first state is fL, and a composite focal length of the second lens element, the third lens element and the fourth lens element is f234, the following conditions are preferably satisfied:

$$0.4 < \sum CT / \sum AT < 1.58 ;$$

$$1.1 < Dr 3 i / BL < 3.5 ;$$

$$0.5 < fL / f 234 < 2.3 ; and$$

$$0.05 < T 12 / CT 1 < 6.00 .$$

According to another aspect of the present disclosure, an imaging optical lens assembly includes seven lens elements. The seven lens elements are, in order from an object side to an image side along an optical path, a first lens element, a second lens element, a third lens element, a fourth lens element, a fifth lens element, a sixth lens element and a seventh lens element. Each of the seven lens elements has an object-side surface facing toward the object side and an image-side surface facing toward the image side.

Preferably, the first lens element has positive refractive power. Preferably, the object-side surface of the first lens element is convex in a paraxial region thereof. Preferably, the fifth lens element has negative refractive power. Preferably, the object-side surface of the fifth lens element is concave in a paraxial region thereof. Preferably, the image-side surface of the fifth lens element is convex in a paraxial region thereof. Preferably, the image-side surface of the fifth lens element has at least one inflection point.

When a sum of central thicknesses of all lens elements of the imaging optical lens assembly is ΣCT, a sum of axial distances between each of all adjacent lens elements of the imaging optical lens assembly is ΣAT, an axial distance between the object-side surface of the second lens element and an image surface is Dr3i, an axial distance between the image-side surface of the seventh lens element and the image surface is BL, a curvature radius of the image-side surface of the third lens element is R6, a curvature radius of the image-side surface of the fourth lens element is R8, a focal length of the first lens element is f1, a focal length of the fourth lens element is f4, and a focal length of the fifth lens element is f5, the following conditions are preferably satisfied:

$$0.6 < \sum CT / \sum AT < 1.58 ;$$

$$1.1 < Dr 3 i / BL < 3.5 ;$$

$$- 5. < R 6 / R 8 < - 0.05 ; and$$

$$- 2.5 \; 0 < ( f 4 + f 5 ) / f 1 < 1.2 .$$

According to another aspect of the present disclosure, an image capturing unit includes one of the aforementioned imaging optical lens assemblies and an image sensor, wherein the image sensor is disposed on the image surface of the imaging optical lens assembly.

According to another aspect of the present disclosure, an electronic device includes the aforementioned image capturing unit.

### BRIEF DESCRIPTION OF THE DRAWINGS

The disclosure can be better understood by reading the following detailed description of the embodiments, with reference made to the accompanying drawings as follows:

FIG. 1 is a schematic view of an image capturing unit respectively in a first state and a second state according to the 1st embodiment of the present disclosure;

FIG. 2 shows spherical aberration curves, astigmatic field curves and a distortion curve of the image capturing unit in the first state according to the 1st embodiment;

FIG. 3 shows spherical aberration curves, astigmatic field curves and a distortion curve of the image capturing unit in the second state according to the 1st embodiment;

FIG. 4 is a schematic view of an image capturing unit respectively in a first state and a second state according to the 2nd embodiment of the present disclosure;

FIG. 5 shows spherical aberration curves, astigmatic field curves and a distortion curve of the image capturing unit in the first state according to the 2nd embodiment;

FIG. 6 shows spherical aberration curves, astigmatic field curves and a distortion curve of the image capturing unit in the second state according to the 2nd embodiment;

FIG. 7 is a schematic view of an image capturing unit respectively in a first state and a second state according to the 3rd embodiment of the present disclosure;

FIG. 8 shows spherical aberration curves, astigmatic field curves and a distortion curve of the image capturing unit in the first state according to the 3rd embodiment;

FIG. 9 shows spherical aberration curves, astigmatic field curves and a distortion curve of the image capturing unit in the second state according to the 3rd embodiment;

FIG. 10 is a schematic view of an image capturing unit respectively in a first state and a second state according to the 4th embodiment of the present disclosure;

FIG. 11 shows spherical aberration curves, astigmatic field curves and a distortion curve of the image capturing unit in the first state according to the 4th embodiment;

FIG. 12 shows spherical aberration curves, astigmatic field curves and a distortion curve of the image capturing unit in the second state according to the 4th embodiment;

FIG. 13 is a schematic view of an image capturing unit respectively in a first state and a second state according to the 5th embodiment of the present disclosure;

FIG. 14 shows spherical aberration curves, astigmatic field curves and a distortion curve of the image capturing unit in the first state according to the 5th embodiment;

FIG. 15 shows spherical aberration curves, astigmatic field curves and a distortion curve of the image capturing unit in the second state according to the 5th embodiment;

FIG. 16 is a schematic view of an image capturing unit respectively in a first state and a second state according to the 6th embodiment of the present disclosure;

FIG. 17 shows spherical aberration curves, astigmatic field curves and a distortion curve of the image capturing unit in the first state according to the 6th embodiment;

FIG. 18 shows spherical aberration curves, astigmatic field curves and a distortion curve of the image capturing unit in the second state according to the 6th embodiment;

FIG. 19 is a schematic view of an image capturing unit respectively in a first state and a second state according to the 7th embodiment of the present disclosure;

FIG. 20 shows spherical aberration curves, astigmatic field curves and a distortion curve of the image capturing unit in the first state according to the 7th embodiment;

FIG. 21 shows spherical aberration curves, astigmatic field curves and a distortion curve of the image capturing unit in the second state according to the 7th embodiment;

FIG. 22 is a schematic view of an image capturing unit respectively in a first state and a second state according to the 8th embodiment of the present disclosure;

FIG. 23 shows spherical aberration curves, astigmatic field curves and a distortion curve of the image capturing unit in the first state according to the 8th embodiment;

FIG. 24 shows spherical aberration curves, astigmatic field curves and a distortion curve of the image capturing unit in the second state according to the 8th embodiment;

FIG. 25 is a schematic view of an image capturing unit respectively in a first state and a second state according to the 9th embodiment of the present disclosure;

FIG. 26 shows spherical aberration curves, astigmatic field curves and a distortion curve of the image capturing unit in the first state according to the 9th embodiment;

FIG. 27 shows spherical aberration curves, astigmatic field curves and a distortion curve of the image capturing unit in the second state according to the 9th embodiment;

FIG. 28 is a perspective view of an image capturing unit according to the 10th embodiment of the present disclosure;

FIG. 29 is one perspective view of an electronic device according to the 11th embodiment of the present disclosure;

FIG. 30 is another perspective view of the electronic device in FIG. 29;

FIG. 31 is a block diagram of the electronic device in FIG. 29;

FIG. 32 is one schematic view of an electronic device according to the 12th embodiment of the present disclosure;

FIG. 33 is another schematic view of the electronic device in FIG. 32;

FIG. 34 is one perspective view of an electronic device according to the 13th embodiment of the present disclosure;

FIG. 35 shows a schematic view of ET6L, ET7L, SAG7R1L, SAG7R2L, Y6R2L and Y7R1L as the image capturing unit is in the first state according to the 1st embodiment of the present disclosure;

FIG. 36 shows a schematic view of inflection points and critical points on lens surfaces as the image capturing unit is in the first state according to the 1st embodiment of the present disclosure;

FIG. 37 shows a schematic view of a configuration of reflective elements and its associated light path folding in the image capturing unit in the first state according to the 1st embodiment;

FIG. 38 shows a schematic view of another configuration of reflective elements and its associated light path folding in the image capturing unit in the first state according to the 1st embodiment;

FIG. 39 shows a schematic view of a shape of an aperture stop according to the present disclosure;

FIG. 40 shows a schematic view of another shape of an aperture stop according to the present disclosure;

FIG. 41 to FIG. 43 each shows a schematic view of a configuration of one reflective element in an imaging optical lens assembly according to one embodiment of the present disclosure; and

FIG. 44 and FIG. 45 each shows a schematic view of a configuration of two reflective elements in an imaging optical lens assembly according to one embodiment of the present disclosure.

### DETAILED DESCRIPTION

An imaging optical lens assembly includes seven lens elements. The seven lens elements are, in order from an object side to an image side along an optical path, a first lens element, a second lens element, a third lens element, a fourth lens element, a fifth lens element, a sixth lens element and a seventh lens element. Each of the seven lens elements of the imaging optical lens assembly has an object-side surface facing toward the object side and an image-side surface facing toward the image side.

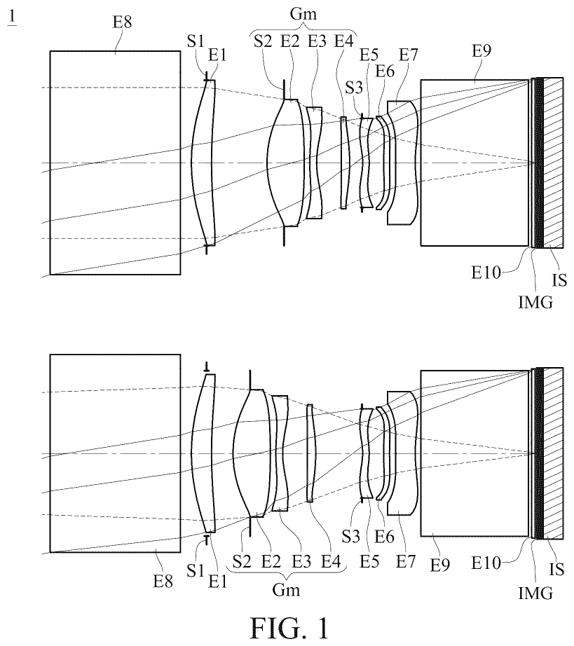

When an imaged object is located at an infinite object distance, the imaging optical lens assembly is in a first state. When an imaged object is located at a finite object distance, the imaging optical lens assembly is in a second state. When an imaged object is moved from an infinite object distance to a finite object distance within 150 mm, some of the seven lens elements in the imaging optical lens assembly are moved along an optical axis for focus adjustment, and the imaging optical lens assembly is transitioned from the first state to the second state. Therefore, it is favorable for saving the module space for the imaging optical lens assembly while enabling both long-distance and close-up photography functions, thereby increasing the product application range. Conversely, when an imaged object is moved from a finite object distance within 150 mm to an infinite object distance, some of the seven lens elements in the imaging optical lens assembly are moved along the optical axis for focus adjustment, and the imaging optical lens assembly is transitioned from the second state to the first state. Said object distance refers to an axial distance from an imaged object to the object-side surface of a lens element closest to the object side in the imaging optical lens assembly (i.e., the object-side surface of the first lens element). Moreover, the finite object distance can be within 100 mm. Moreover, the finite object distance can be within 80 mm. When an object distance is greater than 10000 mm, it can be considered as an infinite object distance capturing condition. Please refer to FIG. 1, which is a schematic view of an image capturing unit respectively in a first state (infinite object distance) and a second state (finite object distance) according to the 1st embodiment of the present disclosure, where the upper part of FIG. 1 is a schematic view of the imaging optical lens assembly in the first state, and the lower part of FIG. 1 is a schematic view of the imaging optical lens assembly in the second state.

According to the present disclosure, the imaging optical lens assembly can further include a reflective element located along the optical path between an imaged object and the first lens element. Therefore, it is favorable for providing different optical path directions for the imaging optical lens assembly, making spatial configuration more flexible, facilitating miniaturization, and reducing mechanical constraints. Moreover, the imaging optical lens assembly can further include another reflective element located along the optical path between the seventh lens element and an image surface. Therefore, it is favorable for providing different optical path directions for the imaging optical lens assembly, achieving space-saving and having telephoto effect of a long focal length.

The first lens element can have positive refractive power. Therefore, it is favorable for reducing the size of the imaging optical lens assembly and controlling the shooting angle of view. The object-side surface of the first lens element can be convex in a paraxial region thereof. Therefore, it is favorable for enhancing the light converging capability of the first lens element, thereby achieving the miniaturization of the imaging optical lens assembly.

The object-side surface of the second lens element can be convex in a paraxial region thereof. Therefore, it is favorable for adjusting the refractive power of the second lens element so as to correct spherical aberration.

The image-side surface of the third lens element can be concave in a paraxial region thereof. Therefore, it is favorable for adjusting the refraction direction of light rays the third lens element to balance the optical path and correct spherical aberration.

The fourth lens element can have positive refractive power. Therefore, it is favorable for adjusting the light paths of every fields of view to achieve a balance between the total track length and the image quality of the imaging optical lens assembly. The image-side surface of the fourth lens element can be convex in a paraxial region thereof. Therefore, it is favorable for enhancing the light converging capability of the fourth lens element to reduce the total track length of the imaging optical lens assembly.

The fifth lens element can have negative refractive power. Therefore, it is favorable for balancing the refractive power distribution of the imaging optical lens assembly and correcting aberrations to increase image quality. The object-side surface of the fifth lens element can be concave in a paraxial region thereof. Therefore, it is favorable for working with moving focus adjustment to receive light in different states incident on the object-side surface of the fifth lens element. The image-side surface of the fifth lens element can be convex in a paraxial region thereof. Therefore, it is favorable for balancing the back focal length of the imaging optical lens assembly and correcting aberrations.

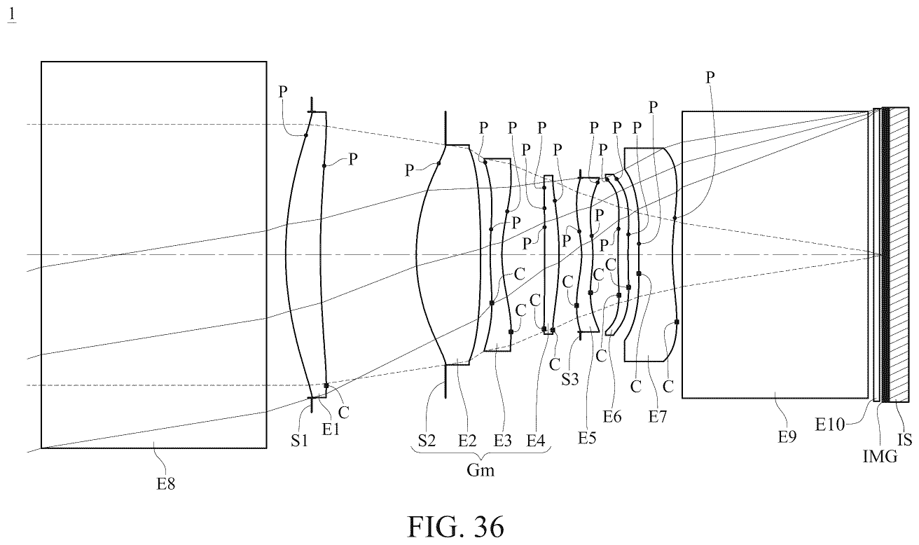

The object-side surface of the fifth lens element can have at least one inflection point. Therefore, it is favorable for controlling the peripheral light path of the object-side surface of the fifth lens element to correct off-axis aberrations. The image-side surface of the fifth lens element can have at least one inflection point. Therefore, it is favorable for balancing the peripheral light paths in different shooting conditions to reduce distortion and correct aberrations, thereby improving image quality. Please refer to FIG. 36, which shows a schematic view of the inflection points P on the lens surfaces as the image capturing unit is in the first state according to the 1st embodiment of the present disclosure. In FIG. 36, the object-side surface and the image-side surface of the first lens element E1, the object-side surface of the second lens element E2, the image-side surface of the third lens element E3, the image-side surface of the fourth lens element E4, the object-side surface of the fifth lens element E5, and the object-side surface and the image-side surface of the seventh lens element E7 each have one inflection point P, the object-side surface of the third lens element E3, the image-side surface of the fifth lens element E5, and the object-side surface and the image-side surface of the sixth lens element E6 each have two inflection points P, and the object-side surface of the fourth lens element E4 has three inflection points P. The 1st embodiment of the present disclosure shown in FIG. 36 is only exemplary. Each of the lens elements in various embodiments of the present disclosure can have one or more inflection points. Additionally, the number of inflection points is calculated only within the area of the optical maximum effective diameter of each lens element. The optical maximum effective diameter range of each lens element can be defined as the area through which the light ray tracing lines of the imaging optical lens assembly pass when in the first state.

At least one surface of at least one of the first lens element, the second lens element, the third lens element, the fourth lens element and the fifth lens element can have at least one critical point in an off-axis region thereof. Therefore, it is favorable for increasing the variation in the lens surface shape for correcting off-axis aberrations. Moreover, at least one surface of at least one of the fifth lens element and the sixth lens element can have at least one critical point in an off-axis region thereof. Said at least one surface of a single lens element having at least one critical point in an off-axis region thereof refers to that at least one of the object-side surface and the image-side surface of a single lens element can have at least one critical point in an off-axis region thereof. Please refer to FIG. 36, which shows a schematic view of the critical points C on the lens surfaces as the image capturing unit is in the first state according to the 1st embodiment of the present disclosure. In FIG. 36, the image-side surface of the first lens element E1, the object-side surface and the image-side surface of the third lens element E3, the object-side surface and the image-side surface of the fourth lens element E4, the object-side surface and the image-side surface of the fifth lens element E5, the object-side surface and the image-side surface of the sixth lens element E6, and the object-side surface and the image-side surface of the seventh lens element E7 each have one critical point C in an off-axis region thereof. The 1st embodiment of the present disclosure shown in FIG. 36 is only exemplary. Each of the lens elements in various embodiments of the present disclosure can have one or more critical points in an off-axis region thereof. Additionally, the number of critical points is calculated only within the area of the optical maximum effective diameter of each lens element.

Each of at least two lens elements in the imaging optical lens assembly can have an Abbe number smaller than 30.0. Therefore, it is favorable for correcting chromatic aberration across multiple object distances to effectively enhance image quality. Moreover, each of at least two lens elements in the imaging optical lens assembly can have an Abbe number smaller than 25.5.

When a sum of central thicknesses of all lens elements of the imaging optical lens assembly is ΣCT, and a sum of axial distances between each of all adjacent lens elements of the imaging optical lens assembly is ΣAT, the following condition can be satisfied: 0.40<ΣCT/ΣAT<1.58. Therefore, it is favorable for balancing the spatial configuration of the imaging optical lens assembly and maintaining high light-gathering quality across multiple object distances. Moreover, the following condition can also be satisfied: 0.60<ΣCT/ΣAT<1.58. Moreover, the following condition can also be satisfied: 0.50<ΣCT/ΣAT<1.45. Moreover, the following condition can also be satisfied: 0.70≤ΣCT/ΣAT≤1.31.

When an axial distance between the object-side surface of the second lens element and the image surface is Dr3i, and an axial distance between the image-side surface of the seventh lens element and the image surface is BL, the following condition can be satisfied: 1.10<Dr3i/BL<3.50. Therefore, it is favorable for balancing the amount of lens element movement and maintaining the back focal length within a limited spatial configuration so as to ensure that the imaging optical lens assembly has sufficient back focal length to accommodate other optical elements. Moreover, the following condition can also be satisfied: 1.40<Dr3i/BL<3.20. Moreover, the following condition can also be satisfied: 1.60<Dr3i/BL<3.00. Moreover, the following condition can also be satisfied: 1.91≤Dr3i/BL≤2.74.

When a focal length of the imaging optical lens assembly in the first state is fL, and a composite focal length of the second lens element, the third lens element and the fourth lens element is f234, the following condition can be satisfied: 0.50<fL/f234<2.30. Therefore, it is favorable for adjusting the refractive power configuration of the second lens element, the third lens element and the fourth lens element so as to facilitate optical path alignment and total track length control of the imaging optical lens assembly during the focusing process. Moreover, the following condition can also be satisfied: 0.80<fL/f234<2.00. Moreover, the following condition can also be satisfied: 1.20≤fL/f234≤1.84.

When an axial distance between the first lens element and the second lens element is T12, and a central thickness of the first lens element is CT1, the following condition can be satisfied: 0.05<T12/CT1<6.00. Therefore, it is favorable for the distance between the first lens element and the second lens element to be effectively controlled by the central thickness of the first lens element to prevent the total track length of the imaging optical lens assembly from becoming excessively long and to reduce manufacturing tolerances. Moreover, the following condition can also be satisfied: 0.10<T12/CT1<5.50. Moreover, the following condition can also be satisfied: 0.18≤T12/CT1≤4.49.

When a curvature radius of the image-side surface of the third lens element is R6, and a curvature radius of the image-side surface of the fourth lens element is R8, the following condition can be satisfied: −5.00<R6/R8<−0.05. Therefore, it is favorable for effectively controlling the deflection angles of light in the third lens element and the fourth lens element to mutually correct central spherical aberration. Moreover, the following condition can also be satisfied: −3.50<R6/R8<−0.05. Moreover, the following condition can also be satisfied: −2.00<R6/R8<−0.10. Moreover, the following condition can also be satisfied: −1.70≤R6/R8≤−0.24.

When a focal length of the first lens element is f1, a focal length of the fourth lens element is f4, and a focal length of the fifth lens element is f5, the following condition can be satisfied: −2.50<(f4+f5)/f1<1.20. Therefore, it is favorable for adjusting the refractive power distribution of the imaging optical lens assembly to correct aberrations, and reducing sensitivity. Moreover, the following condition can also be satisfied: −1.70<(f4+f5)/f1<0.70. Moreover, the following condition can also be satisfied: −1.20<(f4+f5)/f1<0.60. Moreover, the following condition can also be satisfied: −0.73≤(f4+f5)/f1≤0.28.

When an axial distance between the object-side surface of the first lens element and the image surface is TL, and the focal length of the imaging optical lens assembly in the first state is fL, the following condition can be satisfied: 0.70<TL/fL<1.90. Therefore, it is favorable for balancing the field of view and the size of the imaging optical lens assembly. Moreover, the following condition can also be satisfied: 0.80<TL/fL<1.70. Moreover, the following condition can also be satisfied: 0.90<TL/fL<1.50.

When a central thickness of the sixth lens element is CT6, and a central thickness of the seventh lens element is CT7, the following condition can be satisfied: 0.20<CT6/CT7<1.45. Therefore, it is favorable for controlling the central thickness ratio of the sixth lens element and the seventh lens element to reduce the size of the imaging optical lens assembly consider the manufacturing constraints of the lens elements. Moreover, the following condition can also be satisfied: 0.25<CT6/CT7<1.35.

When the axial distance between the object-side surface of the first lens element and the image surface is TL, and a maximum image height of the imaging optical lens assembly (which can be half of a diagonal length of an effective photosensitive area of an image sensor) is ImgH, the following condition can be satisfied: 3.60<TL/ImgH<4.80. Therefore, it is favorable for forming a telephoto structure and obtaining a balance between the total track length and the image height of the imaging optical lens assembly. Moreover, the following condition can also be satisfied: 3.70<TL/ImgH<4.70.

When a curvature radius of the object-side surface of the second lens element is R3, and the curvature radius of the image-side surface of the third lens element is R6, the following condition can be satisfied: 0.10<R6/R3<2.30. Therefore, it is favorable for the surface shape of the object-side surface of the second lens element to be matched with the surface shape of the image-side surface of the third lens element, thereby correcting aberrations across different fields of view. Moreover, the following condition can also be satisfied: 0.20<R6/R3<2.00.

When a curvature radius of the object-side surface of the first lens element is R1, and a curvature radius of the image-side surface of the fifth lens element is R10, the following condition can be satisfied: −1.80<R10/R1<0.60. Therefore, it is favorable for balancing the optical path during the focus adjustment process to reduce stray light. Moreover, the following condition can also be satisfied: −1.60<R10/R1<0.30. Moreover, the following condition can also be satisfied: −1.40<R10/R1<−0.01.

When an axial distance between the fifth lens element and the sixth lens element is T56, and the central thickness of the first lens element is CT1, the following condition can be satisfied: 0.15<T56/CT1<3.50. Therefore, it is favorable for the center thickness of the first lens element to limit the distance between the fifth lens element and the sixth lens element, thereby increasing the space utilization of the imaging optical lens assembly. Moreover, the following condition can also be satisfied: 0.25<T56/CT1<3.30.

When a central thickness of the fifth lens element is CT5, the central thickness of the sixth lens element is CT6, and a focal length of the sixth lens element is f6, the following condition can be satisfied: −0.80<10×(CT5+CT6)/f6<0.90. Therefore, it is favorable for using the refractive power of the sixth lens element to assist in controlling the central thickness of the fifth element and the sixth lens element, thereby reducing the size of the imaging optical lens assembly. Moreover, the following condition can also be satisfied: −0.65<10×(CT5+CT6)/f6<0.80.

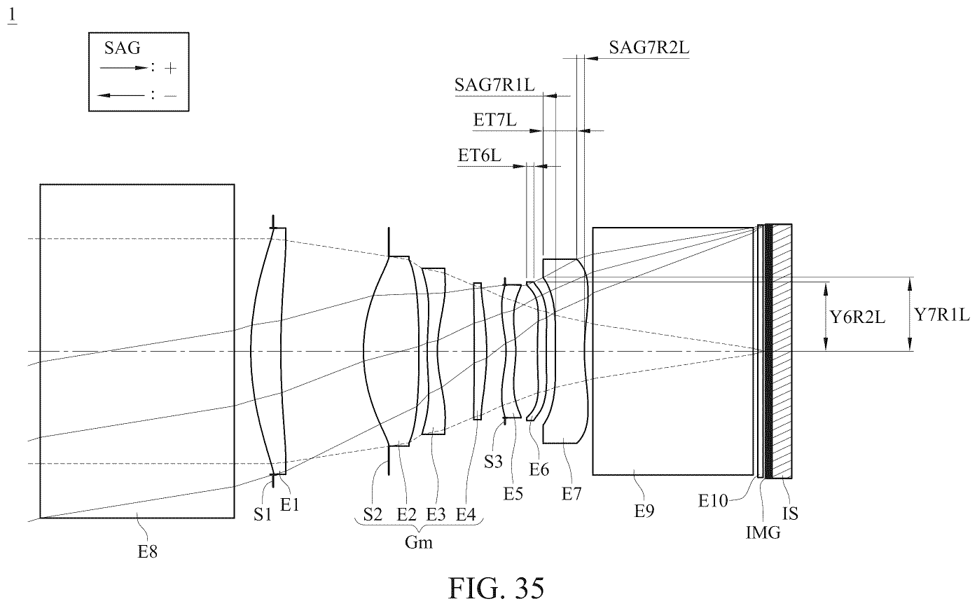

When a displacement in parallel with the optical axis from an axial vertex of the object-side surface of the seventh lens element to a maximum effective radius position of the object-side surface of the seventh lens element as the imaging optical lens assembly is in the first state is SAG7R1L, and a displacement in parallel with the optical axis from an axial vertex of the image-side surface of the seventh lens element to a maximum effective radius position of the image-side surface of the seventh lens element as the imaging optical lens assembly is in the first state is SAG7R2L, the following condition can be satisfied: −0.80<SAG7R1L/SAG7R2L<3.80. Therefore, it is favorable for controlling the angle of incidence of light entering the image surface and improving field curvature. Moreover, the following condition can also be satisfied: −0.50<SAG7R1L/SAG7R2L<3.50. Please refer to FIG. 35, which shows a schematic view of SAG7R1L and SAG7R2L as the image capturing unit is in the first state according to the 1st embodiment of the present disclosure. When the direction from the axial vertex of one surface to the maximum effective radius position of the same surface is facing towards the image side of the imaging optical lens assembly, the value of displacement is positive; when the direction from the axial vertex of the surface to the maximum effective radius position of the same surface is facing towards the object side of the imaging optical lens assembly, the value of displacement is negative.

When a distance in parallel with the optical axis between a maximum effective radius position of the object-side surface of the sixth lens element and a maximum effective radius position of the image-side surface of the sixth lens element as the imaging optical lens assembly is in the first state is ET6L, and the central thickness of the sixth lens element is CT6, the following condition can be satisfied: 0.30<ET6L/CT6<2.70. Therefore, it is favorable for adjusting the peripheral light path to correct distortion. Moreover, the following condition can also be satisfied: 0.40<ET6L/CT6<2.50. Please refer to FIG. 35, which shows a schematic view of ET6L as the image capturing unit is in the first state according to the 1st embodiment of the present disclosure.

When an axial distance between the third lens element and the fourth lens element is T34, and an axial distance between the fourth lens element and the fifth lens element is T45, the following condition can be satisfied: 0.00≤T34/T45<3.50. Therefore, it is favorable for adjusting the axial distances in the front and rear sides of the fourth lens element to balance the relative position of the fourth lens element during the focus adjustment process, and improving the assembly yield of the imaging optical lens assembly. Moreover, the following condition can also be satisfied: 0.02<T34/T45<3.00.

When the axial distance between the first lens element and the second lens element is T12, a focal length of the imaging optical lens assembly is f, and the axial distance between the image-side surface of the seventh lens element and the image surface is BL, the following condition can be satisfied: 0.00≤T12/f+T12/BL<1.25. Therefore, it is favorable for controlling the total track length while enabling the moving focus function of the imaging optical lens assembly, and favorable for the spatial arrangement of the mechanism and other components. Moreover, the following condition can also be satisfied: 0.02<T12/f+T12/BL<1.15. The focal length (f) of the imaging optical lens assembly can refer to the focal length of the imaging optical lens assembly in different focusing states. For example, the focal length (f) of the imaging optical lens assembly can refer to the focal length (fL) of the imaging optical lens assembly in the first state (infinite object distance), or the focal length (fS) of the imaging optical lens assembly in the second state (finite object distance).

When the curvature radius of the image-side surface of the fourth lens element is R8, the curvature radius of the image-side surface of the fifth lens element is R10, and the focal length of the imaging optical lens assembly in the first state is fL, the following condition can be satisfied: 0.20<(|R8|+|R10|)/fL<2.00. Therefore, it is favorable for adjusting the curvature of the image-side surface of the fourth lens element and the image-side surface of the fifth lens element to correct astigmatism. Moreover, the following condition can also be satisfied: 0.30< (|R8|+|R10|)/fL<1.80.

When the focal length of the first lens element is f1, and a focal length of the second lens element is f2, the following condition can be satisfied: −2.00<f1/f2<6.00. Therefore, it is favorable for controlling the convergence or divergence of light at the front end of the imaging optical lens assembly for aberration correction and enhancing light-gathering quality across the entire field of view. Moreover, the following condition can also be satisfied: −1.80<f1/f2<5.80. Moreover, the following condition can also be satisfied: −1.50<f1/f2<5.50.

When a maximum field of view of the imaging optical lens assembly is FOV, the following condition can be satisfied: 15.0 degrees≤FOV≤40.0 degrees. Therefore, it is favorable for ensuring that the imaging optical lens assembly has an appropriate field of view to meet product application requirements. Moreover, the following condition can also be satisfied: 20.0 degrees≤FOV≤40.0 degrees.

When the focal length of the imaging optical lens assembly in the first state is fL, and a focal length of the imaging optical lens assembly in the second state is fS, the following condition can be satisfied: 1.10<fL/fS<1.80. Therefore, it is favorable for the imaging optical lens assembly to have a certain range for both distant and close-up photography, thereby enhancing its functional usability. Moreover, the following condition can also be satisfied: 1.20<fL/fS<1.70.

When a sum of distances in parallel with the optical axis between a maximum effective radius position of the object-side surface and a maximum effective radius position of the image-side surface of each lens element of the imaging optical lens assembly as the imaging optical lens assembly is in the first state is ΣETL, and the sum of central thicknesses of all lens elements of the imaging optical lens assembly is ΣCT, the following condition can be satisfied: 0.40<ΣETL/ΣCT<1.20. Therefore, it is favorable for controlling the overall edge thickness of the imaging optical lens assembly to provide space for accommodating the mechanism and improving manufacturability. Moreover, the following condition can also be satisfied: 0.50<ΣETL/ΣCT<1.10.

When a distance in parallel with the optical axis between the maximum effective radius position of the object-side surface of the seventh lens element and the maximum effective radius position of the image-side surface of the seventh lens element as the imaging optical lens assembly is in the first state is ET7L, and the central thickness of the seventh lens element is CT7, the following condition can be satisfied: 0.30<ET7L/CT7<2.20. Therefore, it is favorable for reducing the size at the image-side end of the imaging optical lens assembly, and correcting astigmatism and distortion. Moreover, the following condition can also be satisfied: 0.40<ET7L/CT7<2.00. Please refer to FIG. 35, which shows a schematic view of ET7L as the image capturing unit is in the first state according to the 1st embodiment of the present disclosure.

When a maximum effective radius of the image-side surface of the sixth lens element as the imaging optical lens assembly is in the first state is Y6R2L, and a maximum effective radius of the object-side surface of the seventh lens element as the imaging optical lens assembly is in the first state is Y7R1L, the following condition can be satisfied: 0.70<Y7R1L/Y6R2L<1.50. Therefore, it is favorable for reducing the deflection angle of peripheral light to prevent total internal reflection and increase the relative illumination of the peripheral field of view. Moreover, the following condition can also be satisfied: 0.80<Y7R1L/Y6R2L<1.40. Please refer to FIG. 35, which shows a schematic view of Y6R2L and Y7R1L as the image capturing unit is in the first state according to the 1st embodiment of the present disclosure.

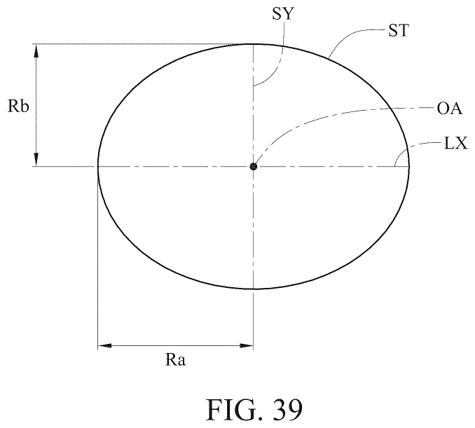

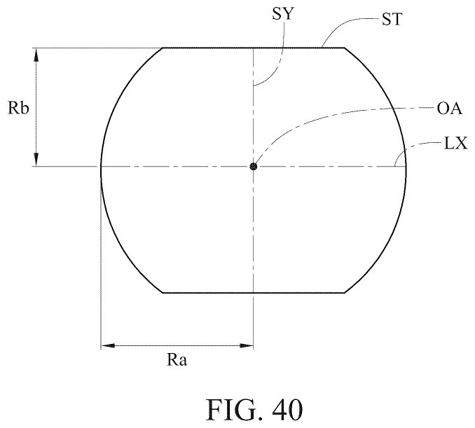

According to the present disclosure, the imaging optical lens assembly can further include an aperture stop. Therefore, it is favorable for ensuring the imaging optical lens assembly having a proper entrance pupil and controlling the field of view so as to achieve a telephoto photography effect. Moreover, the aperture stop can have a major axis direction and a minor axis direction which are perpendicular to the optical axis and different from each other, and an effective radius of the aperture stop in the major axis direction is different from an effective radius of the aperture stop in the minor axis direction. Therefore, it is favorable for adjusting the shape of the aperture stop so as to reduce stray light. For example, please refer to FIG. 39 and FIG. 40, which show schematic views of non-circular aperture stops according to the present disclosure, where FIG. 39 shows a schematic view of a shape of an aperture stop according to the present disclosure, and FIG. 40 shows a schematic view of another shape of an aperture stop according to the present disclosure. As shown in FIG. 39, in some configurations of the present disclosure, a shape of an aperture stop ST is elliptical, and the aperture stop ST has a major axis direction LX and a minor axis direction SY perpendicular to an optical axis OA. The major axis direction LX and the minor axis direction SY are two different directions, and an effective radius Ra of the aperture stop ST in the major axis direction LX is larger than an effective radius Rb of the aperture stop ST in the minor axis direction SY. As shown in FIG. 40, in some configurations of the present disclosure, an aperture stop ST is shaped to have trimmed edges at an outer periphery thereof, and the aperture stop ST has a major axis direction LX and a minor axis direction SY perpendicular to an optical axis OA. The major axis direction LX and the minor axis direction SY are two different directions, and an effective radius Ra of the aperture stop ST in the major axis direction LX is larger than an effective radius Rb of the aperture stop ST in the minor axis direction SY.

According to the present disclosure, the aforementioned features and conditions can be utilized in numerous combinations so as to achieve corresponding effects.

According to the present disclosure, the lens elements of the imaging optical lens assembly can be made of either glass or plastic material. When the lens elements are made of glass material, the refractive power distribution of the imaging optical lens assembly may be more flexible, and the influence on imaging caused by external environment temperature change may be reduced. The glass lens element can either be made by grinding or molding. When the lens elements are made of plastic material, the manufacturing costs can be effectively reduced. Furthermore, surfaces of each lens element can be arranged to be spherical or aspheric. Spherical lens elements are simple in manufacture. Aspheric lens element design allows more control variables for eliminating aberrations thereof and reducing the required number of lens elements, and the total track length of the imaging optical lens assembly can therefore be effectively shortened. Additionally, the aspheric surfaces may be formed by plastic injection molding or glass molding.

According to the present disclosure, when a lens surface is aspheric, it means that the lens surface has an aspheric shape throughout its optically effective area, or a portion(s) thereof.

According to the present disclosure, one or more of the lens elements' material may optionally include an additive which generates light absorption and interference effects and alters the lens elements' transmittance in a specific range of wavelength for a reduction in unwanted stray light or color deviation. For example, the additive may optionally filter out light in the wavelength range of 600 nm to 800 nm to reduce excessive red light and/or near infrared light; or may optionally filter out light in the wavelength range of 350 nm to 450 nm to reduce excessive blue light and/or near ultraviolet light from interfering the final image. The additive may be homogeneously mixed with a plastic material to be used in manufacturing a mixed-material lens element by injection molding. Moreover, the additive may be coated on the lens surfaces to provide the abovementioned effects.

According to the present disclosure, each of an object-side surface and an image-side surface has a paraxial region and an off-axis region. The paraxial region refers to the region of the surface where light rays travel close to the optical axis, and the off-axis region refers to the region of the surface away from the paraxial region. Particularly, unless otherwise stated, when the lens element has a convex surface, it indicates that the surface is convex in the paraxial region thereof; when the lens element has a concave surface, it indicates that the surface is concave in the paraxial region thereof. Moreover, when a region of refractive power, curvature radius or focus of a lens element is not defined, it indicates that the region of refractive power, curvature radius or focus of the lens element is in the paraxial region thereof.

According to the present disclosure, an inflection point is a point on the surface of the lens element at which the surface changes from concave to convex, or vice versa. A critical point is a non-axial point of the lens surface where its tangent is perpendicular to the optical axis.

According to the present disclosure, the image surface of the imaging optical lens assembly, based on the corresponding image sensor, can be flat or curved, especially a curved surface being concave facing towards the object side of the imaging optical lens assembly.

According to the present disclosure, an image correction unit, such as a field flattener, can be optionally disposed between the lens element closest to the image side of the imaging optical lens assembly along the optical path and the image surface for correction of aberrations such as field curvature. The optical properties of the image correction unit, such as curvature, thickness, index of refraction, position and surface shape (convex or concave surface with spherical, aspheric, diffractive or Fresnel types), can be adjusted according to the design of the image capturing unit. In general, a preferable image correction unit is, for example, a thin transparent element having a concave object-side surface and a planar image-side surface, and the thin transparent element is disposed near the image surface.

According to the present disclosure, at least one reflective element, such as a prism or a reflective mirror, can be optionally provided, but the present disclosure is not limited thereto. Therefore, the imaging optical lens assembly can be more flexible in space arrangement. The surface of the prism or reflective mirror can be planar, spherical, aspheric or have a freeform shape, such that the imaging optical lens assembly can be more flexible in space arrangement. Moreover, when the surface of the prism is, for example, spherical, aspheric or have a freeform shape, the prism can also have refractive power, thereby enabling it to converge or diverge light. The reflective element can be disposed between an imaged object and the image surface so as to reduce the size of the imaging optical lens assembly. The optical path can be deflected one time, two times, three times or more by a single reflective element. In addition, the reflective element can have at least one reflective surface, and an angle between the optical axis and a normal direction of the reflective surface is not limited to 45 degrees, but can be other angles depending on the space arrangement. The optical path along an optical axis at the object side can be redirected to an optical axis at the image side by the reflective element. An angle between a vector of the optical axis at the object side and that at the image side can be any angle, not limited to 0, 90 or 180 degrees. In addition, in order to reduce the size of the imaging optical lens assembly, the length and the width of the reflective mirror may be different from each other, and the length, the width and the height of the prism may be different from one another. The surface of the reflective element (e.g., the surface of the prism or the reflective mirror) can be planar, spherical, aspheric or have a freeform shape according to the optical design requirements, but the present disclosure is not limited thereto. The reflective element can consist of more than one prism depending on the design requirements. The prism can be made of glass material or plastic material depending on the design requirements. In addition, the prism with optical path folding function and light converging or diverging function is not one of the lens elements; that is, the prism with optical path folding function and light converging or diverging function is not included in the seven lens elements of the imaging optical lens assembly.

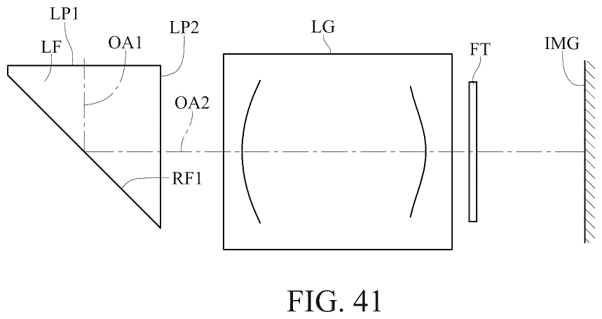

Furthermore, please refer to FIG. 41 through FIG. 43, each of which shows a schematic view of a configuration of one reflective element in an imaging optical lens assembly according to one embodiment of the present disclosure. As shown in FIG. 41 to FIG. 43, the imaging optical lens assembly can include, in order from an imaged object (not shown in the figures) to an image surface IMG along a travelling direction of an optical path, a reflective element LF, a lens group LG, a filter FT and the image surface IMG.

In FIG. 41, the reflective element LF is a prism and has, in sequence along a travelling direction of light on the optical path, a first light permeable surface LP1, a reflective surface RF1, and a second light permeable surface LP2. The optical path enters the reflective element LF through the first light permeable surface LP1 and reaches the reflective surface RF1 along a first optical axis OA1. The reflective surface RF1 deflects the optical path from the first optical axis OA1 to a second optical axis OA2, and the optical path then passes through the second light permeable surface LP2, travels through the lens group LG and the filter FT, and ultimately arrives at the image surface IMG along the second optical axis OA2. As shown in FIG. 41, both of the first light permeable surface LP1 and the second light permeable surface LP2 of the reflective element LF can be planar.

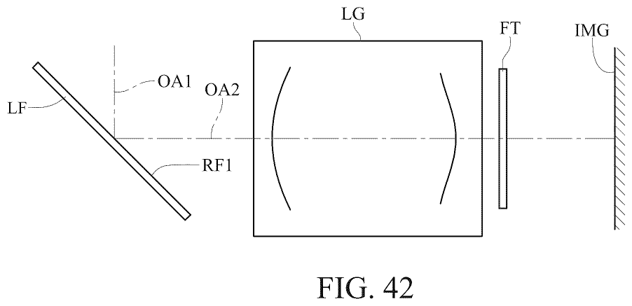

In FIG. 42, the reflective element LF is a flat reflective mirror having a reflective surface RF1. The optical path reaches the reflective surface RF1 along a first optical axis OA1. The reflective surface RF1 deflects the optical path from the first optical axis OA1 to a second optical axis OA2. Subsequently, the optical path travels through the lens group LG and the filter FT, and ultimately arrives at the image surface IMG along the second optical axis OA2.

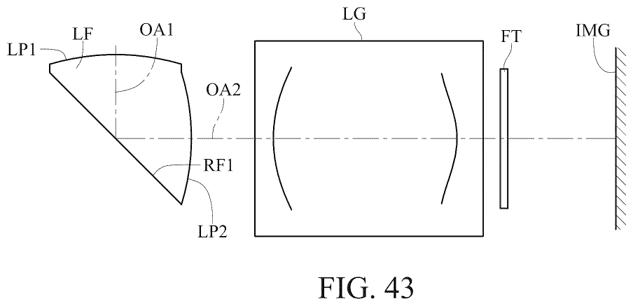

In FIG. 43, the reflective element LF is a prism and has, in sequence along a travelling direction of light on the optical path, a first light permeable surface LP1, a reflective surface RF1, and a second light permeable surface LP2. The optical path enters the reflective element LF through the first light permeable surface LP1 and reaches the reflective surface RF1 along a first optical axis OA1. The reflective surface RF1 deflects the optical path from the first optical axis OA1 to a second optical axis OA2, and the optical path then passes through the second light permeable surface LP2, travels through the lens group LG and the filter FT, and ultimately arrives at the image surface IMG along the second optical axis OA2. As shown in FIG. 43, both of the first light permeable surface LP1 and the second light permeable surface LP2 of the reflective element LF can be curved.

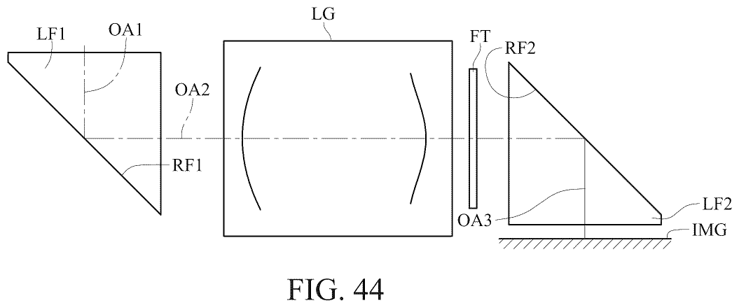

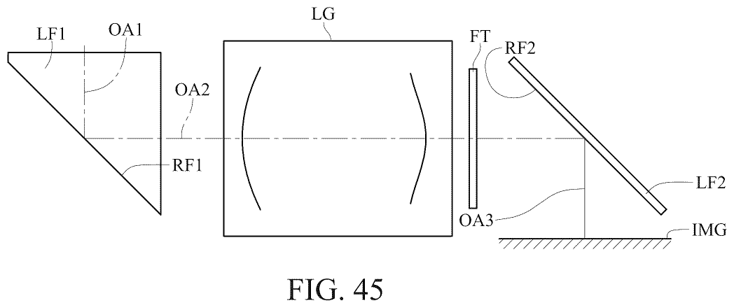

Moreover, please refer to FIG. 44 and FIG. 45, each of which shows a schematic view of a configuration of two reflective elements in an imaging optical lens assembly according to one embodiment of the present disclosure. As shown in FIG. 44 and FIG. 45, the imaging optical lens assembly can include, in order from an imaged object (not shown in the figures) to an image surface IMG along a travelling direction of an optical path, a first reflective element LF1, a lens group LG, a filter FT, a second reflective element LF2 and the image surface IMG. The optical path enters the first reflective element LF1 and reaches the first reflective surface RF1 along a first optical axis OA1, and the first reflective surface RF1 deflects the optical path from the first optical axis OA1 to a second optical axis OA2. The optical path travels through the lens group LG and the filter FT along the second optical axis OA2. Subsequently, the optical path enters the second reflective element LF2 and reaches the second reflective surface RF2 along the second optical axis OA2, and the second reflective surface RF2 deflects the optical path from the second optical axis OA2 to a third optical axis OA3. The optical path ultimately arrives at the image surface IMG along the third optical axis OA3. In FIG. 44, each of the first reflective element LF1 and the second reflective element LF2 can be a prism. In FIG. 45, the first reflective element LF1 and the second reflective element LF2 can be a prism and a flat reflective mirror, respectively.

The imaging optical lens assembly can be optionally provided with three or more reflective elements, and the present disclosure is not limited to the type, number and position of the reflective elements of the embodiments as disclosed in the aforementioned figures.

According to the present disclosure, the imaging optical lens assembly can include at least one stop, such as an aperture stop, a glare stop or a field stop. Said glare stop or said field stop is set for eliminating the stray light and thereby improving image quality thereof.

According to the present disclosure, an aperture stop can be configured as a front stop or a middle stop. A front stop disposed between an imaged object and the first lens element can provide a longer distance between an exit pupil of the imaging optical lens assembly and the image surface to produce a telecentric effect, and thereby improves the image-sensing efficiency of an image sensor (for example, CCD or CMOS). A middle stop disposed between the first lens element and the image surface is favorable for enlarging the viewing angle of the imaging optical lens assembly and thereby provides a wider field of view for the same.

According to the present disclosure, the imaging optical lens assembly can include an aperture control unit. The aperture control unit may be a mechanical component or a light modulator, which can control the size and shape of the aperture through electricity or electrical signals. The mechanical component can include a movable member, such as a blade assembly or a light shielding sheet. The light modulator can include a shielding element, such as a filter, an electrochromic material or a liquid-crystal layer. The aperture control unit controls the amount of incident light or exposure time to enhance the capability of image quality adjustment. In addition, the aperture control unit can be the aperture stop of the present disclosure, which changes the f-number to obtain different image effects, such as the depth of field or lens speed.

According to the present disclosure, the imaging optical lens assembly can further include one or more optical elements for limiting the form of light passing through the imaging optical lens assembly. Each optical element can be, but not limited to, a filter, a polarizer, etc., and each optical element can be, but not limited to, a single-piece element, a composite component, a thin film, etc. The optical element can be located at the object side or the image side of the imaging optical lens assembly or between any two adjacent lens elements so as to allow light in a specific form to pass through, thereby meeting application requirements.

According to the present disclosure, the imaging optical lens assembly can include at least one optical lens element, an optical element, or a carrier, which has at least one surface with a low reflection layer. The low reflection layer can effectively reduce stray light generated due to light reflection at the interface. The low reflection layer can be disposed in an optical non-effective area of an object-side surface or an image-side surface of the said optical lens element, or a connection surface between the object-side surface and the image-side surface. The said optical element can be a light-blocking element, an annular spacer, a barrel element, a cover glass, a blue glass, a filter, a color filter, an optical path folding element (e.g., a reflective element), a prism, a mirror, etc. The said carrier can be a base for supporting a lens assembly, a micro lens disposed on an image sensor, a substrate surrounding the image sensor, a glass plate for protecting the image sensor, etc.

According to the present disclosure, the object side and image side are defined in accordance with the direction of the optical axis, and the axial optical data are calculated along the optical axis. Furthermore, if the optical axis is deflected by a reflective element, the axial optical data are also calculated along the deflected optical axis.

According to the above description of the present disclosure, the following specific embodiments are provided for further explanation.

### 1st Embodiment

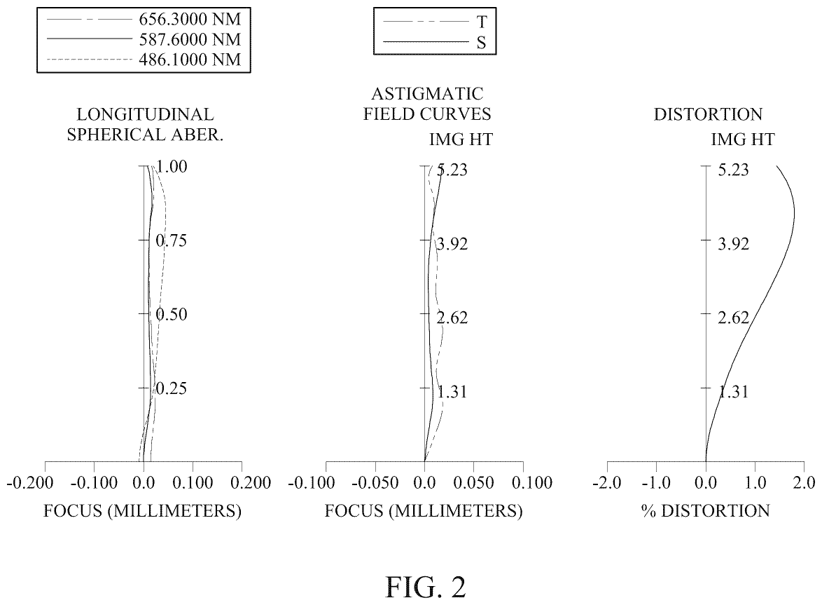

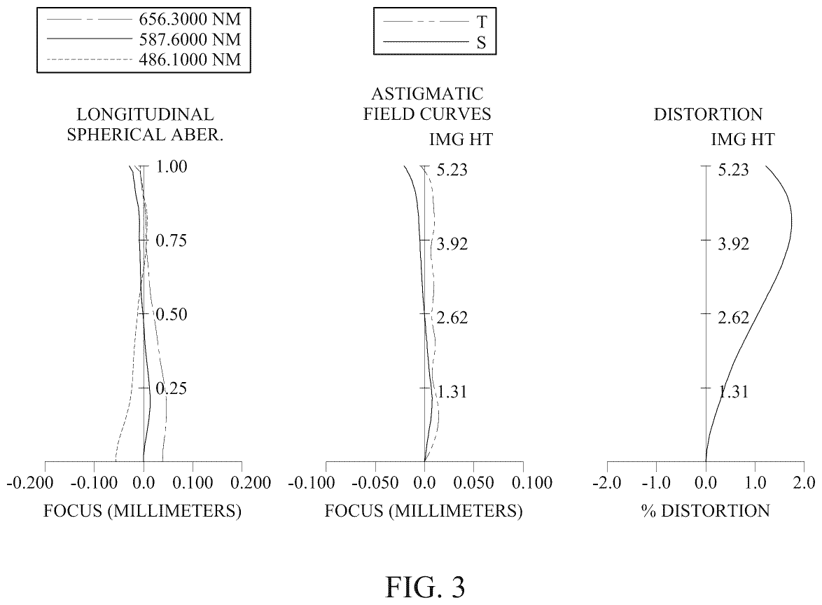

FIG. 1 is a schematic view of an image capturing unit respectively in a first state and a second state according to the 1st embodiment of the present disclosure. FIG. 2 shows, in order from left to right, spherical aberration curves, astigmatic field curves and a distortion curve of the image capturing unit in the first state according to the 1st embodiment. FIG. 3 shows, in order from left to right, spherical aberration curves, astigmatic field curves and a distortion curve of the image capturing unit in the second state according to the 1st embodiment. Moreover, the upper part of FIG. 1 shows the schematic view of the imaging optical lens assembly in the first state, and the lower part of FIG. 1 shows the schematic view of the imaging optical lens assembly in the second state. In FIG. 1, the image capturing unit 1 includes the imaging optical lens assembly (its reference numeral is omitted) of the present disclosure and an image sensor IS. The imaging optical lens assembly includes, in order from an object side to an image side along an optical path, a first reflective element E8, a stop S1, a first lens element E1, a stop S2, a second lens element E2, a third lens element E3, a fourth lens element E4, a stop S3, a fifth lens element E5, a sixth lens element E6, a seventh lens element E7, a second reflective element E9, a filter E10 and an image surface IMG. Furthermore, the imaging optical lens assembly has a movable group Gm, and the movable group Gm includes the stop S2, the second lens element E2, the third lens element E3 and the fourth lens element E4. The imaging optical lens assembly includes seven lens elements (E1, E2, E3, E4, E5, E6 and E7) with no additional lens element disposed between each of the adjacent seven lens elements. In addition, there is no additional lens element located between the first lens element E1 and the first reflective element E8 along an optical axis, and there is no additional lens element located between the seventh lens element E7 and the second reflective element E9 along the optical axis.

When an imaged object is located at an infinite object distance, the imaging optical lens assembly is in the first state as shown in the upper part of FIG. 1. When an imaged object is located at a finite object distance, the imaging optical lens assembly is in the second state as shown in the lower part of FIG. 1. When an imaged object is moved from an infinite object distance to a finite object distance, the movable group Gm is moved along the optical axis for focus adjustment, and the imaging optical lens assembly is transitioned from the first state to the second state. Conversely, when an imaged object is moved from a finite object distance to an infinite object distance, the movable group Gm is moved along the optical axis for focus adjustment, and the imaging optical lens assembly is transitioned from the second state to the first state. Particularly, the movable group Gm is moved towards the object side along the optical axis during the focus adjustment process when the imaging optical lens assembly is transitioned from the first state to the second state. It should be noted that all elements (e.g., the stop, lens element, and/or aperture stop) in the movable group Gm are immovable relative to one another during the focus adjustment process.

The first reflective element E8 is made of glass material and located along the optical path between an imaged object and the first lens element E1, and will not affect the focal length of the imaging optical lens assembly. The first reflective element E8 is a prism with optical path folding function.

The first lens element E1 with positive refractive power has an object-side surface being convex in a paraxial region thereof and an image-side surface being concave in a paraxial region thereof. The first lens element E1 is made of glass material and has the object-side surface and the image-side surface being both aspheric. The object-side surface of the first lens element E1 has one inflection point. The image-side surface of the first lens element E1 has one inflection point. The image-side surface of the first lens element E1 has one critical point in an off-axis region thereof.

The second lens element E2 with positive refractive power has an object-side surface being convex in a paraxial region thereof and an image-side surface being convex in a paraxial region thereof. The second lens element E2 is made of plastic material and has the object-side surface and the image-side surface being both aspheric. The object-side surface of the second lens element E2 has one inflection point.

The third lens element E3 with negative refractive power has an object-side surface being convex in a paraxial region thereof and an image-side surface being concave in a paraxial region thereof. The third lens element E3 is made of plastic material and has the object-side surface and the image-side surface being both aspheric. The object-side surface of the third lens element E3 has two inflection points. The image-side surface of the third lens element E3 has one inflection point. The object-side surface of the third lens element E3 has one critical point in an off-axis region thereof. The image-side surface of the third lens element E3 has one critical point in an off-axis region thereof.

The fourth lens element E4 with positive refractive power has an object-side surface being concave in a paraxial region thereof and an image-side surface being convex in a paraxial region thereof. The fourth lens element E4 is made of plastic material and has the object-side surface and the image-side surface being both aspheric. The object-side surface of the fourth lens element E4 has three inflection points. The image-side surface of the fourth lens element E4 has one inflection point. The object-side surface of the fourth lens element E4 has one critical point in an off-axis region thereof. The image-side surface of the fourth lens element E4 has one critical point in an off-axis region thereof.

The fifth lens element E5 with negative refractive power has an object-side surface being concave in a paraxial region thereof and an image-side surface being convex in a paraxial region thereof. The fifth lens element E5 is made of plastic material and has the object-side surface and the image-side surface being both aspheric. The object-side surface of the fifth lens element E5 has one inflection point. The image-side surface of the fifth lens element E5 has two inflection points. The object-side surface of the fifth lens element E5 has one critical point in an off-axis region thereof. The image-side surface of the fifth lens element E5 has one critical point in an off-axis region thereof.

The sixth lens element E6 with positive refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has two inflection points. The image-side surface of the sixth lens element E6 has two inflection points. The object-side surface of the sixth lens element E6 has one critical point in an off-axis region thereof. The image-side surface of the sixth lens element E6 has one critical point in an off-axis region thereof.

The seventh lens element E7 with negative refractive power has an object-side surface being convex in a paraxial region thereof and an image-side surface being concave in a paraxial region thereof. The seventh lens element E7 is made of plastic material and has the object-side surface and the image-side surface being both aspheric. The object-side surface of the seventh lens element E7 has one inflection point. The image-side surface of the seventh lens element E7 has one inflection point. The object-side surface of the seventh lens element E7 has one critical point in an off-axis region thereof. The image-side surface of the seventh lens element E7 has one critical point in an off-axis region thereof.

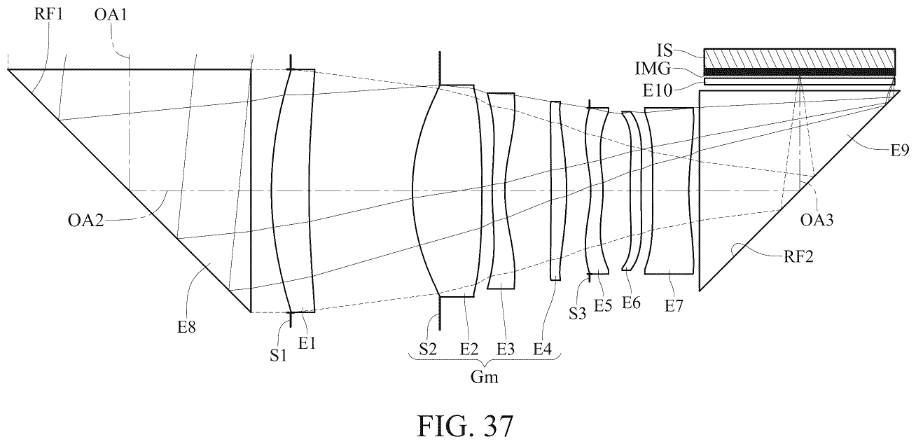

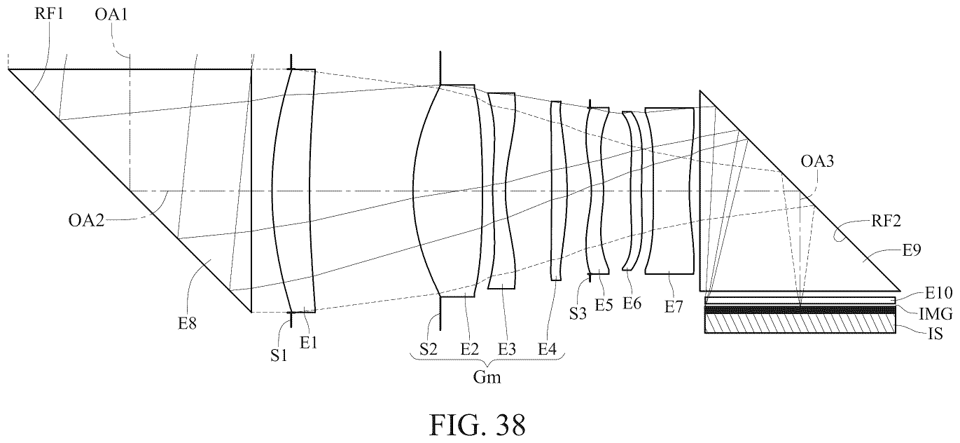

The second reflective element E9 is made of glass material and located along the optical path between the seventh lens element E7 and the image surface IMG, and will not affect the focal length of the imaging optical lens assembly. The second reflective element E9 is a prism with optical path folding function. For simplicity in illustration, FIG. 1 does not show the folding effect caused by the first reflective element E8 and the second reflective element E9 on the optical path. However, the first reflective element E8 and the second reflective element E9 can have various configurations depending on the actual design requirements, thereby creating different folding effects on the optical path. For example, please refer to FIG. 37 and FIG. 38, each of which shows a schematic view of a configuration of reflective elements and its associated light path folding in the image capturing unit in the first state according to the 1st embodiment.

In FIG. 37 and FIG. 38, the optical path enters the first reflective element E8 and reaches the first reflective surface RF1 along a first optical axis OA1, and the first reflective surface RF1 deflects the optical path from the first optical axis OA1 to a second optical axis OA2. The optical path travels through the stop S1, the first lens element E1, the stop S2, the second lens element E2, the third lens element E3, the fourth lens element E4, the stop S3, the fifth lens element E5, the sixth lens element E6 and the seventh lens element E7 along the second optical axis OA2. Subsequently, the optical path enters the second reflective element E9 and reaches the second reflective surface RF2 along the second optical axis OA2, and the second reflective surface RF2 deflects the optical path from the second optical axis OA2 to a third optical axis OA3. The optical path travels through the filter E10 and ultimately arrives at the image surface IMG along the third optical axis OA3. In addition, the first reflective element E8 deflects the optical path once, and the second reflective element E9 also deflects the optical path once.

In the configuration of FIG. 37, a normal direction of the first reflective surface RF1 can be at an angle of 45.0 degrees to both the first optical axis OA1 and the second optical axis OA2, a normal direction of the second reflective surface RF2 can be at an angle of 45.0 degrees to both the second optical axis OA2 and the third optical axis OA3, and an angle between a vector of the optical axis at the object side (e.g., the first optical axis OA1) and a vector of the optical axis at the image side (e.g., the third optical axis OA3) can be 180 degrees. That is, the vector of the optical axis at the object side and the vector of the optical axis at the image side can be in opposite directions.

In the configuration of FIG. 38, a normal direction of the first reflective surface RF1 can be at an angle of 45.0 degrees to both the first optical axis OA1 and the second optical axis OA2, a normal direction of the second reflective surface RF2 can be at an angle of 45.0 degrees to both the second optical axis OA2 and the third optical axis OA3, and an angle between a vector of the optical axis at the object side (e.g., the first optical axis OA1) and a vector of the optical axis at the image side (e.g., the third optical axis OA3) can be 0 degree. That is, the vector of the optical axis at the object side and the vector of the optical axis at the image side can be in the same direction.

The filter E10 is made of glass material and located between the second reflective element E9 and the image surface IMG, and will not affect the focal length of the imaging optical lens assembly. The image sensor IS is disposed on or near the image surface IMG of the imaging optical lens assembly.

The equation of the aspheric surface profiles of the aforementioned lens elements of the 1st embodiment is expressed as follows:

$$X ( Y ) = ( {Y}^{2} / R ) / ( 1 + sqrt ( 1 - ( 1 + k ) \times {( Y / R )}^{2} ) ) + {\sum }_{i} ( Ai ) \times ( {Y}^{i} ) ,$$

where,
X is the displacement in parallel with an optical axis from an axial vertex on the aspheric surface to a point at a distance of Y from the optical axis on the aspheric surface;
Y is the vertical distance from the point on the aspheric surface to the optical axis;
R is the curvature radius;
k is the conic coefficient; and
Ai is the i-th aspheric coefficient, and in the embodiments, i may be, but is not limited to, 4, 6, 8, 10, 12, 14, 16, 18, 20, 22, 24, 26, 28 and 30.

When a focal length of the imaging optical lens assembly in the first state is fL, an f-number of the imaging optical lens assembly in the first state is FnoL, and half of a maximum field of view of the imaging optical lens assembly in the first state is HFOVL, these parameters have the following values: fL=16.67 millimeters (mm), FnoL=1.80, and HFOVL=17.2 degrees (deg.).

When a focal length of the imaging optical lens assembly in the second state is fS, an f-number of the imaging optical lens assembly in the second state is FnoS, and half of a maximum field of view of the imaging optical lens assembly in the second state is HFOVS, these parameters have the following values: fS=12.40 mm, FnoS=2.22, and HFOVS=15.2 degrees.

An axial distance between an imaged object and the object-side surface of one lens element closest to the object side in the imaging optical lens assembly (i.e., the object-side surface of the first lens element E1) is referred to as an object distance, and an axial distance between the imaged object and the first reflective element E8 is D0. In this embodiment, an axial distance between the image-side surface of the first lens element E1 and the stop S2 is D1, and an axial distance between the image-side surface of the fourth lens element E4 and the stop S3 is D2. Values of the object distance, D0, D1 and D2 may change depending on whether the imaging optical lens assembly is in the first state or the second state for focus adjustment. As the imaging optical lens assembly is in the first state, the following conditions are satisfied: object distance=∞ (infinity); D0=∞ (infinity); D1=4.449 mm; and D2=0.752 mm. As the imaging optical lens assembly is in the second state, the following conditions are satisfied: object distance=68.680 mm; D0=60.00 mm; D1=2.365 mm; and D1=2.836 mm.

When the maximum field of view of the imaging optical lens assembly in the first state is FOVL, the following condition is satisfied: FOVL=34.4 degrees.

When the maximum field of view of the imaging optical lens assembly in the second state is FOVS, the following condition is satisfied: FOVS=30.4 degrees.

It is noted that values of Dr3i, f, T12 and T45 in some of the conditions below may change depending on whether the imaging optical lens assembly is in the first state or the second state for focus adjustment.

An axial distance between the object-side surface of the second lens element E2 and the image surface IMG is Dr3i, and an axial distance between the image-side surface of the seventh lens element E7 and the image surface IMG is BL. When the imaging optical lens assembly is in the first state, the following condition is satisfied: Dr3i/BL=2.22. When the imaging optical lens assembly is in the second state, the following condition is satisfied: Dr3i/BL=2.50.

An axial distance between the first lens element E1 and the second lens element E2 is T12, a focal length of the imaging optical lens assembly is f, and the axial distance between the image-side surface of the seventh lens element E7 and the image surface IMG is BL. When the imaging optical lens assembly is in the first state, the following condition is satisfied: T12/f+T12/BL=0.66. When the imaging optical lens assembly is in the second state, the following condition is satisfied: T12/f+T12/BL=0.28. In this embodiment, an axial distance between two adjacent lens elements is a distance in a paraxial region between two adjacent lens surfaces of the two adjacent lens elements.

The axial distance between the first lens element E1 and the second lens element E2 is T12, and a central thickness of the first lens element E1 is CT1. When the imaging optical lens assembly is in the first state, the following condition is satisfied: T12/CT1=2.76. When the imaging optical lens assembly is in the second state, the following condition is satisfied: T12/CT1=1.07.

When an axial distance between the fifth lens element E5 and the sixth lens element E6 is T56, and the central thickness of the first lens element E1 is CT1, the following condition is satisfied: T56/CT1=0.72.

An axial distance between the third lens element E3 and the fourth lens element E4 is T34, and an axial distance between the fourth lens element E4 and the fifth lens element E5 is T45. When the imaging optical lens assembly is in the first state, the following condition is satisfied: T34/T45=1.90. When the imaging optical lens assembly is in the second state, the following condition is satisfied: T34/T45=0.53.

When the focal length of the imaging optical lens assembly in the first state is fL, and the focal length of the imaging optical lens assembly in the second state is fS, the following condition is satisfied: fL/fS=1.34.

When an axial distance between the object-side surface of the first lens element E1 and the image surface IMG is TL, and the focal length of the imaging optical lens assembly in the first state is fL, the following condition is satisfied: TL/fL=1.27.

When the axial distance between the object-side surface of the first lens element E1 and the image surface IMG is TL, and a maximum image height of the imaging optical lens assembly is ImgH, the following condition is satisfied: TL/ImgH=4.05.

When the focal length of the imaging optical lens assembly in the first state is fL, and a composite focal length of the second lens element E2, the third lens element E3 and the fourth lens element E4 is f234, the following condition is satisfied: fL/f234=1.23.

When a focal length of the first lens element E1 is f1, and a focal length of the second lens element E2 is f2, the following condition is satisfied: f1/f2=2.83.

When the focal length of the first lens element E1 is f1, a focal length of the fourth lens element E4 is f4, and a focal length of the fifth lens element E5 is f5, the following condition is satisfied: (f4+f5)/f1=−0.26.

When a curvature radius of the image-side surface of the fourth lens element E4 is R8, a curvature radius of the image-side surface of the fifth lens element E5 is R10, and the focal length of the imaging optical lens assembly in the first state is fL, the following condition is satisfied: (|R8|+|R10|)/fL=0.86.

When a curvature radius of the object-side surface of the first lens element E1 is R1, and the curvature radius of the image-side surface of the fifth lens element E5 is R10, the following condition is satisfied: R10/R1=−0.35.

When a curvature radius of the object-side surface of the second lens element E2 is R3, and a curvature radius of the image-side surface of the third lens element E3 is R6, the following condition is satisfied: R6/R3=0.73.

When a curvature radius of the image-side surface of the third lens element E3 is R6, and the curvature radius of the image-side surface of the fourth lens element E4 is R8, the following condition is satisfied: R6/R8=−0.48.

When a sum of central thicknesses of all lens elements of the imaging optical lens assembly is ΣCT, and a sum of axial distances between each of all adjacent lens elements of the imaging optical lens assembly is ΣAT, the following condition is satisfied: ΣCT/ΣAT=0.87. In this embodiments, ΣCT is the sum of the central thickness of the first lens element E1, a central thickness of the second lens element E2, a central thickness of the third lens element E3, a central thickness of the fourth lens element E4, a central thickness of the fifth lens element E5, a central thickness of the sixth lens element E6 and a central thickness of the seventh lens element E7. In addition, in this embodiment, ΣAT is the sum of the axial distance between the first lens element E1 and the second lens element E2, an axial distance between the second lens element E2 and the third lens element E3, the axial distance between the third lens element E3 and the fourth lens element E4, the axial distance between the fourth lens element E4 and the fifth lens element E5, the axial distance between the fifth lens element E5 and the sixth lens element E6 and an axial distance between the sixth lens element E6 and the seventh lens element E7.

When the central thickness of the fifth lens element E5 is CT5, the central thickness of the sixth lens element E6 is CT6, and a focal length of the sixth lens element E6 is f6, the following condition is satisfied: 10×(CT5+CT6)/f6=0.0043.

When the central thickness of the sixth lens element E6 is CT6, and the central thickness of the seventh lens element E7 is CT7, the following condition is satisfied: CT6/CT7=0.30.

When a sum of distances in parallel with the optical axis between a maximum effective radius position of the object-side surface and a maximum effective radius position of the image-side surface of each lens element of the imaging optical lens assembly as the imaging optical lens assembly is in the first state is ΣETL, and the sum of central thicknesses of all lens elements of the imaging optical lens assembly is ΣCT, the following condition is satisfied: ΣETL/ΣCT=0.76. In this embodiment, ΣETL is the sum of a distance in parallel with the optical axis between a maximum effective radius position of the object-side surface of the first lens element E1 and a maximum effective radius position of the image-side surface of the first lens element E1 as the imaging optical lens assembly is in the first state, a distance in parallel with the optical axis between a maximum effective radius position of the object-side surface of the second lens element E2 and a maximum effective radius position of the image-side surface of the second lens element E2 as the imaging optical lens assembly is in the first state, a distance in parallel with the optical axis between a maximum effective radius position of the object-side surface of the third lens element E3 and a maximum effective radius position of the image-side surface of the third lens element E3 as the imaging optical lens assembly is in the first state, a distance in parallel with the optical axis between a maximum effective radius position of the object-side surface of the fourth lens element E4 and a maximum effective radius position of the image-side surface of the fourth lens element E4 as the imaging optical lens assembly is in the first state, a distance in parallel with the optical axis between a maximum effective radius position of the object-side surface of the fifth lens element E5 and a maximum effective radius position of the image-side surface of the fifth lens element E5 as the imaging optical lens assembly is in the first state, a distance in parallel with the optical axis between a maximum effective radius position of the object-side surface of the sixth lens element E6 and a maximum effective radius position of the image-side surface of the sixth lens element E6 as the imaging optical lens assembly is in the first state and a distance in parallel with the optical axis between a maximum effective radius position of the object-side surface of the seventh lens element E7 and a maximum effective radius position of the image-side surface of the seventh lens element E7 as the imaging optical lens assembly is in the first state.

When the distance in parallel with the optical axis between the maximum effective radius position of the object-side surface of the sixth lens element E6 and the maximum effective radius position of the image-side surface of the sixth lens element E6 is ET6L, and the central thickness of the sixth lens element E6 is CT6, the following condition is satisfied: ET6L/CT6=0.80.

When the distance in parallel with the optical axis between the maximum effective radius position of the object-side surface of the seventh lens element E7 and the maximum effective radius position of the image-side surface of the seventh lens element E7 is ET7L, and the central thickness of the seventh lens element E7 is CT7, the following condition is satisfied: ET7L/CT7=1.16.

When a maximum effective radius of the image-side surface of the sixth lens element E6 is Y6R2L, and a maximum effective radius of the object-side surface of the seventh lens element E7 is Y7R1L, the following condition is satisfied: Y7R1L/Y6R2L=1.07.

When a displacement in parallel with the optical axis from an axial vertex of the object-side surface of the seventh lens element E7 to the maximum effective radius position of the object-side surface of the seventh lens element E7 is SAG7R1L, and a displacement in parallel with the optical axis from an axial vertex of the image-side surface of the seventh lens element E7 to the maximum effective radius position of the image-side surface of the seventh lens element E7 is SAG7R2L, the following condition is satisfied: SAG7R1L/SAG7R2L=1.59. In this embodiment, the direction of SAG7R1L points toward the object side of the imaging optical lens assembly, and the value of SAG7R1L is negative; the direction of SAG7R2L points toward the object side of the imaging optical lens assembly, and the value of SAG7R2L is negative.

The detailed optical data of the 1st embodiment are shown in Table 1A and Table 1B, and the aspheric surface data are shown in Table 1C below.

TABLE 1A
1st Embodiment

| Surface # | | Curvature Radius | | Thickness | Material | Index | Abbe # | Focal Length |
|---|---|---|---|---|---|---|---|---|
| 0 | Object | Plano | | D0 | | | | |
| 1 | Prism 1 | Plano | | 8.000 | Glass | 1.847 | 23.8 | — |
| 2 | | Plano | | 1.605 | | | | |
| 3 | Stop | Plano | | −0.925 | | | | |
| 4 | Lens 1 | 11.7655 | (ASP) | 1.235 | Glass | 1.569 | 56.0 | 31.38 |
| 5 | | 33.2057 | (ASP) | D1 | | | | |
| 6 | Stop | Plano | | −1.043 | | | | |
| 7 | Lens 2 | 6.7218 | (ASP) | 2.288 | Plastic | 1.534 | 56.0 | 11.10 |
| 8 | | −44.3445 | (ASP) | 0.337 | | | | |
| 9 | Lens 3 | 10.1831 | (ASP) | 0.418 | Plastic | 1.656 | 21.3 | −15.01 |
| 10 | | 4.9249 | (ASP) | 1.521 | | | | |
| 11 | Lens 4 | −73.4127 | (ASP) | 0.511 | Plastic | 1.584 | 28.2 | 20.11 |
| 12 | | −10.1551 | (ASP) | D2 | | | | |
| 13 | Stop | Plano | | 0.046 | | | | |
| 14 | Lens 5 | −3.2504 | (ASP) | 0.400 | Plastic | 1.639 | 23.5 | −28.37 |
| 15 | | −4.1510 | (ASP) | 0.892 | | | | |
| 16 | Lens 6 | 28.2879 | (ASP) | 0.360 | Plastic | 1.656 | 21.3 | 1770.10 |
| 17 | | 28.8480 | (ASP) | 0.381 | | | | |
| 18 | Lens 7 | 76.1980 | (ASP) | 1.193 | Plastic | 1.529 | 45.4 | −18.00 |
| 19 | | 8.4231 | (ASP) | 0.350 | | | | |

| | | | | | | | |
|---|---|---|---|---|---|---|---|
| 20 | Prism 2 | Plano | 6.600 | Glass | 1.847 | 23.8 | — |
| 21 | | Plano | 0.200 | | | | |
| 22 | Filter | Plano | 0.210 | Glass | 1.517 | 64.2 | — |
| 23 | | Plano | 0.100 | | | | |
| 24 | Image | Plano | — | | | | |

Note:
Reference wavelength is 587.6 nm (d-line).
An effective radius of the stop S1 (Surface 3) is 5.080 mm.
An effective radius of the stop S2 (Surface 6) is 3.908 mm.
An effective radius of the stop S3 (Surface 13) is 2.736 mm.
The imaging optical lens assembly can further include an aperture stop, and the position of the aperture stop can be adjusted depending on the object distance, or can be adjusted depending on the arrangement of the front reflective element (the first reflective element) or the trimmed edge(s) of lens element(s).

In Table 1A, the curvature radius, the thickness and the focal length are shown in millimeters (mm). Surface numbers 0-24 represent the surfaces sequentially arranged from the object side to the image side along the optical axis.

TABLE 1B
Values of Optical And Physical Parameters/Definitions

| First State (Infinite | | Second State (Finite | |
|---|---|---|---|
| Object Distance) | | Object Distance) | |
| fL [mm] | 16.67 | fS [mm] | 12.40 |
| FnoL | 1.80 | FnoS | 2.22 |
| HFOVL [deg.] | 17.2 | HFOVS [deg.] | 15.2 |
| Object Distance [mm] | ∞ | Object Distance [mm] | 68.680 |
| D0 [mm] | ∞ | D0 [mm] | 60.000 |
| D1 [mm] | 4.449 | D1 [mm] | 2.365 |
| D2 [mm] | 0.752 | D2 [mm] | 2.836 |

Table 1B shows optical and physical parameters/definitions of the imaging optical lens assembly for the first state and the second state under different focusing conditions. It should be understood that, in this embodiment, only two moving focus states (i.e., the first state and the second state) are disclosed, but the present disclosure is not limited thereto. Besides the first state and the second state, the imaging optical lens assembly in this embodiment can also have other moving focus states with different focal lengths between the first state and the second state to accommodate focusing conditions for other object distances.

In Table 1B, the movable group Gm of the imaging optical lens assembly is moved for focus adjustment according to the change of object distance. For example, the movable group Gm is moved toward the object side along the optical axis for focus adjustment when an imaged object is moved from an infinite object distance to a finite object distance, such that the imaging optical lens assembly is transitioned from the first state to the second state. Specifically, when the object distance changes from infinite to a finite object distance of 68.680 mm, the imaging optical lens assembly is transitioned from the first state to the second state, the axial distance D1 between the image-side surface of the first lens element E1 and the stop S2 decreases from 4.449 mm in the first state to 2.365 mm in the second state, and the axial distance D2 between the image-side surface of the fourth lens element E4 and the stop S3 increases from 0.752 mm in the first state to 2.836 mm in the second state. In other words, when the object distance decreases, the movable group Gm is moved toward the object side along the optical axis during the focus adjustment process.

TABLE 1C
Aspheric Coefficients

| Surface # | 4 | 5 | 7 | 8 |
|---|---|---|---|---|
| k= | 0.0000E+00 | 0.0000E+00 | 0.0000E+00 | 0.0000E+00 |
| A4= | −1.13366906E−04 | −1.17437233E−04 | −1.42360308E−04 | −3.43885283E−03 |
| A6= | −1.21350444E−05 | −2.10528724E−05 | 9.37536482E−06 | 2.14628023E−03 |
| A8= | 3.69636752E−06 | 7.30399971E−06 | 1.75942047E−06 | −9.76506779E−04 |
| A10= | −1.08569705E−06 | −1.90341904E−06 | −6.01856897E−06 | 3.24952267E−04 |
| A12= | 2.20875552E−07 | 3.33050871E−07 | 3.30909487E−06 | −8.64671378E−05 |
| A14= | −3.21293764E−08 | −4.15987384E−08 | −1.04700382E−06 | 1.83175102E−05 |
| A16= | 3.32964310E−09 | 3.80517550E−09 | 2.13243351E−07 | −3.01699286E−06 |
| A18= | −2.44100067E−10 | −2.55978686E−10 | −2.92052265E−08 | 3.78336148E−07 |
| A20= | 1.24921151E−11 | 1.24926053E−11 | 2.72159735E−09 | −3.54550507E−08 |
| A22= | −4.34929974E−13 | −4.28607076E−13 | −1.70441811E−10 | 2.42813414E−09 |
| A24= | 9.79594202E−15 | 9.76033729E−15 | 6.86998624E−12 | −1.17533142E−10 |
| A26= | −1.28523263E−16 | −1.31984313E−16 | −1.61111772E−13 | 3.79953418E−12 |
| A28= | 7.45236477E−19 | 7.99980994E−19 | 1.67136949E−15 | −7.34847323E−14 |
| A30= | — | — | — | 6.42435966E−16 |
| Surface # | 9 | 10 | 11 | 12 |
| k= | 0.0000E+00 | 0.0000E+00 | 0.0000E+00 | 0.0000E+00 |
| A4= | −1.66754707E−02 | −1.56700725E−02 | 4.31072705E−04 | 1.45082785E−03 |
| A6= | 5.36359325E−03 | 4.14614015E−03 | 7.45140899E−04 | 3.85550828E−04 |
| A8= | −1.95051621E−03 | −1.47561415E−03 | −4.05072221E−04 | 1.11188311E−05 |
| A10= | 5.10412788E−04 | 3.42520542E−04 | 1.65651066E−04 | −7.57203281E−05 |
| A12= | −9.90923095E−05 | −5.06051464E−05 | −5.86720516E−05 | 4.32828754E−05 |
| A14= | 1.47530743E−05 | 3.65349816E−06 | 1.46404925E−05 | −1.51069987E−05 |
| A16= | −1.66796543E−06 | 2.76640603E−07 | −2.46331387E−06 | 3.50715156E−06 |
| A18= | 1.38713121E−07 | −1.15608550E−07 | 2.76506648E−07 | −5.41791580E−07 |
| A20= | −8.12699449E−09 | 1.61427885E−08 | −1.96673824E−08 | 5.49160501E−08 |
| A22= | 3.15476082E−10 | −1.31919451E−09 | 7.92187288E−10 | −3.47769485E−09 |
| A24= | −7.26677660E−12 | 6.61366612E−11 | −1.36238064E−11 | 1.22791930E−10 |
| A26= | 7.52615392E−14 | −1.89287753E−12 | — | −1.79623354E−12 |
| A28= | — | 2.38183632E−14 | — | — |
| Surface # | 14 | 15 | 16 | 17 |
| k= | 0.0000E+00 | 0.0000E+00 | 0.0000E+00 | 0.0000E+00 |
| A4= | 6.01413311E−02 | 5.94503525E−02 | 1.40301478E−02 | 6.83249146E−03 |
| A6= | −1.53866870E−02 | −1.43373245E−02 | −1.52480690E−02 | −1.52422024E−02 |
| A8= | 4.36376255E−03 | 2.69418595E−03 | 5.00585041E−03 | 7.31369818E−03 |
| A10= | −1.11658919E−03 | 3.53322840E−04 | 9.87036906E−04 | −1.28092356E−03 |
| A12= | 2.51325144E−04 | −6.54723185E−04 | −2.15184751E−03 | −7.02964710E−04 |
| A14= | −4.76195356E−05 | 3.38637425E−04 | 1.25381318E−03 | 6.19036961E−04 |
| A16= | 7.28842384E−06 | −1.06735096E−04 | −4.26178669E−04 | −2.40493908E−04 |
| A18= | −8.46869058E−07 | 2.23429490E−05 | 9.16565864E−05 | 5.84106692E−05 |
| A20= | 6.85532481E−08 | −3.11660917E−06 | −1.18525937E−05 | −9.42880828E−06 |
| A22= | −3.38317769E−09 | 2.78562445E−07 | 6.46282006E−07 | 1.00455061E−06 |
| A24= | 7.58291518E−11 | −1.44364722E−08 | 5.07675952E−08 | −6.63659783E−08 |
| A26= | — | 3.29829168E−10 | −1.16298430E−08 | 2.25535103E−09 |
| A28= | — | — | 8.07741622E−10 | −1.04690684E−11 |
| A30= | — | — | −2.09271169E−11 | −1.08733821E−12 |

| Surface # | 18 | 19 |
|---|---|---|
| k= | 0.0000E+00 | 0.0000E+00 |
| A4= | −5.83673379E−03 | −6.65460657E−03 |
| A6= | −3.41879680E−03 | −6.53313166E−04 |
| A8= | 1.52197934E−03 | 7.33474109E−04 |
| A10= | 2.02720079E−04 | −3.33977080E−04 |
| A12= | −4.94191047E−04 | 9.93529427E−05 |
| A14= | 2.61417812E−04 | −2.09061271E−05 |
| A16= | −8.12292336E−05 | 3.18413292E−06 |
| A18= | 1.68335626E−05 | −3.53845344E−07 |
| A20= | −2.40683928E−06 | 2.86499120E−08 |
| A22= | 2.37535291E−07 | −1.67099840E−09 |
| A24= | −1.57900187E−08 | 6.84458203E−11 |
| A26= | 6.67544872E−10 | −1.87399992E−12 |
| A28= | −1.58995986E−11 | 3.09714246E−14 |
| A30= | 1.56631189E−13 | −2.35830931E−16 |

In Table 1C, k represents the conic coefficient of the equation of the aspheric surface profiles. A4-A30 represent the aspheric coefficients ranging from the 4th order to the 30th order. The tables presented below for each embodiment are the corresponding schematic parameter and aberration curves, and the definitions of the tables are the same as Table 1A and Table 1C of the 1st embodiment. Therefore, an explanation in this regard will not be provided again.

### 2nd Embodiment

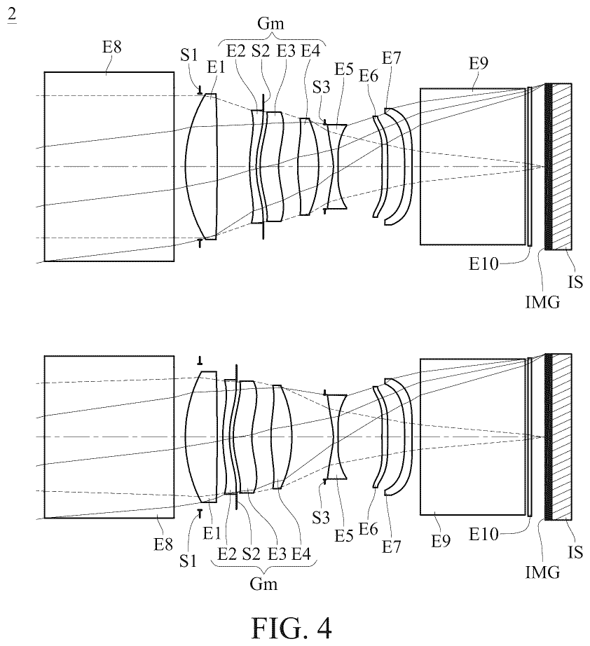

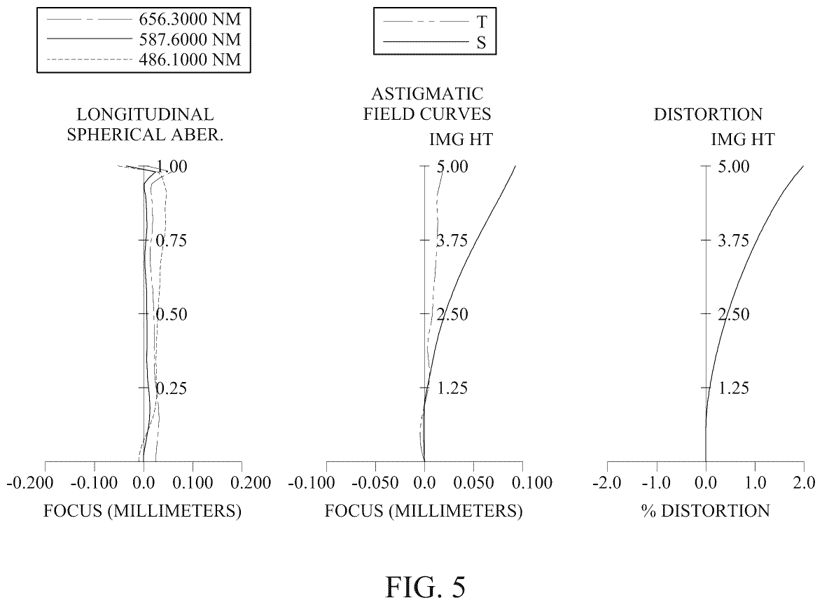

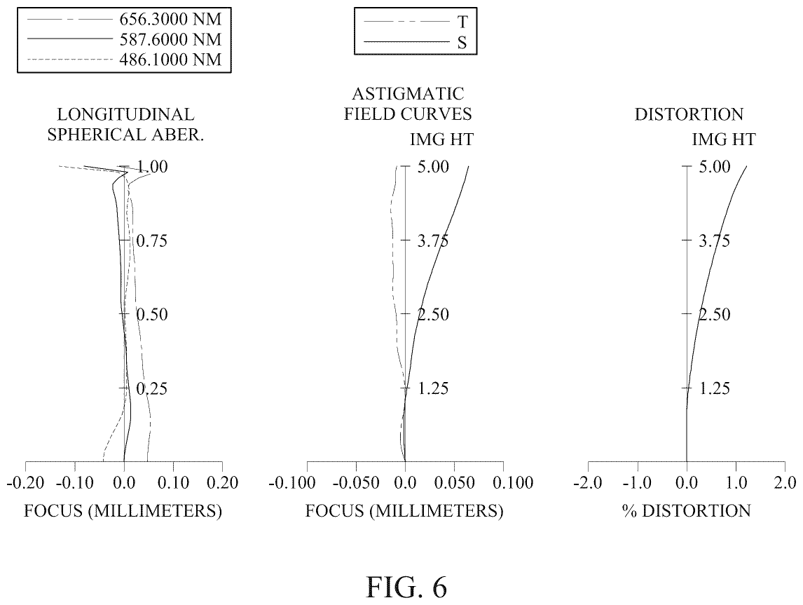

FIG. 4 is a schematic view of an image capturing unit respectively in a first state and a second state according to the 2nd embodiment of the present disclosure. FIG. 5 shows, in order image capturing unit in the first state according to the 2nd embodiment. FIG. 6 shows, in order from left to right, spherical aberration curves, astigmatic field curves and a distortion curve of the image capturing unit in the second state according to the 2nd embodiment. Moreover, the upper part of FIG. 4 shows the schematic view of the imaging optical lens assembly in the first state, and the lower part of FIG. 4 shows the schematic view of the imaging optical lens assembly in the second state. In FIG. 4, the image capturing unit 2 includes the imaging optical lens assembly (its reference numeral is omitted) of the present disclosure and an image sensor IS. The imaging optical lens assembly includes, in order from an object side to an image side along an optical path, a first reflective element E8, a stop S1, a first lens element E1, a second lens element E2, a stop S2, a third lens element E3, a fourth lens element E4, a stop S3, a fifth lens element E5, a sixth lens element E6, a seventh lens element E7, a second reflective element E9, a filter E10 and an image surface IMG. Furthermore, the imaging optical lens assembly has a movable group Gm, and the movable group Gm includes the second lens element E2, the stop S2, the third lens element E3 and the fourth lens element E4. The imaging optical lens assembly includes seven lens elements (E1, E2, E3, E4, E5, E6 and E7) with no additional lens element disposed between each of the adjacent seven lens elements. In addition, there is no additional lens element located between the first lens element E1 and the first reflective element E8 along an optical axis, and there is no additional lens element located between the seventh lens element E7 and the second reflective element E9 along the optical axis.

When an imaged object is located at an infinite object distance, the imaging optical lens assembly is in the first state as shown in the upper part of FIG. 4. When an imaged object is located at a finite object distance, the imaging optical lens assembly is in the second state as shown in the lower part of FIG. 4. When an imaged object is moved from an infinite object distance to a finite object distance, the movable group Gm is moved along the optical axis for focus adjustment, and the imaging optical lens assembly is transitioned from the first state to the second state. Conversely, when an imaged object is moved from a finite object distance to an infinite object distance, the movable group Gm is moved along the optical axis for focus adjustment, and the imaging optical lens assembly is transitioned from the second state to the first state. Particularly, the movable group Gm is moved towards the object side along the optical axis during the focus adjustment process when the imaging optical lens assembly is transitioned from the first state to the second state. It should be noted that all elements (e.g., the stop, lens element, and/or aperture stop) in the movable group Gm are immovable relative to one another during the focus adjustment process.

The first reflective element E8 is made of glass material and located along the optical path between an imaged object and the first lens element E1, and will not affect the focal length of the imaging optical lens assembly. The first reflective element E8 is a prism with optical path folding function.

The first lens element E1 with positive refractive power has an object-side surface being convex in a paraxial region thereof and an image-side surface being convex in a paraxial region thereof. The first lens element E1 is made of plastic material and has the object-side surface and the image-side surface being both aspheric.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has one inflection point. The image-side surface of the second lens element E2 has one inflection point. The object-side surface of the second lens element E2 has one critical point in an off-axis region thereof. The image-side surface of the second lens element E2 has one critical point in an off-axis region thereof.

The third lens element E3 with negative refractive power has an object-side surface being convex in a paraxial region thereof and an image-side surface being concave in a paraxial region thereof. The third lens element E3 is made of plastic material and has the object-side surface and the image-side surface being both aspheric. The object-side surface of the third lens element E3 has one inflection point. The image-side surface of the third lens element E3 has one inflection point. The object-side surface of the third lens element E3 has one critical point in an off-axis region thereof. The image-side surface of the third lens element E3 has one critical point in an off-axis region thereof.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric. The object-side surface of the fourth lens element E4 has two inflection points. The image-side surface of the fourth lens element E4 has one inflection point. The object-side surface of the fourth lens element E4 has one critical point in an off-axis region thereof.

The fifth lens element E5 with negative refractive power has an object-side surface being concave in a paraxial region thereof and an image-side surface being convex in a paraxial region thereof. The fifth lens element E5 is made of plastic material and has the object-side surface and the image-side surface being both aspheric. The object-side surface of the fifth lens element E5 has two inflection points. The image-side surface of the fifth lens element E5 has one inflection point. The image-side surface of the fifth lens element E5 has one critical point in an off-axis region thereof.

The sixth lens element E6 with positive refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has two inflection points. The image-side surface of the sixth lens element E6 has two inflection points. The object-side surface of the sixth lens element E6 has one critical point in an off-axis region thereof. The image-side surface of the sixth lens element E6 has one critical point in an off-axis region thereof.

The seventh lens element E7 with negative refractive power has an object-side surface being concave in a paraxial region thereof and an image-side surface being concave in a paraxial region thereof. The seventh lens element E7 is made of plastic material and has the object-side surface and the image-side surface being both aspheric. The image-side surface of the seventh lens element E7 has one inflection point. The image-side surface of the seventh lens element E7 has one critical point in an off-axis region thereof.

The second reflective element E9 is made of glass material and located along the optical path between the seventh lens element E7 and the image surface IMG, and will not affect the focal length of the imaging optical lens assembly. The second reflective element E9 is a prism with optical path folding function. For simplicity in illustration, FIG. 4 does not show the folding effect caused by the first reflective element E8 and the second reflective element E9 on the optical path. However, the first reflective element E8 and the second reflective element E9 can have various configurations depending on the actual design requirements, thereby creating different folding effects on the optical path. Moreover, the first reflective element E8 and the second reflective element E9 of this embodiment each can have a configuration similar to, for example, one of the configurations shown in FIG. 37 and FIG. 38, which can be referred to foregoing descriptions corresponding to FIG. 37 and FIG. 38, and the details in this regard will not be provided again.

The filter E10 is made of glass material and located between the second reflective element E9 and the image surface IMG, and will not affect the focal length of the imaging optical lens assembly. The image sensor IS is disposed on or near the image surface IMG of the imaging optical lens assembly.

The detailed optical data of the 2nd embodiment are shown in Table 2A and Table 2B, and the aspheric surface data are shown in Table 2C below.

TABLE 2A
2nd Embodiment

| Surface # | | Curvature Radius | | Thickness | Material | Index | Abbe # | Focal Length |
|---|---|---|---|---|---|---|---|---|
| 0 | Object | Plano | | D0 | | | | |
| 1 | Prism 1 | Plano | | 7.800 | Glass | 1.847 | 23.8 | — |
| 2 | | Plano | | 1.555 | | | | |
| 3 | Stop | Plano | | −0.875 | | | | |
| 4 | Lens 1 | 8.4530 | (ASP) | 1.911 | Plastic | 1.544 | 56.0 | 15.32 |
| 5 | | −541.5340 | (ASP) | D1 | | | | |
| 6 | Lens 2 | 9.2982 | (ASP) | 0.400 | Plastic | 1.697 | 16.3 | −31.86 |
| 7 | | 6.4386 | (ASP) | 0.421 | | | | |
| 8 | Stop | Plano | | −0.190 | | | | |
| 9 | Lens 3 | 5.2504 | (ASP) | 1.118 | Plastic | 1.511 | 56.8 | −213.70 |
| 10 | | 4.6488 | (ASP) | 1.149 | | | | |
| 11 | Lens 4 | 8.3046 | (ASP) | 1.259 | Plastic | 1.515 | 56.4 | 8.05 |
| 12 | | −7.8560 | (ASP) | D2 | | | | |
| 13 | Stop | Plano | | 0.519 | | | | |
| 14 | Lens 5 | −2.7372 | (ASP) | 0.286 | Plastic | 1.551 | 44.8 | −6.74 |
| 15 | | −10.8022 | (ASP) | 2.639 | | | | |
| 16 | Lens 6 | 41.1220 | (ASP) | 0.339 | Plastic | 1.697 | 16.3 | 62.88 |
| 17 | | 661.2668 | (ASP) | 1.025 | | | | |
| 18 | Lens 7 | −23.7039 | (ASP) | 0.447 | Plastic | 1.544 | 56.0 | −34.13 |
| 19 | | 86.2718 | (ASP) | 0.500 | | | | |

| | | | | | | | |
|---|---|---|---|---|---|---|---|
| 20 | Prism 2 | Plano | 6.300 | Glass | 1.847 | 23.8 | — |
| 21 | | Plano | 0.180 | | | | |
| 22 | Filter | Plano | 0.210 | Glass | 1.517 | 64.2 | — |
| 23 | | Plano | 0.821 | | | | |
| 24 | Image | Plano | — | | | | |

Note:
Reference wavelength is 587.6 nm (d-line).
An effective radius of the stop S1 (Surface 3) is 4.396 mm.
An effective radius of the stop S2 (Surface 8) is 3.330 mm.
An effective radius of the stop S3 (Surface 13) is 2.557 mm.
The imaging optical lens assembly can further include an aperture stop, and the position of the aperture stop can be adjusted depending on the object distance, or can be adjusted depending on the arrangement of the front reflective element (the first reflective element) or the trimmed edge(s) of lens element(s).

In this embodiment, an axial distance between the image-side surface of the first lens element E1 and the object-side surface of the second lens element E2 is D1. Values of the object distance, D0, D1 and D2 may change depending on whether the imaging optical lens assembly is in the first state or the second state for focus adjustment (as shown in Table 2B below). Except for the aforementioned definition of D1 in this paragraph, the definitions of the parameters shown in Table 2B are the same as those stated in the 1st embodiment, with corresponding values for the 2nd embodiment; therefore, no further explanation will be provided.

TABLE 2B
Values of Optical And Physical Parameters/Definitions

| First State (Infinite | | Second State (Finite | |
|---|---|---|---|
| Object Distance) | | Object Distance) | |
| fL [mm] | 21.38 | fS [mm] | 13.30 |
| FnoL | 2.50 | FnoS | 3.05 |
| HFOVL [deg.] | 12.9 | HFOVS [deg.] | 12.4 |
| Object Distance [mm] | ∞ | Object Distance [mm] | 63.480 |
| D0 [mm] | ∞ | D0 [mm] | 55.000 |
| D1 [mm] | 1.957 | D1 [mm] | 0.344 |
| D2 [mm] | 0.369 | D2 [mm] | 1.982 |

It should be understood that, in this embodiment, only two moving focus states (i.e., the first state and the second state) are disclosed, but the present disclosure is not limited thereto. Besides the first state and the second state, the imaging optical lens assembly in this embodiment can also have other moving focus states with different focal lengths between the first state and the second state to accommodate focusing conditions for other object distances.

In Table 2B, the movable group Gm of the imaging optical lens assembly is moved for focus adjustment according to the change of object distance. For example, the movable group Gm is moved toward the object side along the optical axis for focus adjustment when an imaged object is moved from an infinite object distance to a finite object distance, such that the imaging optical lens assembly is transitioned from the first state to the second state. Specifically, when the object distance changes from infinite to a finite object distance of 63.480 mm, the imaging optical lens assembly is transitioned from the first state to the second state, the axial distance D1 between the image-side surface of the first lens element E1 and the object-side surface of the second lens element E2 decreases from 1.957 mm in the first state to 0.344 mm in the second state, and the axial distance D2 between the image-side surface of the fourth lens element E4 and the stop S3 increases from 0.369 mm in the first state to 1.982 mm in the second state. In other words, when the object distance decreases, the movable group Gm is moved toward the object side along the optical axis during the focus adjustment process.

TABLE 2C
Aspheric Coefficients

| Surface # | 4 | 5 | 6 | 7 |
|---|---|---|---|---|
| k= | 0.0000E+00 | 0.0000E+00 | 0.0000E+00 | 0.0000E+00 |
| A4= | −2.25140773E−05 | −1.91812768E−04 | 2.56759561E−03 | 6.95917515E−03 |
| A6= | 5.66723526E−08 | −1.75447562E−06 | −3.35535837E−03 | −8.21027599E−03 |
| A8= | −5.63926030E−08 | 3.22181738E−07 | 1.52495279E−03 | 4.47828187E−03 |
| A10= | 4.27368375E−09 | −9.44715456E−09 | −5.93159489E−04 | −1.82885846E−03 |
| A12= | — | 1.48742105E−10 | 1.78924145E−04 | 5.44053209E−04 |
| A14= | — | — | −4.36291056E−05 | −1.22549703E−04 |
| A16= | — | — | 8.87725534E−06 | 2.19229078E−05 |
| A18= | — | — | −1.47992110E−06 | −3.20215915E−06 |
| A20= | — | — | 1.92961227E−07 | 3.79105522E−07 |
| A22= | — | — | −1.87356513E−08 | −3.50028404E−08 |
| A24= | — | — | 1.29006117E−09 | 2.38020350E−09 |
| A26= | — | — | −5.91189553E−11 | −1.10495194E−10 |
| A28= | — | — | 1.61145504E−12 | 3.09859047E−12 |
| A30= | — | — | −1.97300936E−14 | −3.93731249E−14 |
| Surface # | 9 | 10 | 11 | 12 |
| k= | 0.0000E+00 | 0.0000E+00 | 0.0000E+00 | 0.0000E+00 |
| A4= | −1.36328257E−03 | −1.18528884E−02 | −3.54954239E−03 | 5.14186148E−04 |
| A6= | −6.34531419E−03 | −1.39944889E−03 | −6.02328657E−04 | −3.54730158E−04 |
| A8= | 3.79218757E−03 | 1.21093379E−03 | 1.23194782E−04 | 1.24719031E−04 |
| A10= | −1.46700773E−03 | −6.17841772E−04 | −3.56801259E−05 | −7.51853714E−05 |
| A12= | 3.90474723E−04 | 2.35940564E−04 | 7.92925362E−06 | 3.29562917E−05 |
| A14= | −7.24765523E−05 | −6.72207447E−05 | −7.62354011E−07 | −9.51413792E−06 |
| A16= | 9.44335268E−06 | 1.43265804E−05 | −6.71585278E−08 | 1.84123799E−06 |
| A18= | −8.60761603E−07 | −2.29032494E−06 | 2.72416223E−08 | −2.40831418E−07 |
| A20= | 5.36470805E−08 | 2.72911766E−07 | −3.08358997E−09 | 2.10588187E−08 |
| A22= | −2.15999606E−09 | −2.38173239E−08 | 1.60651773E−10 | −1.17745400E−09 |
| A24= | 4.95791676E−11 | 1.47431157E−09 | −3.26977644E−12 | 3.78660053E−11 |
| A26= | −4.70762934E−13 | −6.11773447E−11 | — | −5.26893090E−13 |
| A28= | — | 1.52436479E−12 | — | — |
| A30= | — | −1.72297567E−14 | — | — |
| Surface # | 14 | 15 | 16 | 17 |
| k= | 0.0000E+00 | 0.0000E+00 | 0.0000E+00 | 0.0000E+00 |
| A4= | 9.59169480E−02 | 8.35045188E−02 | −5.38146916E−03 | −4.25133020E−03 |
| A6= | −4.84182138E−02 | −4.19731630E−02 | −5.01517087E−03 | −3.37961431E−03 |
| A8= | 2.22841354E−02 | 1.76935106E−02 | 6.05645917E−03 | 2.66077483E−03 |
| A10= | −7.71835558E−03 | −5.95692238E−03 | −7.45392484E−03 | −3.44277971E−03 |
| A12= | 1.92948189E−03 | 1.76140661E−03 | 5.95695383E−03 | 2.82680420E−03 |
| A14= | −3.28753271E−04 | −5.32354369E−04 | −3.11882029E−03 | −1.43954595E−03 |
| A16= | 3.52822149E−05 | 1.60300962E−04 | 1.11863736E−03 | 4.87272861E−04 |
| A18= | −1.99012383E−06 | −3.95202938E−05 | −2.82173913E−04 | −1.13960511E−04 |
| A20= | 2.24723172E−08 | 6.87685215E−06 | 5.05499478E−05 | 1.87034369E−05 |
| A22= | 2.06637135E−09 | −7.70370894E−07 | −6.39786374E−06 | −2.14885752E−06 |
| A24= | — | 4.95937518E−08 | 5.59174849E−07 | 1.69159708E−07 |
| A26= | — | −1.39296824E−09 | −3.21021492E−08 | −8.68492081E−09 |
| A28= | — | — | 1.08904314E−09 | 2.61718975E−10 |
| A30= | — | — | −1.65397043E−11 | −3.50828327E−12 |

| Surface # | 18 | 19 |
|---|---|---|
| k= | 0.0000E+00 | 0.0000E+00 |
| A4= | −6.11521435E−03 | −7.98096923E−03 |
| A6= | −4.50717243E−05 | 8.39512944E−04 |
| A8= | 1.27165802E−03 | 1.84353221E−04 |
| A10= | −2.21889045E−03 | −7.56507236E−04 |
| A12= | 1.70692725E−03 | 5.88494013E−04 |
| A14= | −7.83690162E−04 | −2.51539468E−04 |
| A16= | 2.39351202E−04 | 6.96421226E−05 |
| A18= | −5.09633856E−05 | −1.32747624E−05 |
| A20= | 7.70043418E−06 | 1.78281866E−06 |
| A22= | −8.24201680E−07 | −1.68833098E−07 |
| A24= | 6.11720522E−08 | 1.10528733E−08 |
| A26= | −2.99614611E−09 | −4.76593865E−10 |
| A28= | 8.71015133E−11 | 1.21879746E−11 |
| A30= | −1.13773245E−12 | −1.40119501E−13 |

In the 2nd embodiment, the equation of the aspheric surface profiles of the aforementioned lens elements is the same as the equation of the 1st embodiment. Also, the definitions of these parameters shown in Table 2D below are the same as those stated in the 1st embodiment, with corresponding values for the 2nd embodiment; therefore, an explanation in this regard will not be provided again.

Moreover, these parameters can be calculated from Table 2A to Table 2C as the following values and satisfy the following conditions:

TABLE 2D
Values of Optical and Physical Parameters/Definitions

| | | | |
|---|---|---|---|
| fL [mm] | 21.38 | fL/fS | 1.61 |
| FnoL | 2.50 | TL/fL | 1.01 |
| HFOVL [deg.] | 12.9 | TL/ImgH | 4.33 |
| FOVL [deg.] | 25.8 | fL/f234 | 1.84 |
| Dr3i/BL (1st state) | 2.22 | f1/f2 | −0.48 |
| T12/f + T12/BL (1st state) | 0.34 | (f4 + f5)/f1 | 0.09 |
| T12/CT1 (1st state) | 1.02 | (\|R8\| + \|R10\|)/fL | 0.87 |
| T56/CT1 (1st state) | 1.38 | R10/R1 | −1.28 |
| T34/T45 (1st state) | 1.29 | R6/R3 | 0.50 |
| fS [mm] | 13.30 | R6/R8 | −0.59 |
| FnoS | 3.05 | ΣCT/ΣAT | 0.73 |
| HFOVS [deg.] | 12.4 | 10 × (CT5 + CT6)/f6 | 0.10 |
| FOVS [deg.] | 24.8 | CT6/CT7 | 0.76 |
| Dr3i/BL (2nd state) | 2.42 | ΣETL/ΣCT | 0.76 |
| T12/f + T12/BL (2nd state) | 0.07 | ET6L/CT6 | 0.74 |
| T12/CT1 (2nd state) | 0.18 | ET7L/CT7 | 0.85 |
| T56/CT1 (2nd state) | 1.38 | Y7R1L/Y6R2L | 1.05 |
| T34/T45 (2nd state) | 0.46 | SAG7R1L/SAG7R2L | 0.95 |

### 3rd Embodiment

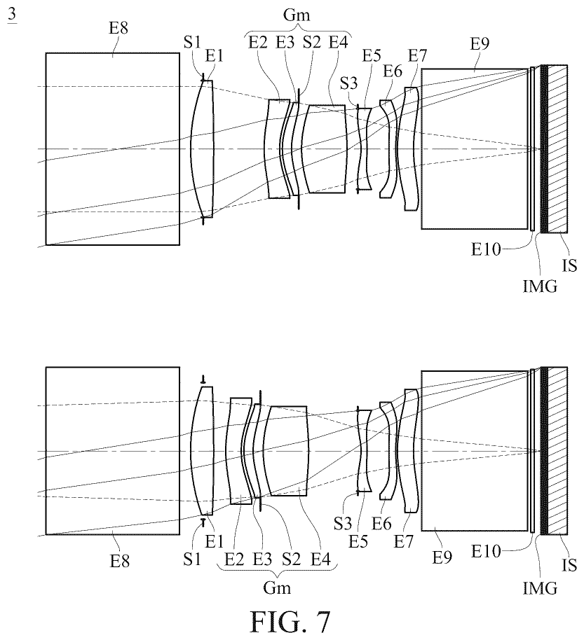

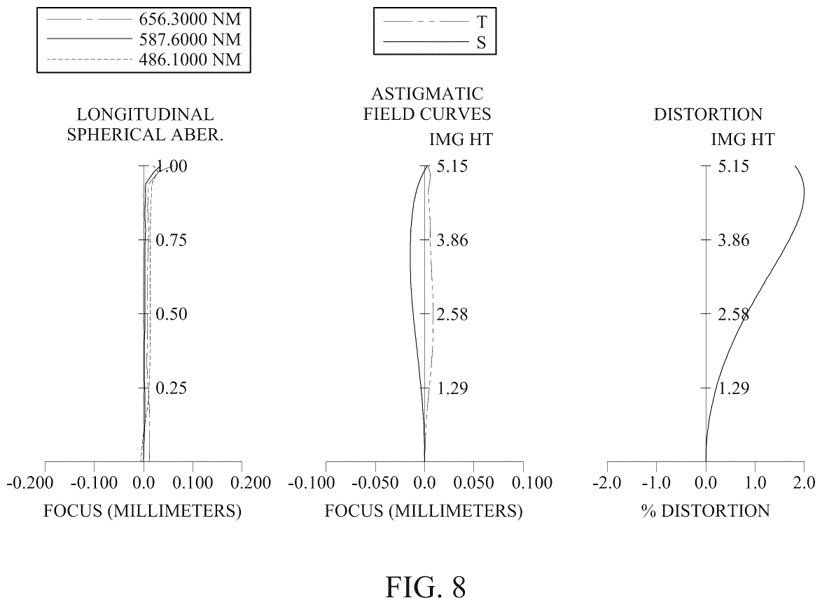

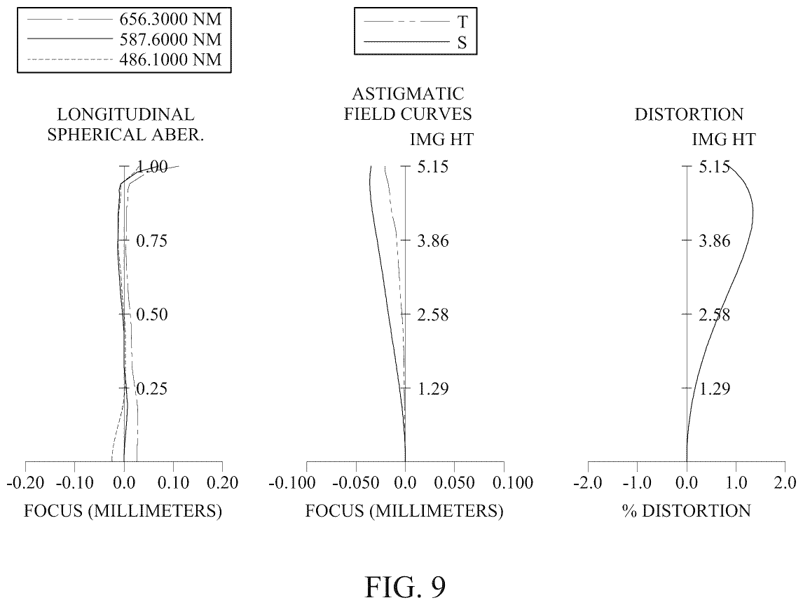

FIG. 7 is a schematic view of an image capturing unit respectively in a first state and a second state according to the 3rd embodiment of the present disclosure. FIG. 8 shows, in order from left to right, spherical aberration curves, astigmatic field curves and a distortion curve of the image capturing unit in the first state according to the 3rd embodiment. FIG. 9 shows, in order from left to right, spherical aberration curves, astigmatic field curves and a distortion curve of the image capturing unit in the second state according to the 3rd embodiment. In FIG. 7, the image capturing unit 3 includes the imaging optical lens assembly (its reference numeral is omitted) of the present disclosure and an image sensor IS. The imaging optical lens assembly includes, in order from an object side to an image side along an optical path, a first reflective element E8, a stop S1, a first lens element E1, a second lens element E2, a third lens element E3, a stop S2, a fourth lens element E4, a stop S3, a fifth lens element E5, a sixth lens element E6, a seventh lens element E7, a second reflective element E9, a filter E10 and an image surface IMG. Furthermore, the imaging optical lens assembly has a movable group Gm, and the movable group Gm includes the second lens element E2, the third lens element E3, the stop S2 and the fourth lens element E4. The imaging optical lens assembly includes seven lens elements (E1, E2, E3, E4, E5, E6 and E7) with no additional lens element disposed between each of the adjacent seven lens elements. In addition, there is no additional lens element located between the first lens element E1 and the first reflective element E8 along an optical axis, and there is no additional lens element located between the seventh lens element E7 and the second reflective element E9 along the optical axis.

When an imaged object is located at an infinite object distance, the imaging optical lens assembly is in the first state as shown in the upper part of FIG. 7. When an imaged object is located at a finite object distance, the imaging optical lens assembly is in the second state as shown in the lower part of FIG. 7. When an imaged object is moved from an infinite object distance to a finite object distance, the movable group Gm is moved along the optical axis for focus adjustment, and the imaging optical lens assembly is transitioned from the first state to the second state. Conversely, when an imaged object is moved from a finite object distance to an infinite object distance, the movable group Gm is moved along the optical axis for focus adjustment, and the imaging optical lens assembly is transitioned from the second state to the first state. Particularly, the movable group Gm is moved towards the object side along the optical axis during the focus adjustment process when the imaging optical lens assembly is transitioned from the first state to the second state. It should be noted that all elements (e.g., the stop, lens element, and/or aperture stop) in the movable group Gm are immovable relative to one another during the focus adjustment process.

The first reflective element E8 is made of glass material and located along the optical path between an imaged object and the first lens element E1, and will not affect the focal length of the imaging optical lens assembly. The first reflective element E8 is a prism with optical path folding function.

The first lens element E1 with positive refractive power has an object-side surface being convex in a paraxial region thereof and an image-side surface being convex in a paraxial region thereof. The first lens element E1 is made of plastic material and has the object-side surface and the image-side surface being both aspheric.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has one inflection point. The image-side surface of the second lens element E2 has one inflection point.

The third lens element E3 with positive refractive power has an object-side surface being convex in a paraxial region thereof and an image-side surface being concave in a paraxial region thereof. The third lens element E3 is made of plastic material and has the object-side surface and the image-side surface being both aspheric. The object-side surface of the third lens element E3 has one inflection point. The image-side surface of the third lens element E3 has one inflection point. The image-side surface of the third lens element E3 has one critical point in an off-axis region thereof.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric. The object-side surface of the fourth lens element E4 has one inflection point. The image-side surface of the fourth lens element E4 has one inflection point.

The fifth lens element E5 with negative refractive power has an object-side surface being concave in a paraxial region thereof and an image-side surface being convex in a paraxial region thereof. The fifth lens element E5 is made of plastic material and has the object-side surface and the image-side surface being both aspheric. The object-side surface of the fifth lens element E5 has one inflection point. The image-side surface of the fifth lens element E5 has one inflection point. The object-side surface of the fifth lens element E5 has one critical point in an off-axis region thereof. The image-side surface of the fifth lens element E5 has one critical point in an off-axis region thereof.

The sixth lens element E6 with negative refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has two inflection points. The image-side surface of the sixth lens element E6 has two inflection points. The object-side surface of the sixth lens element E6 has one critical point in an off-axis region thereof. The image-side surface of the sixth lens element E6 has one critical point in an off-axis region thereof.

The seventh lens element E7 with positive refractive power has an object-side surface being convex in a paraxial region thereof and an image-side surface being concave in a paraxial region thereof. The seventh lens element E7 is made of plastic material and has the object-side surface and the image-side surface being both aspheric. The object-side surface of the seventh lens element E7 has one inflection point. The image-side surface of the seventh lens element E7 has one inflection point. The object-side surface of the seventh lens element E7 has one critical point in an off-axis region thereof. The image-side surface of the seventh lens element E7 has one critical point in an off-axis region thereof.

The second reflective element E9 is made of glass material and located along the optical path between the seventh lens element E7 and the image surface IMG, and will not affect the focal length of the imaging optical lens assembly. The second reflective element E9 is a prism with optical path folding function. For simplicity in illustration, FIG. 7 does not show the folding effect caused by the first reflective element E8 and the second reflective element E9 on the optical path. However, the first reflective element E8 and the second reflective element E9 can have various configurations depending on the actual design requirements, thereby creating different folding effects on the optical path. Moreover, the first reflective element E8 and the second reflective element E9 of this embodiment each can have a configuration similar to, for example, one of the configurations shown in FIG. 37 and FIG. 38, which can be referred to foregoing descriptions corresponding to FIG. 37 and FIG. 38, and the details in this regard will not be provided again.

The filter E10 is made of glass material and located between the second reflective element E9 and the image surface IMG, and will not affect the focal length of the imaging optical lens assembly. The image sensor IS is disposed on or near the image surface IMG of the imaging optical lens assembly.

The detailed optical data of the 3rd embodiment are shown in Table 3A and Table 3B, and the aspheric surface data are shown in Table 3C below.

TABLE 3A
3rd Embodiment

| Surface # | | Curvature Radius | | Thickness | Material | Index | Abbe # | Focal Length |
|---|---|---|---|---|---|---|---|---|
| 0 | Object | Plano | | D0 | | | | |
| 1 | Prism 1 | Plano | | 8.200 | Glass | 1.847 | 23.8 | — |
| 2 | | Plano | | 1.446 | | | | |
| 3 | Stop | Plano | | −0.766 | | | | |
| 4 | Lens 1 | 11.4722 | (ASP) | 1.411 | Plastic | 1.544 | 55.9 | 19.31 |
| 5 | | −117.6471 | (ASP) | D1 | | | | |
| 6 | Lens 2 | 8.1782 | (ASP) | 0.952 | Plastic | 1.642 | 22.5 | −19.63 |
| 7 | | 4.7334 | (ASP) | 0.166 | | | | |
| 8 | Lens 3 | 4.1551 | (ASP) | 0.563 | Plastic | 1.544 | 56.0 | 94.13 |
| 9 | | 4.3061 | (ASP) | 0.449 | | | | |
| 10 | Stop | Plano | | 0.170 | | | | |
| 11 | Lens 4 | 6.4008 | (ASP) | 2.787 | Plastic | 1.534 | 56.0 | 8.72 |
| 12 | | −14.4988 | (ASP) | D2 | | | | |
| 13 | Stop | Plano | | 0.198 | | | | |
| 14 | Lens 5 | −2.9037 | (ASP) | 0.370 | Plastic | 1.511 | 56.8 | −12.93 |
| 15 | | −5.4032 | (ASP) | 1.337 | | | | |
| 16 | Lens 6 | 20.3118 | (ASP) | 0.420 | Plastic | 1.615 | 25.4 | −23.92 |
| 17 | | 8.4609 | (ASP) | 0.100 | | | | |
| 18 | Lens 7 | 6.1996 | (ASP) | 0.993 | Plastic | 1.551 | 44.8 | 48.97 |
| 19 | | 7.5920 | (ASP) | 0.500 | | | | |

| | | | | | | | |
|---|---|---|---|---|---|---|---|
| 20 | Prism 2 | Plano | 6.500 | Glass | 1.847 | 23.8 | — |
| 21 | | Plano | 0.200 | | | | |
| 22 | Filter | Plano | 0.210 | Glass | 1.517 | 64.2 | — |
| 23 | | Plano | 0.413 | | | | |
| 24 | Image | Plano | — | | | | |

Note:
Reference wavelength is 587.6 nm (d-line).
An effective radius of the stop S1 (Surface 3) is 4.205 mm.
An effective radius of the stop S2 (Surface 10) is 2.827 mm.
An effective radius of the stop S3 (Surface 13) is 2.474 mm.
The imaging optical lens assembly can further include an aperture stop, and the position of the aperture stop can be adjusted depending on the object distance, or can be adjusted depending on the arrangement of the front reflective element (the first reflective element) or the trimmed edge(s) of lens element(s).

In this embodiment, an axial distance between the image-side surface of the first lens element E1 and the object-side surface of the second lens element E2 is D1. Values of the object distance, D0, D1 and D2 may change depending on whether the imaging optical lens assembly is in the first state or the second state for focus adjustment (as shown in Table 3B below). Except for the aforementioned definition of D1 in this paragraph, the definitions of the parameters shown in Table 3B are the same as those stated in the 1st embodiment, with corresponding values for the 3rd embodiment; therefore, no further explanation will be provided.

TABLE 3B
Values of Optical And Physical Parameters/Definitions

| First State (Infinite | | Second State (Finite | |
|---|---|---|---|
| Object Distance) | | Object Distance) | |
| fL [mm] | 17.14 | fS [mm] | 11.89 |
| FnoL | 2.22 | FnoS | 2.92 |
| HFOVL [deg.] | 16.4 | HFOVS [deg.] | 14.9 |
| Object Distance [mm] | ∞ | Object Distance [mm] | 58.880 |
| D0 [mm] | ∞ | D0 [mm] | 50.000 |
| D1 [mm] | 3.100 | D1 [mm] | 0.743 |
| D2 [mm] | 0.666 | D2 [mm] | 3.023 |

It should be understood that, in this embodiment, only two moving focus states (i.e., the first state and the second state) are disclosed, but the present disclosure is not limited thereto. Besides the first state and the second state, the imaging optical lens assembly in this embodiment can also have other moving focus states with different focal lengths between the first state and the second state to accommodate focusing conditions for other object distances.

In Table 3B, the movable group Gm of the imaging optical lens assembly is moved for focus adjustment according to the change of object distance. For example, the movable group Gm is moved toward the object side along the optical axis for focus adjustment when an imaged object is moved from an infinite object distance to a finite object distance, such that the imaging optical lens assembly is transitioned from the first state to the second state. Specifically, when the object distance changes from infinite to a finite object distance of 58.880 mm, the imaging optical lens assembly is transitioned from the first state to the second state, the axial distance D1 between the image-side surface of the first lens element E1 and the object-side surface of the second lens element E2 decreases from 3.100 mm in the first state to 0.743 mm in the second state, and the axial distance D2 between the image-side surface of the fourth lens element E4 and the stop S3 increases from 0.666 mm in the first state to 3.023 mm in the second state. In other words, when the object distance decreases, the movable group Gm is moved toward the object side along the optical axis during the focus adjustment process.

TABLE 3C
Aspheric Coefficients

| Surface # | 4 | 5 | 6 | 7 |
|---|---|---|---|---|
| k= | 0.0000E+00 | 0.0000E+00 | 0.0000E+00 | 0.0000E+00 |
| A4= | −4.81606923E−05 | −7.15149322E−05 | −1.54497255E−03 | 3.41837184E−03 |
| A6= | 1.63257061E−06 | 1.90799265E−06 | −4.51409211E−04 | −5.25102307E−03 |
| A8= | −1.94475903E−07 | −2.03966189E−07 | −2.22572157E−04 | 6.85645659E−04 |
| A10= | 6.10410805E−09 | 1.09522547E−08 | 2.96184569E−04 | 1.13953135E−03 |
| A12= | — | −1.46237767E−10 | −1.73298991E−04 | −9.83175274E−04 |
| A14= | — | — | 6.51448456E−05 | 4.35825071E−04 |
| A16= | — | — | −1.70588357E−05 | −1.27926403E−04 |
| A18= | — | — | 3.20069926E−06 | 2.64590207E−05 |
| A20= | — | — | −4.32511714E−07 | −3.90644774E−06 |
| A22= | — | — | 4.16512751E−08 | 4.07674222E−07 |
| A24= | — | — | −2.78153064E−09 | −2.92410404E−08 |
| A26= | — | — | 1.22111415E−10 | 1.36649676E−09 |
| A28= | — | — | −3.16195100E−12 | −3.74084865E−11 |
| A30= | — | — | 3.65066224E−14 | 4.56098290E−13 |
| Surface # | 8 | 9 | 11 | 12 |
| k= | 0.0000E+00 | 0.0000E+00 | 0.0000E+00 | 0.0000E+00 |
| A4= | −1.56560601E−04 | −1.05280332E−02 | −2.29522637E−03 | 1.90848475E−03 |
| A6= | −6.20606975E−03 | −1.28770125E−03 | −1.90684099E−04 | −4.76033129E−04 |
| A8= | 1.38363166E−03 | −6.66132440E−05 | −2.78458175E−05 | 8.03823606E−04 |
| A10= | 8.54498962E−04 | 1.05827161E−03 | 1.21871308E−04 | −7.64572201E−04 |
| A12= | −7.76930083E−04 | −9.01859120E−04 | −6.57985478E−05 | 4.80899815E−04 |
| A14= | 3.11065566E−04 | 4.64601141E−04 | 1.92257882E−05 | −2.03960757E−04 |
| A16= | −7.90956882E−05 | −1.70547559E−04 | −3.57366717E−06 | 5.92813280E−05 |
| A18= | 1.36809855E−05 | 4.59466918E−05 | 4.33436525E−07 | −1.18264343E−05 |
| A20= | −1.60554699E−06 | −9.06145061E−06 | −3.33149831E−08 | 1.59143124E−06 |
| A22= | 1.22068712E−07 | 1.28820358E−06 | 1.47751841E−09 | −1.37969161E−07 |
| A24= | −5.40454962E−09 | −1.28228431E−07 | −2.88853600E−11 | 6.95425684E−09 |
| A26= | 1.05402287E−10 | 8.47017241E−09 | — | −1.54772807E−10 |
| A28= | — | −3.33245370E−10 | — | — |
| A30= | — | 5.90612884E−12 | — | — |
| Surface # | 14 | 15 | 16 | 17 |
| k= | 0.0000E+00 | 0.0000E+00 | 0.0000E+00 | 0.0000E+00 |
| A4= | 8.14608873E−02 | 7.33993982E−02 | 6.55408615E−03 | 3.00952325E−04 |
| A6= | −2.97673110E−02 | −2.54735442E−02 | −1.74827748E−02 | −1.94391453E−02 |
| A8= | 1.07978631E−02 | 6.69517725E−03 | 1.11381721E−02 | 1.51267616E−02 |
| A10= | −3.18404536E−03 | −7.01452848E−04 | −6.85790153E−03 | −8.74973092E−03 |
| A12= | 7.45056063E−04 | −3.87372321E−04 | 3.48528881E−03 | 3.91229810E−03 |
| A14= | −1.32315452E−04 | 2.63550018E−04 | −1.32481875E−03 | −1.34562236E−03 |
| A16= | 1.70942622E−05 | −8.85895869E−05 | 3.56493041E−04 | 3.55074771E−04 |
| A18= | −1.50578031E−06 | 1.95595418E−05 | −6.23330415E−05 | −7.13311154E−05 |
| A20= | 8.04995680E−08 | −2.93570684E−06 | 5.27153885E−06 | 1.07492088E−05 |
| A22= | −1.94764505E−09 | 2.89269922E−07 | 3.54015416E−07 | −1.18723919E−06 |
| A24= | — | −1.68889589E−08 | −1.59900473E−07 | 9.27250481E−08 |
| A26= | — | 4.42650974E−10 | 2.00417708E−08 | −4.82580399E−09 |
| A28= | — | — | −1.22084159E−09 | 1.49543986E−10 |
| A30= | — | — | 3.05555627E−11 | −2.07984156E−12 |

| Surface # | 18 | 19 |
|---|---|---|
| k= | 0.0000E+00 | 0.0000E+00 |
| A4= | −1.26772499E−02 | −9.97027545E−03 |
| A6= | −3.07387109E−03 | 2.23670214E−03 |
| A8= | 5.43585615E−03 | −5.47817881E−04 |
| A10= | −3.06692159E−03 | 1.82278480E−04 |
| A12= | 1.10232423E−03 | −6.55781225E−05 |
| A14= | −2.82908007E−04 | 1.78460053E−05 |
| A16= | 5.37286665E−05 | −3.40807022E−06 |
| A18= | −7.63969517E−06 | 4.57550793E−07 |
| A20= | 8.12139795E−07 | −4.33773402E−08 |
| A22= | −6.36712488E−08 | 2.88299136E−09 |
| A24= | 3.57435657E−09 | −1.31071564E−10 |
| A26= | −1.35916656E−10 | 3.86797817E−12 |
| A28= | 3.13486850E−12 | −6.63908058E−14 |
| A30= | −3.31011845E−14 | 4.98569860E−16 |

In the 3rd embodiment, the equation of the aspheric surface profiles of the aforementioned lens elements is the same as the equation of the 1st embodiment. Also, the definitions of these parameters shown in Table 3D below are the same as those stated in the 1st embodiment, with corresponding values for the 3rd embodiment; therefore, an explanation in this regard will not be provided again.

Moreover, these parameters can be calculated from Table 3A to Table 3C as the following values and satisfy the following conditions:

TABLE 3D
Values of Optical and Physical Parameters/Definitions

| | | | |
|---|---|---|---|
| fL [mm] | 17.14 | fL/fS | 1.44 |
| FnoL | 2.22 | TL/fL | 1.25 |
| HFOVL [deg.] | 16.4 | TL/ImgH | 4.18 |
| FOVL [deg.] | 32.8 | fL/f234 | 1.20 |
| Dr3i/BL (1st state) | 2.17 | f1/f2 | −0.98 |
| T12/f + T12/BL (1st state) | 0.58 | (f4 + f5)/f1 | −0.22 |
| T12/CT1 (1st state) | 2.20 | (\|R8\| + \|R10\|)/fL | 1.16 |
| T56/CT1 (1st state) | 0.95 | R10/R1 | −0.47 |
| T34/T45 (1st state) | 0.72 | R6/R3 | 0.53 |
| fS [mm] | 11.89 | R6/R8 | −0.30 |
| FnoS | 2.92 | ΣCT/ΣAT | 1.21 |
| HFOVS [deg.] | 14.9 | 10 × (CT5 + CT6)/f6 | −0.33 |
| FOVS [deg.] | 29.8 | CT6/CT7 | 0.42 |
| Dr3i/BL (2nd state) | 2.47 | ΣETL/ΣCT | 0.86 |
| T12/f + T12/BL (2nd state) | 0.16 | ET6L/CT6 | 1.59 |
| T12/CT1 (2nd state) | 0.53 | ET7L/CT7 | 0.69 |
| T56/CT1 (2nd state) | 0.95 | Y7R1L/Y6R2L | 1.17 |
| T34/T45 (2nd state) | 0.19 | SAG7R1L/SAG7R2L | 2.98 |

### 4th Embodiment

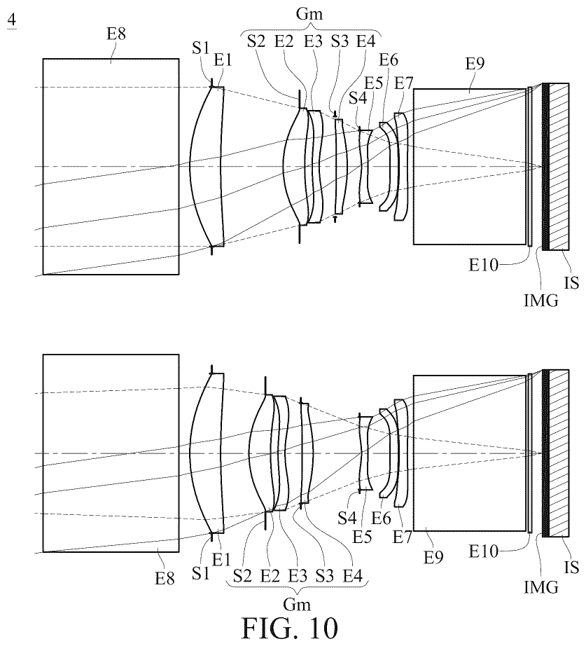

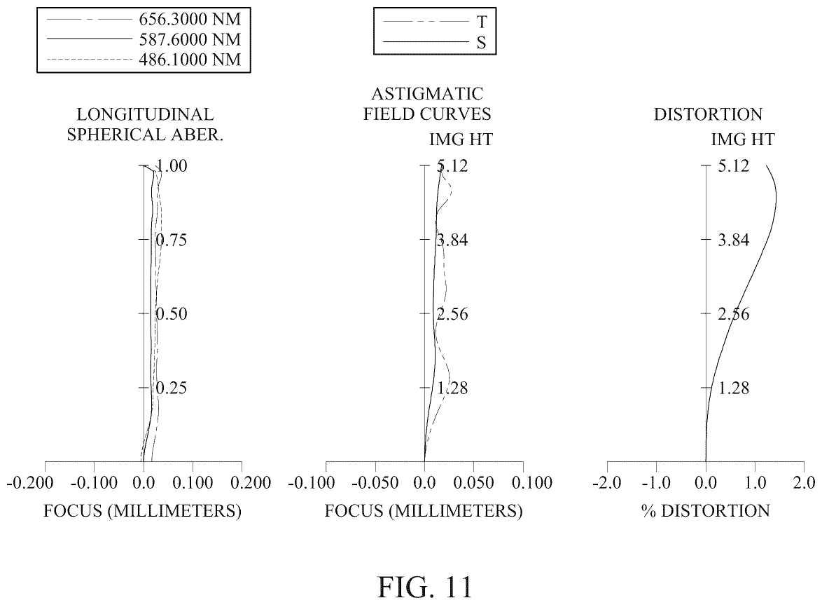

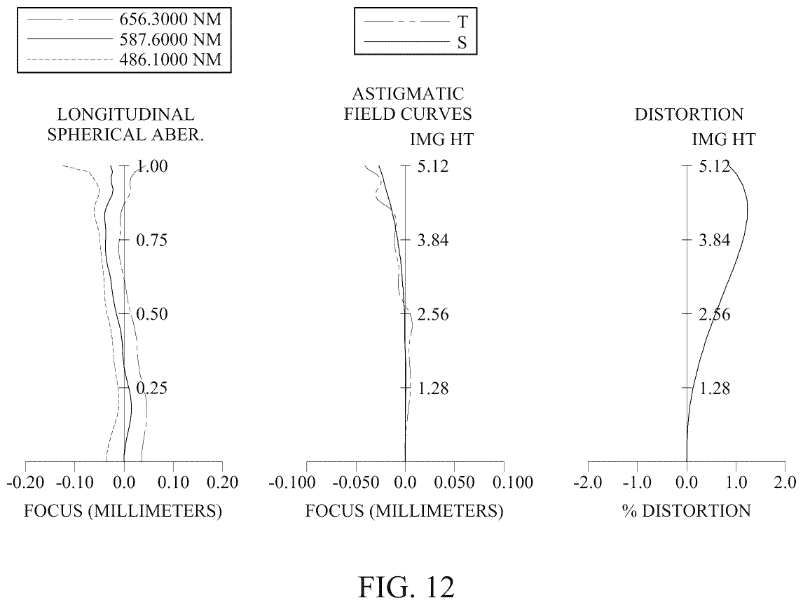

FIG. 10 is a schematic view of an image capturing unit respectively in a first state and a second state according to the 4th embodiment of the present disclosure. FIG. 11 shows, in order image capturing unit in the first state according to the 4th embodiment. FIG. 12 shows, in order from left to right, spherical aberration curves, astigmatic field curves and a distortion curve of the image capturing unit in the second state according to the 4th embodiment. In FIG. 10, the image capturing unit 4 includes the imaging optical lens assembly (its reference numeral is omitted) of the present disclosure and an image sensor IS. The imaging optical lens assembly includes, in order from an object side to an image side along an optical path, a first reflective element E8, a stop S1, a first lens element E1, a stop S2, a second lens element E2, a third lens element E3, a stop S3, a fourth lens element E4, a stop S4, a fifth lens element E5, a sixth lens element E6, a seventh lens element E7, a second reflective element E9, a filter E10 and an image surface IMG. Furthermore, the imaging optical lens assembly has a movable group Gm, and the movable group Gm includes the stop S2, the second lens element E2, the third lens element E3, the stop S3 and the fourth lens element E4. The imaging optical lens assembly includes seven lens elements (E1, E2, E3, E4, E5, E6 and E7) with no additional lens element disposed between each of the adjacent seven lens elements. In addition, there is no additional lens element located between the first lens element E1 and the first reflective element E8 along an optical axis, and there is no additional lens element located between the seventh lens element E7 and the second reflective element E9 along the optical axis.

When an imaged object is located at an infinite object distance, the imaging optical lens assembly is in the first state as shown in the upper part of FIG. 10. When an imaged object is located at a finite object distance, the imaging optical lens assembly is in the second state as shown in the lower part of FIG. 10. When an imaged object is moved from an infinite object distance to a finite object distance, the movable group Gm is moved along the optical axis for focus adjustment, and the imaging optical lens assembly is transitioned from the first state to the second state. Conversely, when an imaged object is moved from a finite object distance to an infinite object distance, the movable group Gm is moved along the optical axis for focus adjustment, and the imaging optical lens assembly is transitioned from the second state to the first state. Particularly, the movable group Gm is moved towards the object side along the optical axis during the focus adjustment process when the imaging optical lens assembly is transitioned from the first state to the second state. It should be noted that all elements (e.g., the stop, lens element, and/or aperture stop) in the movable group Gm are immovable relative to one another during the focus adjustment process.

The first reflective element E8 is made of glass material and located along the optical path between an imaged object and the first lens element E1, and will not affect the focal length of the imaging optical lens assembly. The first reflective element E8 is a prism with optical path folding function.

The first lens element E1 with positive refractive power has an object-side surface being convex in a paraxial region thereof and an image-side surface being concave in a paraxial region thereof. The first lens element E1 is made of glass material and has the object-side surface and the image-side surface being both aspheric. The object-side surface of the first lens element E1 has one inflection point. The image-side surface of the first lens element E1 has one inflection point.

The second lens element E2 with positive refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has one inflection point. The image-side surface of the second lens element E2 has one inflection point. The image-side surface of the second lens element E2 has one critical point in an off-axis region thereof.

The third lens element E3 with negative refractive power has an object-side surface being convex in a paraxial region thereof and an image-side surface being concave in a paraxial region thereof. The third lens element E3 is made of plastic material and has the object-side surface and the image-side surface being both aspheric. The object-side surface of the third lens element E3 has two inflection points. The image-side surface of the third lens element E3 has one inflection point. The object-side surface of the third lens element E3 has one critical point in an off-axis region thereof. The image-side surface of the third lens element E3 has one critical point in an off-axis region thereof.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric. The object-side surface of the fourth lens element E4 has two inflection points. The image-side surface of the fourth lens element E4 has one inflection point. The object-side surface of the fourth lens element E4 has two critical points in an off-axis region thereof. The image-side surface of the fourth lens element E4 has one critical point in an off-axis region thereof.

The fifth lens element E5 with negative refractive power has an object-side surface being concave in a paraxial region thereof and an image-side surface being convex in a paraxial region thereof. The fifth lens element E5 is made of plastic material and has the object-side surface and the image-side surface being both aspheric. The object-side surface of the fifth lens element E5 has one inflection point. The image-side surface of the fifth lens element E5 has one inflection point. The object-side surface of the fifth lens element E5 has one critical point in an off-axis region thereof. The image-side surface of the fifth lens element E5 has one critical point in an off-axis region thereof.

The sixth lens element E6 with positive refractive power has an object-side surface being concave in a paraxial region thereof and an image-side surface being convex in a paraxial region thereof. The sixth lens element E6 is made of plastic material and has the object-side surface and the image-side surface being both aspheric. The object-side surface of the sixth lens element E6 has one inflection point. The image-side surface of the sixth lens element E6 has one inflection point.

The seventh lens element E7 with negative refractive power has an object-side surface being concave in a paraxial region thereof and an image-side surface being concave in a paraxial region thereof. The seventh lens element E7 is made of plastic material and has the object-side surface and the image-side surface being both aspheric. The object-side surface of the seventh lens element E7 has three inflection points. The image-side surface of the seventh lens element E7 has three inflection points. The image-side surface of the seventh lens element E7 has one critical point in an off-axis region thereof.

The second reflective element E9 is made of glass material and located along the optical path between the seventh lens element E7 and the image surface IMG, and will not affect the focal length of the imaging optical lens assembly. The second reflective element E9 is a prism with optical path folding function. For simplicity in illustration, FIG. 10 does not show the folding effect caused by the first reflective element E8 and the second reflective element E9 on the optical path. However, the first reflective element E8 and the second reflective element E9 can have various configurations depending on the actual design requirements, thereby creating different folding effects on the optical path. Moreover, the first reflective element E8 and the second reflective element E9 of this embodiment each can have a configuration similar to, for example, one of the configurations shown in FIG. 37 and FIG. 38, which can be referred to foregoing descriptions corresponding to FIG. 37 and FIG. 38, and the details in this regard will not be provided again.

The filter E10 is made of glass material and located between the second reflective element E9 and the image surface IMG, and will not affect the focal length of the imaging optical lens assembly. The image sensor IS is disposed on or near the image surface IMG of the imaging optical lens assembly.

The detailed optical data of the 4th embodiment are shown in Table 4A and Table 4B, and the aspheric surface data are shown in Table 4C below.

TABLE 4A
4th Embodiment

| Surface # | | Curvature Radius | | Thickness | Material | Index | Abbe # | Focal Length |
|---|---|---|---|---|---|---|---|---|
| 0 | Object | Plano | | D0 | | | | |
| 1 | Prism 1 | Plano | | 8.350 | Glass | 1.847 | 23.8 | — |
| 2 | | Plano | | 2.023 | | | | |
| 3 | Stop | Plano | | −1.343 | | | | |
| 4 | Lens 1 | 8.9044 | (ASP) | 1.895 | Glass | 1.497 | 81.6 | 22.48 |
| 5 | | 40.6962 | (ASP) | D1 | | | | |
| 6 | Stop | Plano | | −1.010 | | | | |
| 7 | Lens 2 | 5.9785 | (ASP) | 1.328 | Plastic | 1.544 | 56.0 | 18.69 |
| 8 | | 13.3735 | (ASP) | 0.459 | | | | |
| 9 | Lens 3 | 9.1919 | (ASP) | 0.430 | Plastic | 1.660 | 20.4 | −24.79 |
| 10 | | 5.7755 | (ASP) | 0.976 | | | | |
| 11 | Stop | Plano | | 0.073 | | | | |
| 12 | Lens 4 | 217.9183 | (ASP) | 0.681 | Plastic | 1.544 | 56.0 | 16.21 |
| 13 | | −9.1798 | (ASP) | D2 | | | | |
| 14 | Stop | Plano | | 0.121 | | | | |
| 15 | Lens 5 | −3.4626 | (ASP) | 0.400 | Plastic | 1.566 | 37.4 | −16.62 |
| 16 | | −5.7084 | (ASP) | 1.356 | | | | |
| 17 | Lens 6 | −20.4874 | (ASP) | 0.504 | Plastic | 1.669 | 19.5 | 2596.79 |
| 18 | | −20.4483 | (ASP) | 0.050 | | | | |
| 19 | Lens 7 | −39.4068 | (ASP) | 0.506 | Plastic | 1.544 | 56.0 | −19.72 |
| 20 | | 14.8097 | (ASP) | 0.380 | | | | |

| | | | | | | | |
|---|---|---|---|---|---|---|---|
| 21 | Prism 2 | Plano | 6.900 | Glass | 1.847 | 23.8 | — |
| 22 | | Plano | 0.150 | | | | |
| 23 | Filter | Plano | 0.210 | Glass | 1.517 | 64.2 | — |
| 24 | | Plano | 0.670 | | | | |
| 25 | Image | Plano | — | | | | |

Note:
Reference wavelength is 587.6 nm (d-line).
An effective radius of the stop S1 (Surface 3) is 4.900 mm.
An effective radius of the stop S2 (Surface 6) is 3.599 mm.
An effective radius of the stop S3 (Surface 11) is 3.088 mm.
An effective radius of the stop S4 (Surface 14) is 2.223 mm.
The imaging optical lens assembly can further include an aperture stop, and the position of the aperture stop can be adjusted depending on the object distance, or can be adjusted depending on the arrangement of the front reflective element (the first reflective element) or the trimmed edge(s) of lens element(s).

In this embodiment, an axial distance between the image-side surface of the fourth lens element E4 and the stop S4 is D2. Values of the object distance, D0, D1 and D2 may change depending on whether the imaging optical lens assembly is in the first state or the second state for focus adjustment (as shown in Table 4B below). Except for the aforementioned definition of D2 in this paragraph, the definitions of the parameters shown in Table 4B are the same as those stated in the 1st embodiment, with corresponding values for the 4th embodiment; therefore, no further explanation will be provided.

TABLE 4B
Values of Optical And Physical Parameters/Definitions

| First State (Infinite | | Second State (Finite | |
|---|---|---|---|
| Object Distance) | | Object Distance) | |
| fL [mm] | 18.81 | fS [mm] | 13.02 |
| FnoL | 1.93 | FnoS | 2.47 |
| HFOVL [deg.] | 15.0 | HFOVS [deg.] | 13.4 |
| Object Distance [mm] | ∞ | Object Distance [mm] | 69.030 |
| D0 [mm] | ∞ | D0 [mm] | 60.000 |
| D1 [mm] | 4.847 | D1 [mm] | 2.747 |
| D2 [mm] | 0.754 | D2 [mm] | 2.854 |

It should be understood that, in this embodiment, only two moving focus states (i.e., the first state and the second state) are disclosed, but the present disclosure is not limited thereto. Besides the first state and the second state, the imaging optical lens assembly in this embodiment can also have other moving focus states with different focal lengths between the first state and the second state to accommodate focusing conditions for other object distances.

In Table 4B, the movable group Gm of the imaging optical lens assembly is moved for focus adjustment according to the change of object distance. For example, the movable group Gm is moved toward the object side along the optical axis for focus adjustment when an imaged object is moved from an infinite object distance to a finite object distance, such that the imaging optical lens assembly is transitioned from the first state to the second state. Specifically, when the object distance changes from infinite to a finite object distance of 69.030 mm, the imaging optical lens assembly is transitioned from the first state to the second state, the axial distance D1 between the image-side surface of the first lens element E1 and the stop S2 decreases from 4.847 mm in the first state to 2.747 mm in the second state, and the axial distance D2 between the image-side surface of the fourth lens element E4 and the stop S4 increases from 0.754 mm in the first state to 2.854 mm in the second state. In other words, when the object distance decreases, the movable group Gm is moved toward the object side along the optical axis during the focus adjustment process.

TABLE 4C
Aspheric Coefficients

| Surface # | 4 | 5 | 7 | 8 |
|---|---|---|---|---|
| k= | 0.0000E+00 | 0.0000E+00 | 0.0000E+00 | 0.0000E+00 |
| A4= | −1.61463256E−04 | −1.26192622E−04 | −3.73871589E−06 | −2.71295255E−03 |
| A6= | 3.94533894E−05 | −3.93986927E−05 | 1.09240102E−04 | 2.30940746E−03 |
| A8= | −2.43352309E−05 | 3.46531915E−05 | 5.56937519E−05 | −1.14785113E−03 |
| A10= | 1.01164494E−05 | −1.45490160E−05 | −8.83204920E−05 | 5.19412571E−04 |
| A12= | −2.79138020E−06 | 3.77790992E−06 | 5.55044502E−05 | −2.31737739E−04 |
| A14= | 5.21821659E−07 | −6.65076120E−07 | −2.22365730E−05 | 8.18370381E−05 |
| A16= | −6.79552130E−08 | 8.26314296E−08 | 6.05522695E−06 | −2.10137295E−05 |
| A18= | 6.27446495E−09 | −7.38625475E−09 | −1.14895885E−06 | 3.87826480E−06 |
| A20= | −4.13203035E−10 | 4.77562904E−10 | 1.53312615E−07 | −5.13816697E−07 |
| A22= | 1.92745688E−11 | −2.21582897E−11 | −1.43154466E−08 | 4.84041438E−08 |
| A24= | −6.22040984E−13 | 7.19907013E−13 | 9.14661977E−10 | −3.16187558E−09 |
| A26= | 1.32079186E−14 | −1.55592287E−14 | −3.80517054E−11 | 1.36032725E−10 |
| A28= | −1.65983929E−16 | 2.01040500E−16 | 9.27374688E−13 | −3.46441519E−12 |
| A30= | 9.35346571E−19 | −1.17544191E−18 | −1.00294796E−14 | 3.95465039E−14 |
| Surface # | 9 | 10 | 12 | 13 |
| k= | 0.0000E+00 | 0.0000E+00 | 0.0000E+00 | 0.0000E+00 |
| A4= | −1.46469001E−02 | −1.46918150E−02 | −2.45487027E−03 | −3.99226567E−05 |
| A6= | 5.28016601E−03 | 4.44129231E−03 | 7.35416884E−04 | 1.76525861E−04 |
| A8= | −1.95351838E−03 | −1.78743668E−03 | −6.76102256E−04 | −2.66813794E−05 |
| A10= | 4.58999526E−04 | 4.73983133E−04 | 3.89069514E−04 | −6.93815866E−05 |
| A12= | −8.25294182E−05 | −1.02739194E−04 | −1.55221854E−04 | 8.22786291E−05 |
| A14= | 1.45954302E−05 | 2.44507060E−05 | 4.38682388E−05 | −4.28817838E−05 |
| A16= | −2.54438534E−06 | −5.88142438E−06 | −8.58835470E−06 | 1.34769505E−05 |
| A18= | 3.49403431E−07 | 1.09467851E−06 | 1.12403068E−06 | −2.73410525E−06 |
| A20= | −3.25319804E−08 | −1.41176672E−07 | −9.27434065E−08 | 3.60211344E−07 |
| A22= | 1.89491144E−09 | 1.22725347E−08 | 4.32669850E−09 | −2.97050404E−08 |
| A24= | −6.22330812E−11 | −7.03596380E−10 | −8.65618768E−11 | 1.38902730E−09 |
| A26= | 8.80707059E−13 | 2.53677946E−11 | — | −2.80246381E−11 |
| A28= | — | −5.16399391E−13 | — | — |
| A30= | — | 4.45027496E−15 | — | — |
| Surface # | 15 | 16 | 17 | 18 |
| k= | 0.0000E+00 | 0.0000E+00 | 0.0000E+00 | 0.0000E+00 |
| A4= | 6.61627752E−02 | 6.55648447E−02 | 2.33305874E−02 | 2.50678317E−02 |
| A6= | −1.84779814E−02 | −1.88505770E−02 | −2.73953984E−02 | −4.13352040E−02 |
| A8= | 5.85034355E−03 | 1.11633327E−02 | 2.63519006E−02 | 4.59647484E−02 |
| A10= | −2.66090605E−03 | −1.19884097E−02 | −2.54424922E−02 | −3.94307919E−02 |
| A12= | 1.49156114E−03 | 1.03484393E−02 | 1.76187556E−02 | 2.41331798E−02 |
| A14= | −6.66929775E−04 | −6.09978124E−03 | −8.10600290E−03 | −1.07304157E−02 |
| A16= | 2.05181026E−04 | 2.46780396E−03 | 2.26022874E−03 | 3.53081682E−03 |
| A18= | −4.17307917E−05 | −6.87855955E−04 | −2.45401619E−04 | −8.63772848E−04 |
| A20= | 5.36964433E−06 | 1.29960172E−04 | −6.86975412E−05 | 1.55791748E−04 |
| A22= | −3.96384452E−07 | −1.58979876E−05 | 3.48034359E−05 | −2.03022081E−05 |
| A24= | 1.28025699E−08 | 1.13586079E−06 | −7.02481375E−06 | 1.84689937E−06 |
| A26= | — | −3.59723763E−08 | 7.87554969E−07 | −1.10625831E−07 |
| A28= | — | — | −4.79633962E−08 | 3.90239837E−09 |
| A30= | — | — | 1.24114798E−09 | −6.11937951E−11 |

| Surface # | 19 | 20 |
|---|---|---|
| k= | 0.0000E+00 | 0.0000E+00 |
| A4= | −1.40608418E−02 | −2.51072426E−02 |
| A6= | −1.36691786E−02 | 1.19419596E−02 |
| A8= | 2.92226565E−02 | −4.61004617E−03 |
| A10= | −2.45051669E−02 | 1.68490886E−03 |
| A12= | 1.26551481E−02 | −5.50462514E−04 |
| A14= | −4.39124416E−03 | 1.47685154E−04 |
| A16= | 1.05871607E−03 | −3.15920473E−05 |
| A18= | −1.80074694E−04 | 5.25616895E−06 |
| A20= | 2.16579619E−05 | −6.58497375E−07 |
| A22= | −1.82156286E−06 | 5.99354115E−08 |
| A24= | 1.04077052E−07 | −3.80271383E−09 |
| A26= | −3.81134961E−09 | 1.58449080E−10 |
| A28= | 7.94337276E−11 | −3.88459705E−12 |
| A30= | −6.96700232E−13 | 4.24127058E−14 |

In the 4th embodiment, the equation of the aspheric surface profiles of the aforementioned lens elements is the same as the equation of the 1st embodiment. Also, the definitions of these parameters shown in Table 4D below are the same as those stated in the 1st embodiment, with corresponding values for the 4th embodiment; therefore, an explanation in this regard will not be provided again.

Moreover, these parameters can be calculated from Table 4A to Table 4C as the following values and satisfy the following conditions:

TABLE 4D
Values of Optical and Physical Parameters/Definitions

| | | | |
|---|---|---|---|
| fL [mm] | 18.81 | fL/fS | 1.44 |
| FnoL | 1.93 | TL/fL | 1.15 |
| HFOVL [deg.] | 15.0 | TL/ImgH | 4.23 |
| FOVL [deg.] | 30.0 | fL/f234 | 1.33 |
| Dr3i/BL (1st state) | 1.92 | f1/f2 | 1.20 |
| T12/f + T12/BL (1st state) | 0.67 | (f4 + f5)/f1 | −0.02 |
| T12/CT1 (1st state) | 2.02 | (\|R8\| + \|R10\|)/fL | 0.79 |
| T56/CT1 (1st state) | 0.72 | R10/R1 | −0.64 |
| T34/T45 (1st state) | 1.20 | R6/R3 | 0.97 |
| fS [mm] | 13.02 | R6/R8 | −0.63 |
| FnoS | 2.47 | ΣCT/ΣAT | 0.75 |
| HFOVS [deg.] | 13.4 | 10 × (CT5 + CT6)/f6 | 0.0035 |
| FOVS [deg.] | 26.8 | CT6/CT7 | 1.00 |
| Dr3i/BL (2nd state) | 2.17 | ΣETL/ΣCT | 0.70 |
| T12/f + T12/BL (2nd state) | 0.34 | ET6L/CT6 | 0.85 |
| T12/CT1 (2nd state) | 0.92 | ET7L/CT7 | 1.02 |
| T56/CT1 (2nd state) | 0.72 | Y7R1L/Y6R2L | 1.12 |
| T34/T45 (2nd state) | 0.35 | SAG7R1L/SAG7R2L | 1.03 |

### 5th Embodiment

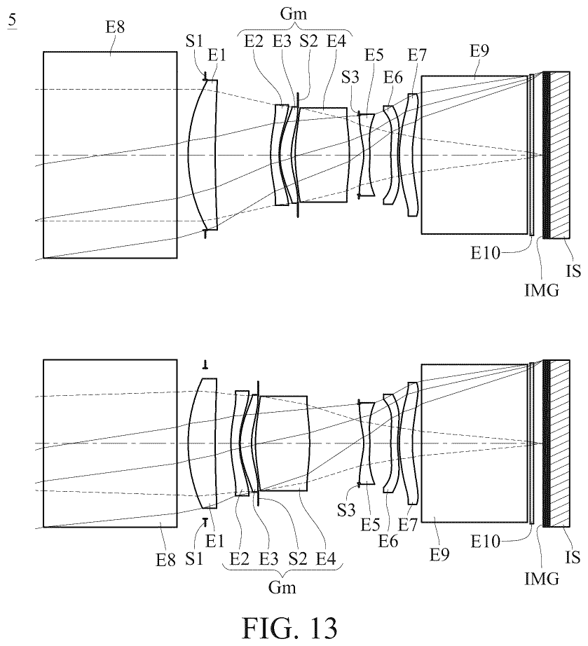

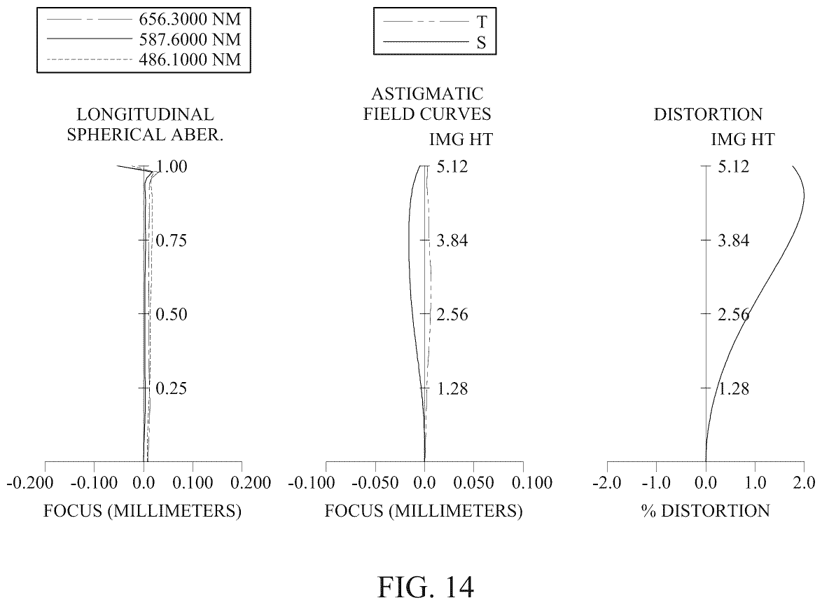

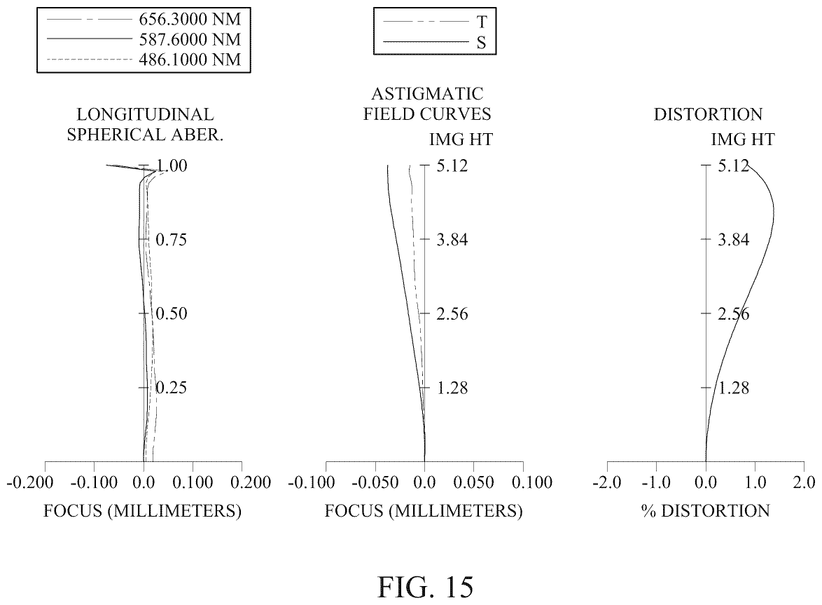

FIG. 13 is a schematic view of an image capturing unit respectively in a first state and a second state according to the 5th embodiment of the present disclosure. FIG. 14 shows, in order from left to right, spherical aberration curves, astigmatic field curves and a distortion curve of the image capturing unit in the first state according to the 5th embodiment. FIG. 15 shows, in order from left to right, spherical aberration curves, astigmatic field curves and a distortion curve of the image capturing unit in the second state according to the 5th embodiment. In FIG. 13, the image capturing unit 5 includes the imaging optical lens assembly (its reference numeral is omitted) of the present disclosure and an image sensor IS. The imaging optical lens assembly includes, in order from an object side to an image side along an optical path, a first reflective element E8, a stop S1, a first lens element E1, a second lens element E2, a third lens element E3, a stop S2, a fourth lens element E4, a stop S3, a fifth lens element E5, a sixth lens element E6, a seventh lens element E7, a second reflective element E9, a filter E10 and an image surface IMG. Furthermore, the imaging optical lens assembly has a movable group Gm, and the movable group Gm includes the second lens element E2, the third lens element E3, the stop S2 and the fourth lens element E4. The imaging optical lens assembly includes seven lens elements (E1, E2, E3, E4, E5, E6 and E7) with no additional lens element disposed between each of the adjacent seven lens elements. In addition, there is no additional lens element located between the first lens element E1 and the first reflective element E8 along an optical axis, and there is no additional lens element located between the seventh lens element E7 and the second reflective element E9 along the optical axis.

When an imaged object is located at an infinite object distance, the imaging optical lens assembly is in the first state as shown in the upper part of FIG. 13. When an imaged object is located at a finite object distance, the imaging optical lens assembly is in the second state as shown in the lower part of FIG. 13. When an imaged object is moved from an infinite object distance to a finite object distance, the movable group Gm is moved along the optical axis for focus adjustment, and the imaging optical lens assembly is transitioned from the first state to the second state. Conversely, when an imaged object is moved from a finite object distance to an infinite object distance, the movable group Gm is moved along the optical axis for focus adjustment, and the imaging optical lens assembly is transitioned from the second state to the first state. Particularly, the movable group Gm is moved towards the object side along the optical axis during the focus adjustment process when the imaging optical lens assembly is transitioned from the first state to the second state. It should be noted that all elements (e.g., the stop, lens element, and/or aperture stop) in the movable group Gm are immovable relative to one another during the focus adjustment process.

The first reflective element E8 is made of glass material and located along the optical path between an imaged object and the first lens element E1, and will not affect the focal length of the imaging optical lens assembly. The first reflective element E8 is a prism with optical path folding function.

The first lens element E1 with positive refractive power has an object-side surface being convex in a paraxial region thereof and an image-side surface being concave in a paraxial region thereof. The first lens element E1 is made of plastic material and has the object-side surface and the image-side surface being both aspheric.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has one inflection point. The image-side surface of the second lens element E2 has one inflection point. The object-side surface of the second lens element E2 has one critical point in an off-axis region thereof.

The third lens element E3 with positive refractive power has an object-side surface being convex in a paraxial region thereof and an image-side surface being concave in a paraxial region thereof. The third lens element E3 is made of plastic material and has the object-side surface and the image-side surface being both aspheric. The object-side surface of the third lens element E3 has one inflection point. The image-side surface of the third lens element E3 has one inflection point. The image-side surface of the third lens element E3 has one critical point in an off-axis region thereof.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric. The object-side surface of the fourth lens element E4 has two inflection points. The image-side surface of the fourth lens element E4 has one inflection point.

The fifth lens element E5 with negative refractive power has an object-side surface being concave in a paraxial region thereof and an image-side surface being convex in a paraxial region thereof. The fifth lens element E5 is made of plastic material and has the object-side surface and the image-side surface being both aspheric. The object-side surface of the fifth lens element E5 has one inflection point. The image-side surface of the fifth lens element E5 has one inflection point. The image-side surface of the fifth lens element E5 has one critical point in an off-axis region thereof.

The sixth lens element E6 with negative refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has two inflection points. The image-side surface of the sixth lens element E6 has two inflection points. The object-side surface of the sixth lens element E6 has one critical point in an off-axis region thereof. The image-side surface of the sixth lens element E6 has one critical point in an off-axis region thereof.

The seventh lens element E7 with positive refractive power has an object-side surface being convex in a paraxial region thereof and an image-side surface being concave in a paraxial region thereof. The seventh lens element E7 is made of plastic material and has the object-side surface and the image-side surface being both aspheric. The object-side surface of the seventh lens element E7 has one inflection point. The image-side surface of the seventh lens element E7 has one inflection point. The object-side surface of the seventh lens element E7 has one critical point in an off-axis region thereof. The image-side surface of the seventh lens element E7 has one critical point in an off-axis region thereof.

The second reflective element E9 is made of glass material and located along the optical path between the seventh lens element E7 and the image surface IMG, and will not affect the focal length of the imaging optical lens assembly. The second reflective element E9 is a prism with optical path folding function. For simplicity in illustration, FIG. 13 does not show the folding effect caused by the first reflective element E8 and the second reflective element E9 on the optical path. However, the first reflective element E8 and the second reflective element E9 can have various configurations depending on the actual design requirements, thereby creating different folding effects on the optical path. Moreover, the first reflective element E8 and the second reflective element E9 of this embodiment each can have a configuration similar to, for example, one of the configurations shown in FIG. 37 and FIG. 38, which can be referred to foregoing descriptions corresponding to FIG. 37 and FIG. 38, and the details in this regard will not be provided again.

The filter E10 is made of glass material and located between the second reflective element E9 and the image surface IMG, and will not affect the focal length of the imaging optical lens assembly. The image sensor IS is disposed on or near the image surface IMG of the imaging optical lens assembly.

The detailed optical data of the 5th embodiment are shown in Table 5A and Table 5B, and the aspheric surface data are shown in Table 5C below.

TABLE 5A
5th Embodiment

| Surface # | | Curvature Radius | | Thickness | Material | Index | Abbe # | Focal Length |
|---|---|---|---|---|---|---|---|---|
| 0 | Object | Plano | | D0 | | | | |
| 1 | Prism 1 | Plano | | 8.200 | Glass | 1.847 | 23.8 | — |
| 2 | | Plano | | 1.728 | | | | |
| 3 | Stop | Plano | | −1.048 | | | | |
| 4 | Lens 1 | 9.4974 | (ASP) | 1.667 | Plastic | 1.544 | 56.0 | 19.92 |
| 5 | | 71.9708 | (ASP) | D1 | | | | |
| 6 | Lens 2 | 7.9958 | (ASP) | 0.518 | Plastic | 1.669 | 19.5 | −22.76 |
| 7 | | 5.1064 | (ASP) | 0.050 | | | | |
| 8 | Lens 3 | 3.9976 | (ASP) | 0.700 | Plastic | 1.544 | 56.0 | 44.69 |
| 9 | | 4.4891 | (ASP) | 0.399 | | | | |
| 10 | Stop | Plano | | −0.162 | | | | |
| 11 | Lens 4 | 9.4385 | (ASP) | 3.329 | Plastic | 1.544 | 56.0 | 10.27 |
| 12 | | −11.9834 | (ASP) | D2 | | | | |
| 13 | Stop | Plano | | 0.301 | | | | |
| 14 | Lens 5 | −2.9119 | (ASP) | 0.380 | Plastic | 1.511 | 56.8 | −10.94 |
| 15 | | −6.3489 | (ASP) | 1.287 | | | | |
| 16 | Lens 6 | 15.7989 | (ASP) | 0.420 | Plastic | 1.587 | 28.3 | −43.08 |
| 17 | | 9.6299 | (ASP) | 0.100 | | | | |
| 18 | Lens 7 | 6.2994 | (ASP) | 0.798 | Plastic | 1.544 | 56.0 | 72.11 |
| 19 | | 7.1694 | (ASP) | 0.570 | | | | |

| | | | | | | | |
|---|---|---|---|---|---|---|---|
| 20 | Prism 2 | Plano | 6.500 | Glass | 1.847 | 23.8 | — |
| 21 | | Plano | 0.160 | | | | |
| 22 | Filter | Plano | 0.210 | Glass | 1.517 | 64.2 | — |
| 23 | | Plano | 0.599 | | | | |
| 24 | Image | Plano | — | | | | |

Note:
Reference wavelength is 587.6 nm (d-line).
An effective radius of the stop S1 (Surface 3) is 4.620 mm.
An effective radius of the stop S2 (Surface 10) is 2.923 mm.
An effective radius of the stop S3 (Surface 13) is 2.435 mm.
The imaging optical lens assembly can further include an aperture stop, and the position of the aperture stop can be adjusted depending on the object distance, or can be adjusted depending on the arrangement of the front reflective element (the first reflective element) or the trimmed edge(s) of lens element(s).

In this embodiment, an axial distance between the image-side surface of the first lens element E1 and the object-side surface of the second lens element E2 is D1. Values of the object distance, D0, D1 and D2 may change depending on whether the imaging optical lens assembly is in the first state or the second state for focus adjustment (as shown in Table 5B below). Except for the aforementioned definition of D1 in this paragraph, the definitions of the parameters shown in Table 5B are the same as those stated in the 1st embodiment, with corresponding values for the 5th embodiment; therefore, no further explanation will be provided.

TABLE 5B
Values of Optical And Physical Parameters/Definitions

| First State | | Second State | |
|---|---|---|---|
| (Infinite Object Distance) | | (Finite Object Distance) | |
| fL [mm] | 16.67 | fS [mm] | 12.15 |
| FnoL | 1.80 | FnoS | 2.93 |
| HFOVL [deg.] | 17.2 | HFOVS [deg.] | 14.2 |
| Object Distance [mm] | ∞ | Object Distance [mm] | 58.880 |
| D0 [mm] | ∞ | D0 [mm] | 50.000 |
| D1 [mm] | 3.400 | D1 [mm] | 0.962 |
| D2 [mm] | 0.580 | D2 [mm] | 3.018 |

It should be understood that, in this embodiment, only two moving focus states (i.e., the first state and the second state) are disclosed, but the present disclosure is not limited thereto. Besides the first state and the second state, the imaging optical lens assembly in this embodiment can also have other moving focus states with different focal lengths between the first state and the second state to accommodate focusing conditions for other object distances.

In Table 5B, the movable group Gm of the imaging optical lens assembly is moved for focus adjustment according to the change of object distance. For example, the movable group Gm is moved toward the object side along the optical axis for focus adjustment when an imaged object is moved from an infinite object distance to a finite object distance, such that the imaging optical lens assembly is transitioned from the first state to the second state. Specifically, when the object distance changes from infinite to a finite object distance of 58.880 mm, the imaging optical lens assembly is transitioned from the first state to the second state, the axial distance D1 between the image-side surface of the first lens element E1 and the object-side surface of the second lens element E2 decreases from 3.400 mm in the first state to 0.962 mm in the second state, and the axial distance D2 between the image-side surface of the fourth lens element E4 and the stop S3 increases from 0.580 mm in the first state to 3.018 mm in the second state. In other words, when the object distance decreases, the movable group Gm is moved toward the object side along the optical axis during the focus adjustment process.

TABLE 5C
Aspheric Coefficients

| Surface # | 4 | 5 | 6 | 7 |
|---|---|---|---|---|
| k= | 0.0000E+00 | 0.0000E+00 | 0.0000E+00 | 0.0000E+00 |
| A4= | −7.08900609E−06 | −7.28591927E−05 | −5.47748033E−05 | −1.54089379E−03 |
| A6= | 7.58658552E−07 | 1.10235577E−06 | −4.32251861E−04 | 3.47231323E−03 |
| A8= | −1.77956388E−08 | −3.56244444E−08 | −2.99557579E−04 | −5.24240774E−03 |
| A10= | 7.41712273E−10 | 2.45848895E−09 | 2.13678915E−04 | 3.61396070E−03 |
| A12= | 1.76359087E−11 | −3.65701156E−11 | −9.08614400E−05 | −1.66166609E−03 |
| A14= | — | — | 2.75484539E−05 | 5.50079015E−04 |
| A16= | — | — | −6.04240716E−06 | −1.34752430E−04 |
| A18= | — | — | 9.44664548E−07 | 2.45968224E−05 |
| A20= | — | — | −1.00945881E−07 | −3.32643574E−06 |
| A22= | — | — | 6.71272729E−09 | 3.28055548E−07 |
| A24= | — | — | −2.02522687E−10 | −2.29260735E−08 |
| A26= | — | — | −4.46783416E−12 | 1.07813766E−09 |
| A28= | — | — | 5.44756583E−13 | −3.07399702E−11 |
| A30= | — | — | −1.24417685E−14 | 4.04002401E−13 |
| Surface # | 8 | 9 | 11 | 12 |
| k= | 0.0000E+00 | 0.0000E+00 | 0.0000E+00 | 0.0000E+00 |
| A4= | −8.75187519E−03 | −9.76566035E−03 | −1.13312601E−03 | 1.79668200E−03 |
| A6= | 5.08248594E−03 | 5.11797003E−04 | 2.38159638E−04 | −2.80973597E−04 |
| A8= | −5.82686427E−03 | −7.56139668E−04 | −9.26784363E−04 | 5.71397453E−04 |
| A10= | 3.74432049E−03 | 2.35467590E−04 | 6.84962282E−04 | −5.46837462E−04 |
| A12= | −1.56498511E−03 | 1.23354376E−04 | −3.20028551E−04 | 3.47883393E−04 |
| A14= | 4.55026521E−04 | −1.48669951E−04 | 1.01665987E−04 | −1.49866228E−04 |
| A16= | −9.40495125E−05 | 7.13132599E−05 | −2.15183468E−05 | 4.44311570E−05 |
| A18= | 1.37603070E−05 | −2.09360932E−05 | 2.95120729E−06 | −9.06509253E−06 |
| A20= | −1.38999351E−06 | 4.09481333E−06 | −2.50654871E−07 | 1.24917931E−06 |
| A22= | 9.19722554E−08 | −5.45572722E−07 | 1.19613027E−08 | −1.10940904E−07 |
| A24= | −3.57822260E−09 | 4.91145188E−08 | −2.45146506E−10 | 5.72664479E−09 |
| A26= | 6.19098901E−11 | −2.86927369E−09 | — | −1.30426231E−10 |
| A28= | — | 9.85368964E−11 | — | — |
| A30= | — | −1.51479847E−12 | — | — |
| Surface # | 14 | 15 | 16 | 17 |
| k= | 0.0000E+00 | 0.0000E+00 | 0.0000E+00 | 0.0000E+00 |
| A4= | 7.88448934E−02 | 7.14406109E−02 | 1.20734551E−02 | 1.49950758E−02 |
| A6= | −3.08331001E−02 | −2.66674758E−02 | −1.78126418E−02 | −2.63134180E−02 |
| A8= | 1.20415473E−02 | 7.69150151E−03 | 9.26837396E−03 | 1.52509168E−02 |
| A10= | −3.97555505E−03 | −1.09547193E−03 | −4.32580374E−03 | −6.61061964E−03 |
| A12= | 1.10122637E−03 | −3.25752663E−04 | 1.62263103E−03 | 2.29795929E−03 |
| A14= | −2.50160584E−04 | 2.83071662E−04 | −4.17167781E−04 | −6.49635588E−04 |
| A16= | 4.53396123E−05 | −1.03472960E−04 | 4.56278774E−05 | 1.49236977E−04 |
| A18= | −6.24027939E−06 | 2.40332283E−05 | 1.34909187E−05 | −2.75094879E−05 |
| A20= | 6.03710843E−07 | −3.72394276E−06 | −7.74414087E−06 | 3.96727115E−06 |
| A22= | −3.60449298E−08 | 3.73598036E−07 | 1.86822364E−06 | −4.31480372E−07 |
| A24= | 9.89000148E−10 | −2.19739477E−08 | −2.69469662E−07 | 3.37170839E−08 |
| A26= | — | 5.75418758E−10 | 2.39063850E−08 | −1.76687437E−09 |
| A28= | — | — | −1.20780083E−09 | 5.51135077E−11 |
| A30= | — | — | 2.66885509E−11 | −7.67709477E−13 |

| Surface # | 18 | 19 |
|---|---|---|
| k= | 0.0000E+00 | 0.0000E+00 |
| A4= | −3.18076403E−03 | −1.04782402E−02 |
| A6= | −9.32142812E−03 | 2.31382510E−03 |
| A8= | 6.92283864E−03 | −5.74337583E−04 |
| A10= | −2.82091173E−03 | 1.88034101E−04 |
| A12= | 8.19170287E−04 | −6.13075898E−05 |
| A14= | −1.82808778E−04 | 1.52981136E−05 |
| A16= | 3.17827194E−05 | −2.76471405E−06 |
| A18= | −4.26719801E−06 | 3.57909310E−07 |
| A20= | 4.35164709E−07 | −3.27613807E−08 |
| A22= | −3.29487584E−08 | 2.06671447E−09 |
| A24= | 1.78989367E−09 | −8.55875831E−11 |
| A26= | −6.58474657E−11 | 2.11194639E−12 |
| A28= | 1.46754573E−12 | −2.45750065E−14 |
| A30= | −1.49467747E−14 | 4.09030069E−17 |

In the 5th embodiment, the equation of the aspheric surface profiles of the aforementioned lens elements is the same as the equation of the 1st embodiment. Also, the definitions of these parameters shown in Table 5D below are the same as those stated in the 1st embodiment, with corresponding values for the 5th embodiment; therefore, an explanation in this regard will not be provided again.

Moreover, these parameters can be calculated from Table 5A to Table 5C as the following values and satisfy the following conditions:

TABLE 5D
Values of Optical and Physical Parameters/Definitions

| | | | |
|---|---|---|---|
| fL [mm] | 16.67 | fL/fS | 1.37 |
| FnoL | 1.80 | TL/fL | 1.23 |
| HFOVL [deg.] | 17.2 | TL/ImgH | 4.26 |
| FOVL [deg.] | 34.4 | fL/f234 | 1.24 |
| Dr3i/BL (1st state) | 2.08 | f1/f2 | −0.88 |
| T12/f + T12/BL (1st state) | 0.61 | (f4 + f5)/f1 | −0.03 |
| T12/CT1 (1st state) | 2.04 | (\|R8\| + \|R10\|)/fL | 1.03 |
| T56/CT1 (1st state) | 0.77 | R10/R1 | −0.67 |
| T34/T45 (1st state) | 0.27 | R6/R3 | 0.56 |
| fS [mm] | 12.15 | R6/R8 | −0.37 |
| FnoS | 2.93 | ΣCT/ΣAT | 1.31 |
| HFOVS [deg.] | 14.2 | 10 × (CT5 + CT6)/f6 | −0.19 |
| FOVS [deg.] | 28.4 | CT6/CT7 | 0.53 |
| Dr3i/BL (2nd state) | 2.39 | ΣETL/ΣCT | 0.84 |
| T12/f + T12/BL (2nd state) | 0.20 | ET6L/CT6 | 1.32 |
| T12/CT1 (2nd state) | 0.58 | ET7L/CT7 | 0.63 |
| T56/CT1 (2nd state) | 0.77 | Y7R1L/Y6R2L | 1.18 |
| T34/T45 (2nd state) | 0.07 | SAG7R1L/SAG7R2L | 2.15 |

### 6th Embodiment

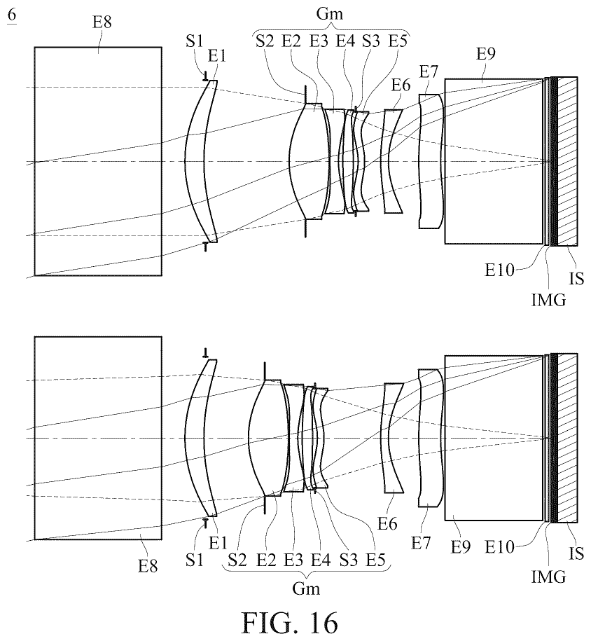

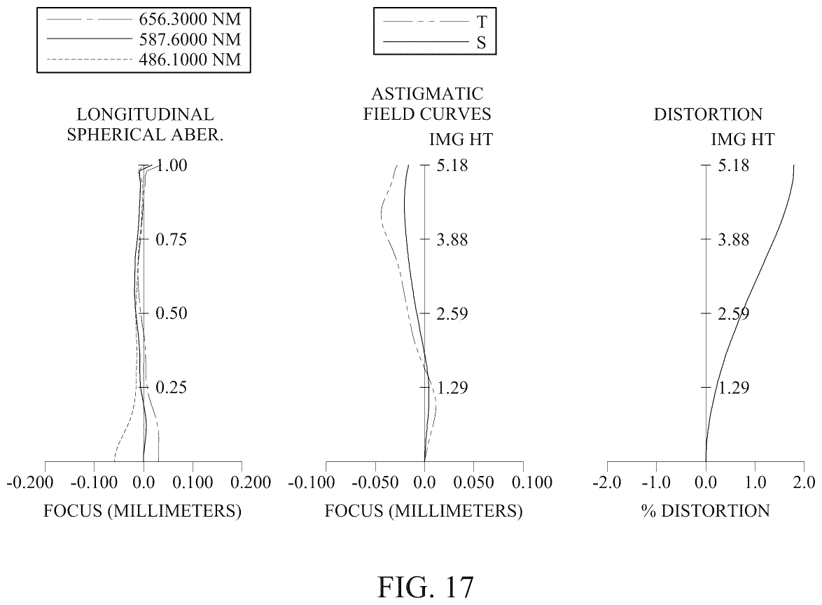

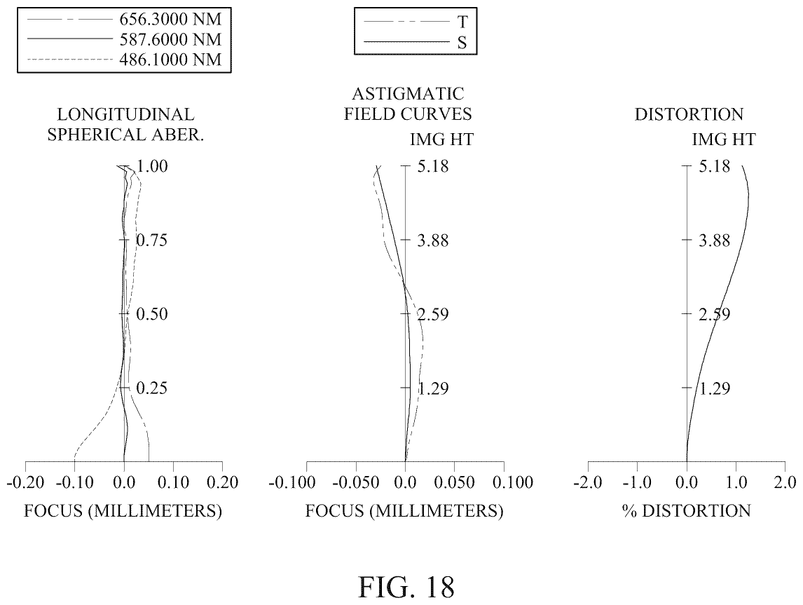

FIG. 16 is a schematic view of an image capturing unit respectively in a first state and a second state according to the 6th embodiment of the present disclosure. FIG. 17 shows, in order image capturing unit in the first state according to the 6th embodiment. FIG. 18 shows, in order from left to right, spherical aberration curves, astigmatic field curves and a distortion curve of the image capturing unit in the second state according to the 6th embodiment. In FIG. 16, the image capturing unit 6 includes the imaging optical lens assembly (its reference numeral is omitted) of the present disclosure and an image sensor IS. The imaging optical lens assembly includes, in order from an object side to an image side along an optical path, a first reflective element E8, a stop S1, a first lens element E1, a stop S2, a second lens element E2, a third lens element E3, a fourth lens element E4, a stop S3, a fifth lens element E5, a sixth lens element E6, a seventh lens element E7, a second reflective element E9, a filter E10 and an image surface IMG. Furthermore, the imaging optical lens assembly has a movable group Gm, and the movable group Gm includes the stop S2, the second lens element E2, the third lens element E3, the fourth lens element E4, the stop S3 and the fifth lens element E5. The imaging optical lens assembly includes seven lens elements (E1, E2, E3, E4, E5, E6 and E7) with no additional lens element disposed between each of the adjacent seven lens elements. In addition, there is no additional lens element located between the first lens element E1 and the first reflective element E8 along an optical axis, and there is no additional lens element located between the seventh lens element E7 and the second reflective element E9 along the optical axis.

When an imaged object is located at an infinite object distance, the imaging optical lens assembly is in the first state as shown in the upper part of FIG. 16. When an imaged object is located at a finite object distance, the imaging optical lens assembly is in the second state as shown in the lower part of FIG. 16. When an imaged object is moved from an infinite object distance to a finite object distance, the movable group Gm is moved along the optical axis for focus adjustment, and the imaging optical lens assembly is transitioned from the first state to the second state. Conversely, when an imaged object is moved from a finite object distance to an infinite object distance, the movable group Gm is moved along the optical axis for focus adjustment, and the imaging optical lens assembly is transitioned from the second state to the first state. Particularly, the movable group Gm is moved towards the object side along the optical axis during the focus adjustment process when the imaging optical lens assembly is transitioned from the first state to the second state. It should be noted that all elements (e.g., the stop, lens element, and/or aperture stop) in the movable group Gm are immovable relative to one another during the focus adjustment process.

The first reflective element E8 is made of glass material and located along the optical path between an imaged object and the first lens element E1, and will not affect the focal length of the imaging optical lens assembly. The first reflective element E8 is a prism with optical path folding function.

The first lens element E1 with positive refractive power has an object-side surface being convex in a paraxial region thereof and an image-side surface being concave in a paraxial region thereof. The first lens element E1 is made of glass material and has the object-side surface and the image-side surface being both aspheric. The object-side surface of the first lens element E1 has one inflection point. The image-side surface of the first lens element E1 has one inflection point.

The second lens element E2 with positive refractive power has an object-side surface being convex in a paraxial region thereof and an image-side surface being convex in a paraxial region thereof. The second lens element E2 is made of plastic material and has the object-side surface and the image-side surface being both aspheric. The object-side surface of the second lens element E2 has one inflection point.

The third lens element E3 with negative refractive power has an object-side surface being convex in a paraxial region thereof and an image-side surface being concave in a paraxial region thereof. The third lens element E3 is made of plastic material and has the object-side surface and the image-side surface being both aspheric. The object-side surface of the third lens element E3 has two inflection points. The image-side surface of the third lens element E3 has one inflection point. The object-side surface of the third lens element E3 has one critical point in an off-axis region thereof. The image-side surface of the third lens element E3 has one critical point in an off-axis region thereof.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric. The image-side surface of the fourth lens element E4 has three inflection points. The image-side surface of the fourth lens element E4 has one critical point in an off-axis region thereof.

The fifth lens element E5 with negative refractive power has an object-side surface being concave in a paraxial region thereof and an image-side surface being convex in a paraxial region thereof. The fifth lens element E5 is made of plastic material and has the object-side surface and the image-side surface being both aspheric. The object-side surface of the fifth lens element E5 has one inflection point. The image-side surface of the fifth lens element E5 has one inflection point. The object-side surface of the fifth lens element E5 has one critical point in an off-axis region thereof. The image-side surface of the fifth lens element E5 has one critical point in an off-axis region thereof.

The sixth lens element E6 with negative refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has one inflection point. The image-side surface of the sixth lens element E6 has one inflection point.

The seventh lens element E7 with negative refractive power has an object-side surface being convex in a paraxial region thereof and an image-side surface being concave in a paraxial region thereof. The seventh lens element E7 is made of plastic material and has the object-side surface and the image-side surface being both aspheric. The object-side surface of the seventh lens element E7 has one inflection point. The image-side surface of the seventh lens element E7 has one inflection point. The object-side surface of the seventh lens element E7 has one critical point in an off-axis region thereof. The image-side surface of the seventh lens element E7 has one critical point in an off-axis region thereof.

The second reflective element E9 is made of glass material and located along the optical path between the seventh lens element E7 and the image surface IMG, and will not affect the focal length of the imaging optical lens assembly. The second reflective element E9 is a prism with optical path folding function. For simplicity in illustration, FIG. 16 does not show the folding effect caused by the first reflective element E8 and the second reflective element E9 on the optical path. However, the first reflective element E8 and the second reflective element E9 can have various configurations depending on the actual design requirements, thereby creating different folding effects on the optical path. Moreover, the first reflective element E8 and the second reflective element E9 of this embodiment each can have a configuration similar to, for example, one of the configurations shown in FIG. 37 and FIG. 38, which can be referred to foregoing descriptions corresponding to FIG. 37 and FIG. 38, and the details in this regard will not be provided again.

The filter E10 is made of glass material and located between the second reflective element E9 and the image surface IMG, and will not affect the focal length of the imaging optical lens assembly. The image sensor IS is disposed on or near the image surface IMG of the imaging optical lens assembly.

The detailed optical data of the 6th embodiment are shown in Table 6A and Table 6B, and the aspheric surface data are shown in Table 6C below.

TABLE 6A
6th Embodiment

| | | | | | | | | Focal |
|---|---|---|---|---|---|---|---|---|
| Surface # | | Curvature Radius | | Thickness | Material | Index | Abbe # | Length |
| 0 | Object | Plano | | D0 | | | | |
| 1 | Prism 1 | Plano | | 7.800 | Glass | 1.847 | 23.8 | — |
| 2 | | Plano | | 2.700 | | | | |
| 3 | Stop | Plano | | −1.259 | | | | |
| 4 | Lens 1 | 7.9542 | (ASP) | 1.166 | Glass | 1.567 | 42.8 | 36.22 |
| 5 | | 12.2894 | (ASP) | D1 | | | | |
| 6 | Stop | Plano | | −1.000 | | | | |
| 7 | Lens 2 | 5.9162 | (ASP) | 2.453 | Plastic | 1.544 | 56.0 | 8.41 |
| 8 | | −17.2775 | (ASP) | 0.050 | | | | |
| 9 | Lens 3 | 16.9429 | (ASP) | 0.527 | Plastic | 1.686 | 18.4 | −9.35 |
| 10 | | 4.5953 | (ASP) | 0.271 | | | | |
| 11 | Lens 4 | 21.6607 | (ASP) | 0.636 | Plastic | 1.697 | 16.3 | 14.67 |
| 12 | | −19.1544 | (ASP) | 0.152 | | | | |
| 13 | Stop | Plano | | 0.148 | | | | |
| 14 | Lens 5 | −3.2054 | (ASP) | 0.400 | Plastic | 1.587 | 28.3 | −41.24 |
| 15 | | −3.8649 | (ASP) | D2 | | | | |
| 16 | Lens 6 | 9.9781 | (ASP) | 0.476 | Plastic | 1.544 | 56.0 | −17.34 |
| 17 | | 4.7678 | (ASP) | 1.867 | | | | |
| 18 | Lens 7 | 15.7537 | (ASP) | 1.347 | Plastic | 1.614 | 25.6 | −87.26 |
| 19 | | 11.7767 | (ASP) | 0.270 | | | | |

| | | | | | | | |
|---|---|---|---|---|---|---|---|
| 20 | Prism 2 | Plano | 6.000 | Glass | 1.847 | 23.8 | — |
| 21 | | Plano | 0.150 | | | | |
| 22 | Filter | Plano | 0.210 | Glass | 1.517 | 64.2 | — |
| 23 | | Plano | 0.146 | | | | |
| 24 | Image | Plano | — | | | | |

Note:
Reference wavelength is 587.6 nm (d-line).
An effective radius of the stop S1 (Surface 3) is 5.000 mm.
An effective radius of the stop S2 (Surface 6) is 3.565 mm.
An effective radius of the stop S3 (Surface 13) is 3.062 mm.
The imaging optical lens assembly can further include an aperture stop, and the position of the aperture stop can be adjusted depending on the object distance, or can be adjusted depending on the arrangement of the front reflective element (the first reflective element) or the trimmed edge(s) of lens element(s).

In this embodiment, an axial distance between the image-side surface of the fifth lens element E5 and the object-side surface of the sixth lens element E6 is D2. Values of the object distance, D0, D1 and D2 may change depending on whether the imaging optical lens assembly is in the first state or the second state for focus adjustment (as shown in Table 6B below). Except for the aforementioned definition of D2 in this paragraph, the definitions of the parameters shown in Table 6B are the same as those stated in the 1st embodiment, with corresponding values for the 6th embodiment; therefore, no further explanation will be provided.

TABLE 6B
Values of Optical And Physical Parameters/Definitions

| First State | | Second State | |
|---|---|---|---|
| (Infinite Object Distance) | | (Finite Object Distance) | |
| fL [mm] | 17.1 | fS [mm] | 13.22 |
| FnoL | 1.88 | FnoS | 2.43 |
| HFOVL [deg.] | 16.6 | HFOVS [deg.] | 14.2 |
| Object Distance [mm] | ∞ | Object Distance [mm] | 74.241 |
| D0 [mm] | ∞ | D0 [mm] | 65.000 |
| D1 [mm] | 6.237 | D1 [mm] | 3.737 |
| D2 [mm] | 0.986 | D2 [mm] | 3.486 |

It should be understood that, in this embodiment, only two moving focus states (i.e., the first state and the second state) are disclosed, but the present disclosure is not limited thereto. Besides the first state and the second state, the imaging optical lens assembly in this embodiment can also have other moving focus states with different focal lengths between the first state and the second state to accommodate focusing conditions for other object distances.

In Table 6B, the movable group Gm of the imaging optical lens assembly is moved for focus adjustment according to the change of object distance. For example, the movable group Gm is moved toward the object side along the optical axis for focus adjustment when an imaged object is moved from an infinite object distance to a finite object distance, such that the imaging optical lens assembly is transitioned from the first state to the second state. Specifically, when the object distance changes from infinite to a finite object distance of 74.241 mm, the imaging optical lens assembly is transitioned from the first state to the second state, the axial distance D1 between the image-side surface of the first lens element E1 and the stop S2 decreases from 6.237 mm in the first state to 3.737 mm in the second state, and the axial distance D2 between the image-side surface of the fifth lens element E5 and the object-side surface of the sixth lens element E6 increases from 0.986 mm in the first state to 3.486 mm in the second state. In other words, when the object distance decreases, the movable group Gm is moved toward the object side along the optical axis during the focus adjustment process.

TABLE 6C
Aspheric Coefficients

| Surface # | 4 | 5 | 7 | 8 |
|---|---|---|---|---|
| k= | 0.0000E+00 | 0.0000E+00 | 0.0000E+00 | 0.0000E+00 |
| A4= | −1.57730572E−04 | −1.73695853E−04 | −2.66394657E−04 | −2.16891943E−02 |
| A6= | 2.58243430E−05 | 7.13872970E−06 | −1.35463622E−05 | 3.14439069E−02 |
| A8= | −1.55487283E−05 | −8.47774025E−06 | −3.20583052E−05 | −2.36152723E−02 |
| A10= | 4.59325546E−06 | 2.92696606E−06 | 2.40602315E−05 | 1.13781843E−02 |
| A12= | −8.77593250E−07 | −6.21411012E−07 | −1.08094779E−05 | −3.86764889E−03 |
| A14= | 1.14115449E−07 | 8.89333748E−08 | 3.15036580E−06 | 9.67553078E−04 |
| A16= | −1.03635941E−08 | −8.87897682E−09 | −6.19795428E−07 | −1.81436073E−04 |
| A18= | 6.63292415E−10 | 6.24691436E−10 | 8.38734304E−08 | 2.56264118E−05 |
| A20= | −2.97671229E−11 | −3.08053606E−11 | −7.82724512E−09 | −2.71116984E−06 |
| A22= | 9.16214100E−13 | 1.04068257E−12 | 4.94975099E−10 | 2.11329642E−07 |
| A24= | −1.84196137E−14 | −2.29203312E−14 | −2.02499987E−11 | −1.17609095E−08 |
| A26= | 2.17910688E−16 | 2.96316288E−16 | 4.83138659E−13 | 4.41520208E−10 |
| A28= | −1.15120132E−18 | −1.70541083E−18 | −5.09479115E−15 | −1.00052988E−11 |
| A30= | — | — | — | 1.03247446E−13 |
| Surface # | 9 | 10 | 11 | 12 |
| k= | 0.0000E+00 | 0.0000E+00 | 0.0000E+00 | 0.0000E+00 |
| A4= | −3.54094218E−02 | −2.18385291E−02 | 9.33986841E−03 | 2.34931583E−02 |
| A6= | 3.18182220E−02 | 3.45066231E−03 | −1.21106362E−02 | −1.57514003E−02 |
| A8= | −1.96780778E−02 | 2.28214950E−03 | 6.19371845E−03 | 5.68946860E−03 |
| A10= | 8.00655858E−03 | −2.57087735E−03 | −2.01005287E−03 | −1.48972638E−03 |
| A12= | −2.26491894E−03 | 1.33847926E−03 | 5.30811608E−04 | 3.02149975E−04 |
| A14= | 4.55405818E−04 | −4.36165806E−04 | −1.19850766E−04 | −3.80530581E−05 |
| A16 − | −6.53476670E−05 | 9.44663484E−05 | 2.06209690E−05 | −5.84533804E−07 |
| A18= | 6.63100517E−06 | −1.39818007E−05 | −2.41049308E−06 | 1.29399692E−06 |
| A20= | −4.64051497E−07 | 1.42627848E−06 | 1.76297467E−07 | −2.47152464E−07 |
| A22= | 2.12806873E−08 | −9.89858472E−08 | −7.23435267E−09 | 2.31134176E−08 |
| A24= | −5.75031466E−10 | 4.47622205E−09 | 1.26900438E−10 | −1.10923785E−09 |
| A26= | 6.93550484E−12 | −1.19212613E−10 | — | 2.18095348E−11 |
| A28= | − | 1.42131595E−12 | — | — |
| Surface # | 14 | 15 | 16 | 17 |
| k= | 0.0000E+00 | 0.0000E+00 | 0.0000E+00 | 0.0000E+00 |
| A4= | 4.68802655E−02 | 2.65073929E−02 | −3.40029053E−03 | −3.87986724E−03 |
| A6= | −2.05055902E−02 | −7.84776496E−03 | 3.38274788E−04 | 1.32486901E−04 |
| A8= | 1.10945045E−02 | 4.97085375E−03 | −8.18793559E−05 | 2.93836948E−04 |
| A10= | −4.40157254E−03 | −1.91315694E−03 | 7.46051734E−05 | −2.84104085E−04 |
| A12= | 1.37222087E−03 | 6.31094844E−04 | −8.61304005E−05 | 1.33512849E−04 |
| A14= | −3.20719892E−04 | −1.83516972E−04 | 5.49875440E−05 | −3.81652966E−05 |
| A16= | 5.28084089E−05 | 4.23079819E−05 | −2.15378476E−05 | 6.76950833E−06 |
| A18= | −5.86993761E−06 | −7.21141652E−06 | 5.60227061E−06 | −6.50125869E−07 |
| A20= | 4.19217357E−07 | 8.63531347E−07 | −1.00253867E−06 | 1.65973577E−09 |
| A22= | −1.74088387E−08 | −6.79370509E−08 | 1.24320264E−07 | 8.48214527E−09 |
| A24= | 3.20480597E−10 | 3.12455909E−09 | −1.05079830E−08 | −1.17775525E−09 |
| A26= | — | −6.32715323E−11 | 5.77828221E−10 | 8.06781063E−11 |
| A28= | — | — | −1.86340986E−11 | −2.91492518E−12 |
| A30= | — | — | 2.67333927E−13 | 4.43594267E−14 |

| Surface # | 18 | 19 |
|---|---|---|
| k= | 0.0000E+00 | 0.0000E+00 |
| A4= | −2.30344319E−03 | −2.86411609E−03 |
| A6= | 4.94732659E−04 | −5.60106103E−05 |
| A8= | −4.51385491E−04 | 7.89535293E−05 |
| A10= | 2.89019487E−04 | −3.81506688E−05 |
| A12= | −1.26664127E−04 | 1.15567908E−05 |
| A14= | 3.90345332E−05 | −2.39124149E−06 |
| A16= | −8.63776602E−06 | 3.50362472E−07 |
| A18= | 1.38796371E−06 | −3.71494902E−08 |
| A20= | −1.62208344E−07 | 2.87462171E−09 |
| A22= | 1.36531671E−08 | −1.61357698E−10 |
| A24= | −8.06780654E−10 | 6.40757449E−12 |
| A26= | 3.17757871E−11 | −1.70446746E−13 |
| A28= | −7.49235983E−13 | 2.71345436E−15 |
| A30= | 7.99941066E−15 | −1.94142777E−17 |

In the 6th embodiment, the equation of the aspheric surface profiles of the aforementioned lens elements is the same as the equation of the 1st embodiment. Also, the definitions of these parameters shown in Table 6D below are the same as those stated in the 1st embodiment, with corresponding values for the 6th embodiment; therefore, an explanation in this regard will not be provided again. It is noted that values of Dr3i, f, T12 and T56 in some of the conditions below may change depending on whether the imaging optical lens assembly is in the first state or the second state for focus adjustment.

Moreover, these parameters can be calculated from Table 6A to Table 6C as the following values and satisfy the following conditions:

TABLE 6D
Values of Optical and Physical Parameters/Definitions

| | | | |
|---|---|---|---|
| fL [mm] | 17.10 | fL/fS | 1.29 |
| FnoL | 1.88 | TL/fL | 1.32 |
| HFOVL [deg.] | 16.6 | TL/ImgH | 4.34 |
| FOVL [deg.] | 33.2 | fL/f234 | 1.49 |
| Dr3i/BL (1st state) | 2.37 | f1/f2 | 4.30 |
| T12/f + T12/BL (1st state) | 1.08 | (f4 + f5)/f1 | −0.73 |
| T12/CT1 (1st state) | 4.49 | (\|R8\| + \|R10\|)/fL | 1.35 |
| T56/CT1 (1st state) | 0.85 | R10/R1 | −0.49 |
| T34/T45 (1st state) | 0.90 | R6/R3 | 0.78 |
| fS [mm] | 13.22 | R6/R8 | −0.24 |
| FnoS | 2.43 | ΣCT/ΣAT | 0.80 |
| HFOVS [deg.] | 14.2 | 10 × (CT5 + CT6)/f6 | −0.51 |
| FOVS [deg.] | 28.4 | CT6/CT7 | 0.35 |
| Dr3i/BL (2nd state) | 2.74 | ΣETL/ΣCT | 0.83 |
| T12/f + T12/BL (2nd state) | 0.61 | ET6L/CT6 | 2.30 |
| T12/CT1 (2nd state) | 2.35 | ET7L/CT7 | 0.87 |
| T56/CT1 (2nd state) | 2.99 | Y7R1L/Y6R2L | 1.13 |
| T34/T45 (2nd state) | 0.90 | SAG7R1L/SAG7R2L | −0.25 |

### 7th Embodiment

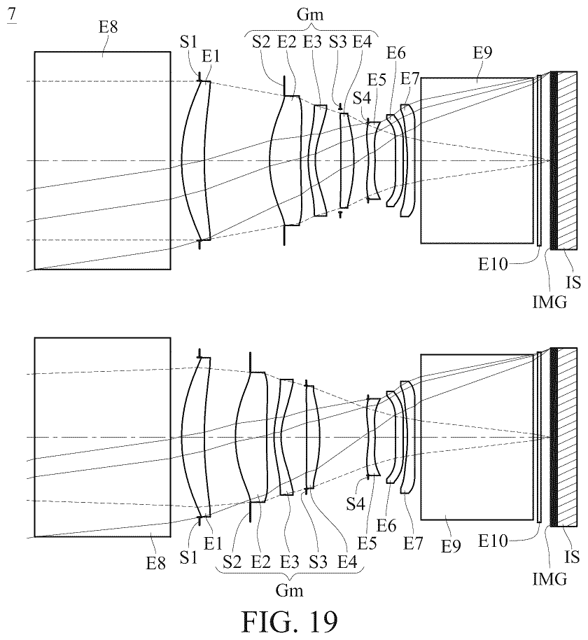

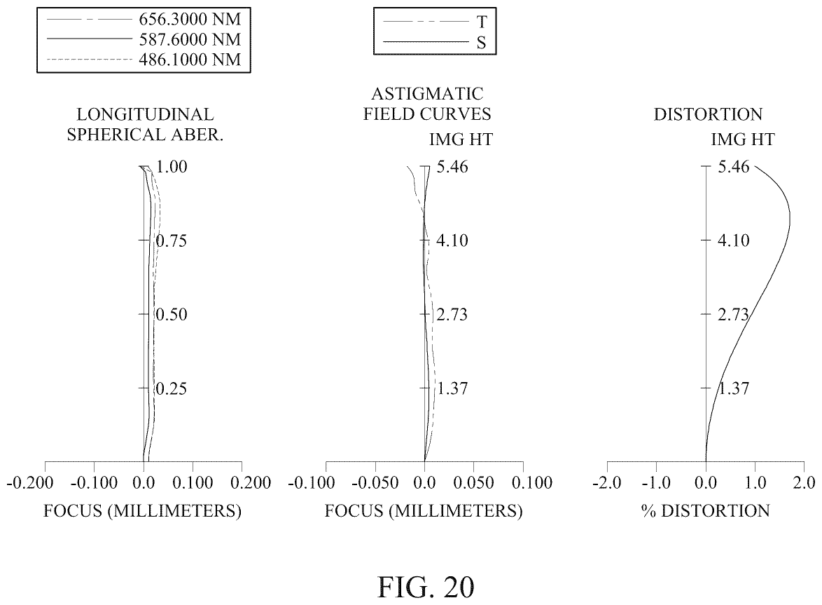

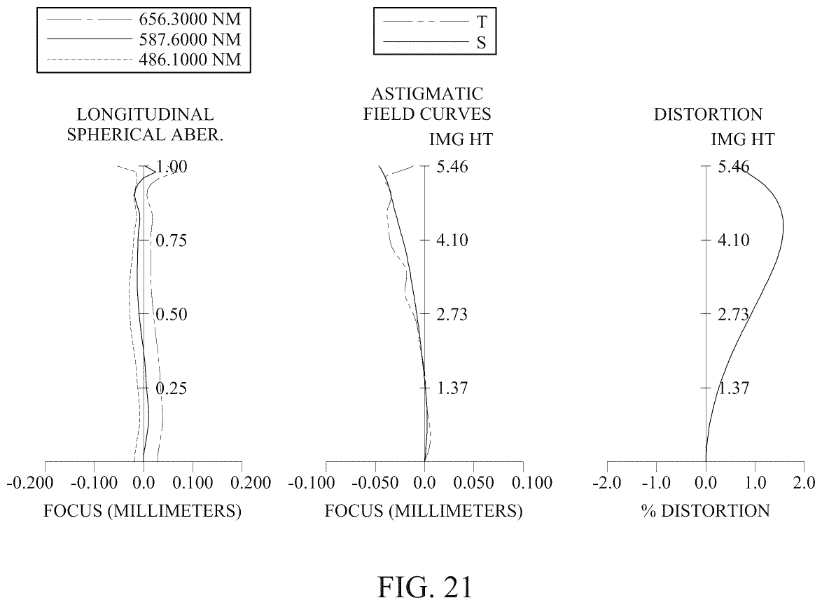

FIG. 19 is a schematic view of an image capturing unit respectively in a first state and a second state according to the 7th embodiment of the present disclosure. FIG. 20 shows, in order from left to right, spherical aberration curves, astigmatic field curves and a distortion curve of the image capturing unit in the first state according to the 7th embodiment. FIG. 21 shows, in order from left to right, spherical aberration curves, astigmatic field curves and a distortion curve of the image capturing unit in the second state according to the 7th embodiment. In FIG. 19, the image capturing unit 7 includes the imaging optical lens assembly (its reference numeral is omitted) of the present disclosure and an image sensor IS. The imaging optical lens assembly includes, in order from an object side to an image side along an optical path, a first reflective element E8, a stop S1, a first lens element E1, a stop S2, a second lens element E2, a third lens element E3, a stop S3, a fourth lens element E4, a stop S4, a fifth lens element E5, a sixth lens element E6, a seventh lens element E7, a second reflective element E9, a filter E10 and an image surface IMG. Furthermore, the imaging optical lens assembly has a movable group Gm, and the movable group Gm includes the stop S2, the second lens element E2, the third lens element E3, the stop S3 and the fourth lens element E4. The imaging optical lens assembly includes seven lens elements (E1, E2, E3, E4, E5, E6 and E7) with no additional lens element disposed between each of the adjacent seven lens elements. In addition, there is no additional lens element located between the first lens element E1 and the first reflective element E8 along an optical axis, and there is no additional lens element located between the seventh lens element E7 and the second reflective element E9 along the optical axis.

When an imaged object is located at an infinite object distance, the imaging optical lens assembly is in the first state as shown in the upper part of FIG. 19. When an imaged object is located at a finite object distance, the imaging optical lens assembly is in the second state as shown in the lower part of FIG. 19. When an imaged object is moved from an infinite object distance to a finite object distance, the movable group Gm is moved along the optical axis for focus adjustment, and the imaging optical lens assembly is transitioned from the first state to the second state. Conversely, when an imaged object is moved from a finite object distance to an infinite object distance, the movable group Gm is moved along the optical axis for focus adjustment, and the imaging optical lens assembly is transitioned from the second state to the first state. Particularly, the movable group Gm is moved towards the object side along the optical axis during the focus adjustment process when the imaging optical lens assembly is transitioned from the first state to the second state. It should be noted that all elements (e.g., the stop, lens element, and/or aperture stop) in the movable group Gm are immovable relative to one another during the focus adjustment process.

The first reflective element E8 is made of glass material and located along the optical path between an imaged object and the first lens element E1, and will not affect the focal length of the imaging optical lens assembly. The first reflective element E8 is a prism with optical path folding function.

The first lens element E1 with positive refractive power has an object-side surface being convex in a paraxial region thereof and an image-side surface being concave in a paraxial region thereof. The first lens element E1 is made of glass material and has the object-side surface and the image-side surface being both aspheric. The object-side surface of the first lens element E1 has one inflection point. The image-side surface of the first lens element E1 has one inflection point.

The second lens element E2 with positive refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has one inflection point. The image-side surface of the second lens element E2 has one inflection point. The image-side surface of the second lens element E2 has one critical point in an off-axis region thereof.

The third lens element E3 with negative refractive power has an object-side surface being convex in a paraxial region thereof and an image-side surface being concave in a paraxial region thereof. The third lens element E3 is made of plastic material and has the object-side surface and the image-side surface being both aspheric. The object-side surface of the third lens element E3 has one inflection point. The image-side surface of the third lens element E3 has one inflection point.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric. The object-side surface of the fourth lens element E4 has two inflection points. The image-side surface of the fourth lens element E4 has one inflection point. The object-side surface of the fourth lens element E4 has two critical points in an off-axis region thereof.

The fifth lens element E5 with negative refractive power has an object-side surface being concave in a paraxial region thereof and an image-side surface being convex in a paraxial region thereof. The fifth lens element E5 is made of plastic material and has the object-side surface and the image-side surface being both aspheric. The object-side surface of the fifth lens element E5 has one inflection point. The image-side surface of the fifth lens element E5 has one inflection point. The object-side surface of the fifth lens element E5 has one critical point in an off-axis region thereof. The image-side surface of the fifth lens element E5 has one critical point in an off-axis region thereof.

The sixth lens element E6 with negative refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has two inflection points. The image-side surface of the sixth lens element E6 has two inflection points. The object-side surface of the sixth lens element E6 has one critical point in an off-axis region thereof. The image-side surface of the sixth lens element E6 has one critical point in an off-axis region thereof.

The seventh lens element E7 with negative refractive power has an object-side surface being concave in a paraxial region thereof and an image-side surface being convex in a paraxial region thereof. The seventh lens element E7 is made of plastic material and has the object-side surface and the image-side surface being both aspheric. The object-side surface of the seventh lens element E7 has three inflection points. The image-side surface of the seventh lens element E7 has two inflection points. The image-side surface of the seventh lens element E7 has two critical points in an off-axis region thereof.

The second reflective element E9 is made of glass material and located along the optical path between the seventh lens element E7 and the image surface IMG, and will not affect the focal length of the imaging optical lens assembly. The second reflective element E9 is a prism with optical path folding function. For simplicity in illustration, FIG. 19 does not show the folding effect caused by the first reflective element E8 and the second reflective element E9 on the optical path. However, the first reflective element E8 and the second reflective element E9 can have various configurations depending on the actual design requirements, thereby creating different folding effects on the optical path. Moreover, the first reflective element E8 and the second reflective element E9 of this embodiment each can have a configuration similar to, for example, one of the configurations shown in FIG. 37 and FIG. 38, which can be referred to foregoing descriptions corresponding to FIG. 37 and FIG. 38, and the details in this regard will not be provided again.

The filter E10 is made of glass material and located between the second reflective element E9 and the image surface IMG, and will not affect the focal length of the imaging optical lens assembly. The image sensor IS is disposed on or near the image surface IMG of the imaging optical lens assembly.

The detailed optical data of the 7th embodiment are shown in Table 7A and Table 7B, and the aspheric surface data are shown in Table 7C below.

TABLE 7A
7th Embodiment

| | | | | | | | | Focal |
|---|---|---|---|---|---|---|---|---|
| Surface # | | Curvature Radius | | Thickness | Material | Index | Abbe # | Length |
| 0 | Object | Plano | | D0 | | | | |
| 1 | Prism 1 | Plano | | 8.350 | Glass | 1.847 | 23.8 | — |
| 2 | | Plano | | 1.775 | | | | |
| 3 | Stop | Plano | | −1.095 | | | | |
| 4 | Lens 1 | 9.5335 | (ASP) | 1.394 | Glass | 1.497 | 81.6 | 31.82 |
| 5 | | 22.8285 | (ASP) | D1 | | | | |
| 6 | Stop | Plano | | −0.907 | | | | |
| 7 | Lens 2 | 7.2475 | (ASP) | 1.919 | Plastic | 1.544 | 56.0 | 14.65 |
| 8 | | 72.2385 | (ASP) | 0.455 | | | | |
| 9 | Lens 3 | 5.8188 | (ASP) | 0.430 | Plastic | 1.660 | 20.4 | −21.08 |
| 10 | | 3.9821 | (ASP) | 1.544 | | | | |
| 11 | Stop | Plano | | 0.023 | | | | |
| 12 | Lens 4 | 99.8749 | (ASP) | 0.811 | Plastic | 1.544 | 56.0 | 16.42 |
| 13 | | −9.7806 | (ASP) | D2 | | | | |
| 14 | Stop | Plano | | 0.035 | | | | |
| 15 | Lens 5 | −4.0259 | (ASP) | 0.400 | Plastic | 1.566 | 37.4 | −21.20 |
| 16 | | −6.2766 | (ASP) | 1.252 | | | | |
| 17 | Lens 6 | 239.0391 | (ASP) | 0.479 | Plastic | 1.669 | 19.5 | −141.83 |
| 18 | | 67.8699 | (ASP) | 0.256 | | | | |
| 19 | Lens 7 | −10.8000 | (ASP) | 0.450 | Plastic | 1.544 | 56.0 | −20.70 |
| 20 | | −267.6550 | (ASP) | 0.380 | | | | |

| | | | | | | | |
|---|---|---|---|---|---|---|---|
| 21 | Prism 2 | Plano | 6.900 | Glass | 1.847 | 23.8 | — |
| 22 | | Plano | 0.270 | | | | |
| 23 | Filter | Plano | 0.210 | Glass | 1.517 | 64.2 | — |
| 24 | | Plano | 0.593 | | | | |
| 25 | Image | Plano | — | | | | |

Note:
Reference wavelength is 587.6 nm (d-line).
An effective radius of the stop S1 (Surface 3) is 4.916 mm.
An effective radius of the stop S2 (Surface 6) is 3.984 mm.
An effective radius of the stop S3 (Surface 11) is 3.174 mm.
An effective radius of the stop S4 (Surface 14) is 2.338 mm.
The imaging optical lens assembly can further include an aperture stop, and the position of the aperture stop can be adjusted depending on the object distance, or can be adjusted depending on the arrangement of the front reflective element (the first reflective element) or the trimmed edge(s) of lens element(s).

In this embodiment, an axial distance between the image-side surface of the fourth lens element E4 and the stop S4 is D2. Values of the object distance, D0, D1 and D2 may change depending on whether the imaging optical lens assembly is in the first state or the second state for focus adjustment (as shown in Table 7B below). Except for the aforementioned definition of D2 in this paragraph, the definitions of the parameters shown in Table 7B are the same as those stated in the 1st embodiment, with corresponding values for the 7th embodiment; therefore, no further explanation will be provided.

TABLE 7B
Values of Optical And Physical Parameters/Definitions

| First State | | Second State | |
|---|---|---|---|
| (Infinite Object Distance) | | (Finite Object Distance) | |
| fL [mm] | 18.85 | fS [mm] | 13.25 |
| FnoL | 1.93 | FnoS | 2.37 |
| HFOVL [deg.] | 16.0 | HFOVS [deg.] | 14.2 |
| Object Distance [mm] | ∞ | Object Distance [mm] | 69.030 |
| D0 [mm] | ∞ | D0 [mm] | 60.000 |
| D1 [mm] | 4.921 | D1 [mm] | 2.821 |
| D2 [mm] | 0.870 | D2 [mm] | 2.970 |

It should be understood that, in this embodiment, only two moving focus states (i.e., the first state and the second state) are disclosed, but the present disclosure is not limited thereto. Besides the first state and the second state, the imaging optical lens assembly in this embodiment can also have other moving focus states with different focal lengths between the first state and the second state to accommodate focusing conditions for other object distances.

In Table 7B, the movable group Gm of the imaging optical lens assembly is moved for focus adjustment according to the change of object distance. For example, the movable group Gm is moved toward the object side along the optical axis for focus adjustment when an imaged object is moved from an infinite object distance to a finite object distance, such that the imaging optical lens assembly is transitioned from the first state to the second state. Specifically, when the object distance changes from infinite to a finite object distance of 69.030 mm, the imaging optical lens assembly is transitioned from the first state to the second state, the axial distance D1 between the image-side surface of the first lens element E1 and the stop S2 decreases from 4.921 mm in the first state to 2.821 mm in the second state, and the axial distance D2 between the image-side surface of the fourth lens element E4 and the stop S4 increases from 0.870 mm in the first state to 2.970 mm in the second state. In other words, when the object distance decreases, the movable group Gm is moved toward the object side along the optical axis during the focus adjustment process.

TABLE 7C
Aspheric Coefficients

| Surface # | 4 | 5 | 7 | 8 |
|---|---|---|---|---|
| k= | 0.0000E+00 | 0.0000E+00 | 0.0000E+00 | 0.0000E+00 |
| A4= | −1.15737569E−04 | −1.28724923E−04 | −1.69408663E−05 | 1.01768254E−03 |
| A6= | 1.24877526E−05 | −9.02998222E−06 | 4.62407599E−05 | −1.47337412E−04 |
| A8= | −9.76335358E−06 | 3.46005423E−06 | −8.28052347E−05 | 8.44293898E−05 |
| A10= | 3.97143467E−06 | −8.98389326E−07 | 5.56924699E−05 | −6.43814463E−05 |
| A12= | −1.04647171E−06 | 1.05291449E−07 | −2.42771325E−05 | 2.62388771E−05 |
| A14= | 1.85284890E−07 | 2.02954191E−10 | 7.11892843E−06 | −7.10917013E−06 |
| A16= | −2.28231322E−08 | −1.96001593E−09 | −1.45860974E−06 | 1.36909017E−06 |
| A18= | 1.99441437E−09 | 3.18384141E−10 | 2.12910440E−07 | −1.91450203E−07 |
| A20= | −1.24423106E−10 | −2.81655952E−11 | −2.22636784E−08 | 1.94940865E−08 |
| A22= | 5.50204470E−12 | 1.58827863E−12 | 1.65462855E−09 | −1.42919540E−09 |
| A24= | −1.68365946E−13 | −5.86360485E−14 | −8.52703389E−11 | 7.33514574E−11 |
| A26= | 3.38861176E−15 | 1.37684345E−15 | 2.89458709E−12 | −2.49518083E−12 |
| A28= | −4.03305280E−17 | −1.86980531E−17 | −5.81673924E−14 | 5.04101965E−14 |
| A30= | 2.14952981E−19 | 1.11938150E−19 | 5.23820091E−16 | −4.56826982E−16 |
| Surface # | 9 | 10 | 12 | 13 |
| k= | 0.0000E+00 | 0.0000E+00 | 0.0000E+00 | 0.0000E+00 |
| A4= | −8.24441822E−03 | −1.12542053E−02 | −1.23084555E−03 | −1.37199308E−04 |
| A6= | 5.80766699E−04 | 5.49464815E−04 | −2.01328421E−04 | −1.37533891E−04 |
| A8= | 1.09222476E−04 | 3.33443572E−04 | 1.35638327E−04 | 8.59921535E−05 |
| A10= | −1.24610627E−04 | −3.35968156E−04 | −7.71670958E−05 | −3.78951625E−05 |
| A12= | 4.80200648E−05 | 1.66737664E−04 | 3.47322244E−05 | 1.60897013E−05 |
| A14= | −1.13647559E−05 | −5.61915582E−05 | −1.06792049E−05 | −4.64748820E−06 |
| A16= | 1.79415922E−06 | 1.36226985E−05 | 2.11887908E−06 | 7.70950065E−07 |
| A18= | −1.89620376E−07 | −2.42287004E−06 | −2.64748498E−07 | −5.50867804E−08 |
| A20= | 1.30744179E−08 | 3.17735710E−07 | 2.01720511E−08 | −2.28015539E−09 |
| A22= | −5.55781430E−10 | −3.04289262E−08 | −8.55569557E−10 | 7.21721797E−10 |
| A24= | 1.29410464E−11 | 2.06796772E−09 | 1.54193450E−11 | −4.95328206E−11 |
| A26= | −1.21675349E−13 | −9.41933597E−11 | — | 1.17622905E−12 |
| A28= | — | 2.56780469E−12 | — | — |
| A30= | — | −3.15311733E−14 | — | — |
| Surface # | 15 | 16 | 17 | 18 |
| k= | 0.0000E+00 | 0.0000E+00 | 0.0000E+00 | 0.0000E+00 |
| A4= | 5.47196547E−02 | 5.58086239E−02 | 5.29718521E−03 | −7.26164844E−04 |
| A6= | −1.28437716E−02 | −1.28796921E−02 | −7.07476546E−03 | −7.57761555E−03 |
| A8= | 2.19729262E−03 | 4.64564421E−03 | −1.55665394E−03 | 6.29881316E−03 |
| A10= | 7.02690642E−05 | −4.09253242E−03 | 7.36640146E−03 | −4.77171865E−03 |
| A12= | −2.09803491E−04 | 3.41312716E−03 | −9.31983559E−03 | 2.33389090E−03 |
| A14= | 8.20850700E−05 | −1.91945345E−03 | 7.08735305E−03 | −6.37238822E−04 |
| A16= | −1.90557626E−05 | 7.25387460E−04 | −3.60918629E−03 | 4.56513209E−05 |
| A18= | 2.91947955E−06 | −1.85977374E−04 | 1.28055548E−03 | 3.25809979E−05 |
| A20= | −2.90854033E−07 | 3.19673435E−05 | −3.20946007E−04 | −1.38791060E−05 |
| A22= | 1.71428727E−08 | −3.52937667E−06 | 5.65893626E−05 | 2.83815691E−06 |
| A24= | −4.53739689E−10 | 2.26235808E−07 | −6.86096954E−06 | −3.51099054E−07 |
| A26= | — | −6.39958372E−09 | 5.43774403E−07 | 2.66785925E−08 |
| A28= | — | — | −2.53240573E−08 | −1.14898858E−09 |
| A30= | — | — | 5.24545357E−10 | 2.15007456E−11 |

| Surface # | 19 | 20 |
|---|---|---|
| k= | 0.0000E+00 | 0.0000E+00 |
| A4= | −5.26048510E−03 | −4.31434489E−03 |
| A6= | 3.20199330E−03 | 4.19339541E−03 |
| A8= | 2.58257953E−03 | −1.77207824E−03 |
| A10= | −4.18858467E−03 | 5.61262270E−04 |
| A12= | 2.93109002E−03 | −1.33181552E−04 |
| A14= | −1.29512422E−03 | 1.86103415E−05 |
| A16= | 3.92237147E−04 | −3.37192106E−07 |
| A18= | −8.41927093E−05 | −4.33547587E−07 |
| A20= | 1.29594077E−05 | 9.75718568E−08 |
| A22= | −1.42294979E−06 | −1.15107607E−08 |
| A24= | 1.08807750E−07 | 8.42674671E−10 |
| A26= | −5.50211881E−09 | −3.83635042E−11 |
| A28= | 1.65228192E−10 | 9.95855218E−13 |
| A30= | −2.22891260E−12 | −1.12435832E−14 |

In the 7th embodiment, the equation of the aspheric surface profiles of the aforementioned lens elements is the same as the equation of the 1st embodiment. Also, the definitions of these parameters shown in Table 7D below are the same as those stated in the 1st embodiment, with corresponding values for the 7th embodiment; therefore, an explanation in this regard will not be provided again.

Moreover, these parameters can be calculated from Table 7A to Table 7C as the following values and satisfy the following conditions:

TABLE 7D
Values of Optical and Physical Parameters/Definitions

| | | | |
|---|---|---|---|
| fL [mm] | 18.85 | fL/fS | 1.42 |
| FnoL | 1.93 | TL/fL | 1.20 |
| HFOVL [deg.] | 16.0 | TL/ImgH | 4.15 |
| FOVL [deg.] | 32.0 | fL/f234 | 1.44 |
| Dr3i/BL (1st state) | 2.07 | f1/f2 | 2.17 |
| T12/f + T12/BL (1st state) | 0.69 | (f4 + f5)/f1 | −0.15 |
| T12/CT1 (1st state) | 2.88 | (\|R8\| + \|R10\|)/fL | 0.85 |
| T56/CT1 (1st state) | 0.90 | R10/R1 | −0.66 |
| T34/T45 (1st state) | 1.73 | R6/R3 | 0.55 |
| fS [mm] | 13.25 | R6/R8 | −0.41 |
| FnoS | 2.37 | ΣCT/ΣAT | 0.70 |
| HFOVS [deg.] | 14.2 | 10 × (CT5 + CT6)/f6 | −0.06 |
| FOVS [deg.] | 28.4 | CT6/CT7 | 1.06 |
| Dr3i/BL (2nd state) | 2.32 | ΣETL/ΣCT | 0.73 |
| T12/f + T12/BL (2nd state) | 0.37 | ET6L/CT6 | 0.88 |
| T12/CT1 (2nd state) | 1.37 | ET7L/CT7 | 1.06 |
| T56/CT1 (2nd state) | 0.90 | Y7R1L/Y6R2L | 1.12 |
| T34/T45 (2nd state) | 0.52 | SAG7R1L/SAG7R2L | 1.08 |

### 8th Embodiment

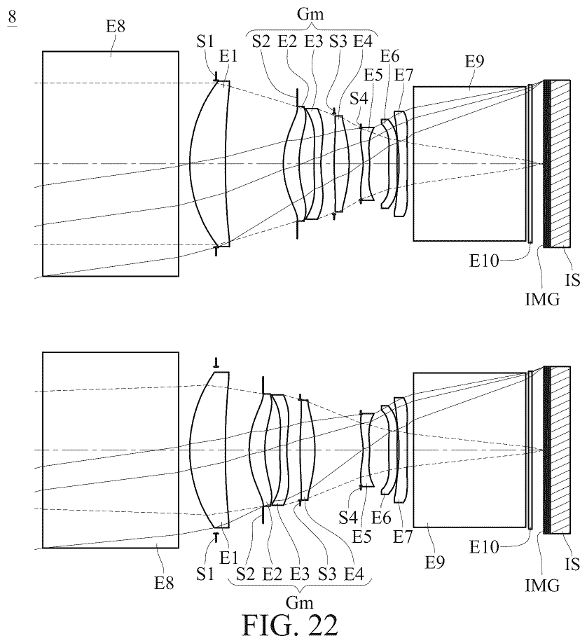

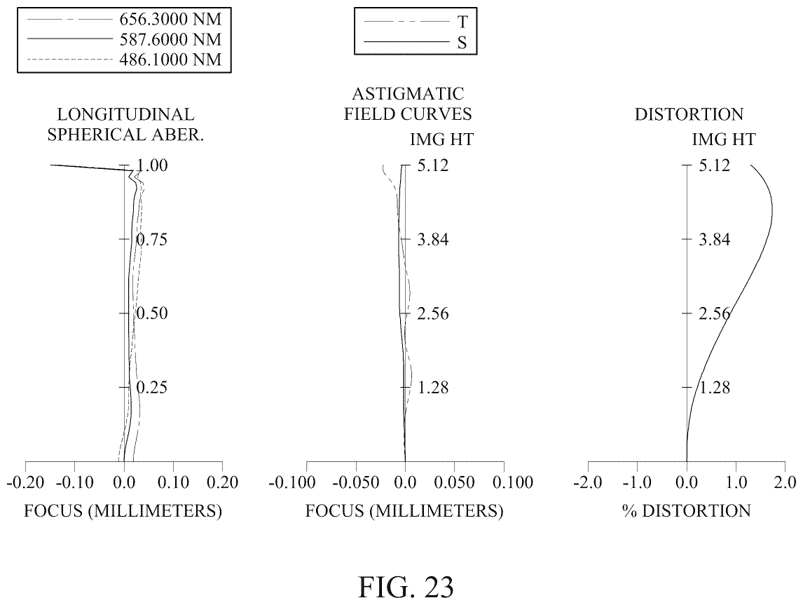

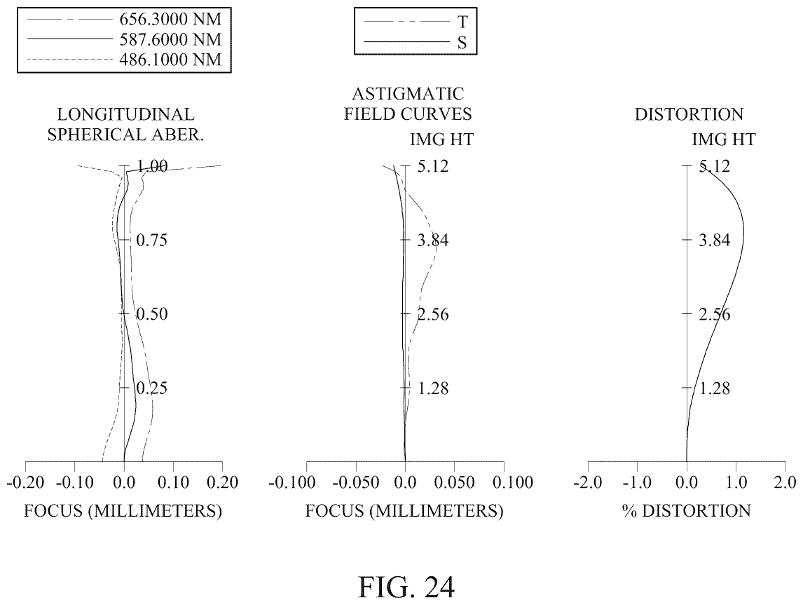

FIG. 22 is a schematic view of an image capturing unit respectively in a first state and a second state according to the 8th embodiment of the present disclosure. FIG. 23 shows, in order image capturing unit in the first state according to the 8th embodiment. FIG. 24 shows, in order from left to right, spherical aberration curves, astigmatic field curves and a distortion curve of the image capturing unit in the second state according to the 8th embodiment. In FIG. 22, the image capturing unit 8 includes the imaging optical lens assembly (its reference numeral is omitted) of the present disclosure and an image sensor IS. The imaging optical lens assembly includes, in order from an object side to an image side along an optical path, a first reflective element E8, a stop S1, a first lens element E1, a stop S2, a second lens element E2, a third lens element E3, a stop S3, a fourth lens element E4, a stop S4, a fifth lens element E5, a sixth lens element E6, a seventh lens element E7, a second reflective element E9, a filter E10 and an image surface IMG. Furthermore, the imaging optical lens assembly has a movable group Gm, and the movable group Gm includes the stop S2, the second lens element E2, the third lens element E3, the stop S3 and the fourth lens element E4. The imaging optical lens assembly includes seven lens elements (E1, E2, E3, E4, E5, E6 and E7) with no additional lens element disposed between each of the adjacent seven lens elements. In addition, there is no additional lens element located between the first lens element E1 and the first reflective element E8 along an optical axis, and there is no additional lens element located between the seventh lens element E7 and the second reflective element E9 along the optical axis.

When an imaged object is located at an infinite object distance, the imaging optical lens assembly is in the first state as shown in the upper part of FIG. 22. When an imaged object is located at a finite object distance, the imaging optical lens assembly is in the second state as shown in the lower part of FIG. 22. When an imaged object is moved from an infinite object distance to a finite object distance, the movable group Gm is moved along the optical axis for focus adjustment, and the imaging optical lens assembly is transitioned from the first state to the second state. Conversely, when an imaged object is moved from a finite object distance to an infinite object distance, the movable group Gm is moved along the optical axis for focus adjustment, and the imaging optical lens assembly is transitioned from the second state to the first state. Particularly, the movable group Gm is moved towards the object side along the optical axis during the focus adjustment process when the imaging optical lens assembly is transitioned from the first state to the second state. It should be noted that all elements (e.g., the stop, lens element, and/or aperture stop) in the movable group Gm are immovable relative to one another during the focus adjustment process.

The first reflective element E8 is made of glass material and located along the optical path between an imaged object and the first lens element E1, and will not affect the focal length of the imaging optical lens assembly. The first reflective element E8 is a prism with optical path folding function.

The first lens element E1 with positive refractive power has an object-side surface being convex in a paraxial region thereof and an image-side surface being concave in a paraxial region thereof. The first lens element E1 is made of glass material and has the object-side surface and the image-side surface being both spherical.

The second lens element E2 with positive refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has one inflection point. The image-side surface of the second lens element E2 has two inflection points. The object-side surface of the second lens element E2 has one critical point in an off-axis region thereof. The image-side surface of the second lens element E2 has one critical point in an off-axis region thereof.

The third lens element E3 with negative refractive power has an object-side surface being convex in a paraxial region thereof and an image-side surface being concave in a paraxial region thereof. The third lens element E3 is made of plastic material and has the object-side surface and the image-side surface being both aspheric. The object-side surface of the third lens element E3 has two inflection points. The image-side surface of the third lens element E3 has one inflection point. The object-side surface of the third lens element E3 has one critical point in an off-axis region thereof. The image-side surface of the third lens element E3 has one critical point in an off-axis region thereof.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric. The object-side surface of the fourth lens element E4 has two inflection points. The image-side surface of the fourth lens element E4 has one inflection point. The object-side surface of the fourth lens element E4 has two critical points in an off-axis region thereof.

The fifth lens element E5 with negative refractive power has an object-side surface being concave in a paraxial region thereof and an image-side surface being convex in a paraxial region thereof. The fifth lens element E5 is made of plastic material and has the object-side surface and the image-side surface being both aspheric. The object-side surface of the fifth lens element E5 has one inflection point. The image-side surface of the fifth lens element E5 has one inflection point. The object-side surface of the fifth lens element E5 has one critical point in an off-axis region thereof. The image-side surface of the fifth lens element E5 has one critical point in an off-axis region thereof.

The sixth lens element E6 with negative refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has two inflection points. The image-side surface of the sixth lens element E6 has two inflection points. The object-side surface of the sixth lens element E6 has one critical point in an off-axis region thereof. The image-side surface of the sixth lens element E6 has one critical point in an off-axis region thereof.

The seventh lens element E7 with negative refractive power has an object-side surface being concave in a paraxial region thereof and an image-side surface being convex in a paraxial region thereof. The seventh lens element E7 is made of plastic material and has the object-side surface and the image-side surface being both aspheric. The object-side surface of the seventh lens element E7 has three inflection points. The image-side surface of the seventh lens element E7 has two inflection points. The image-side surface of the seventh lens element E7 has two critical points in an off-axis region thereof.

The second reflective element E9 is made of glass material and located along the optical path between the seventh lens element E7 and the image surface IMG, and will not affect the focal length of the imaging optical lens assembly. The second reflective element E9 is a prism with optical path folding function. For simplicity in illustration, FIG. 22 does not show the folding effect caused by the first reflective element E8 and the second reflective element E9 on the optical path. However, the first reflective element E8 and the second reflective element E9 can have various configurations depending on the actual design requirements, thereby creating different folding effects on the optical path. Moreover, the first reflective element E8 and the second reflective element E9 of this embodiment each can have a configuration similar to, for example, one of the configurations shown in FIG. 37 and FIG. 38, which can be referred to foregoing descriptions corresponding to FIG. 37 and FIG. 38, and the details in this regard will not be provided again.

The filter E10 is made of glass material and located between the second reflective element E9 and the image surface IMG, and will not affect the focal length of the imaging optical lens assembly. The image sensor IS is disposed on or near the image surface IMG of the imaging optical lens assembly.

The detailed optical data of the 8th embodiment are shown in Table 8A and Table 8B, and the aspheric surface data are shown in Table 8C below.

TABLE 8A
8th Embodiment

| | | | | | | | | Focal |
|---|---|---|---|---|---|---|---|---|
| Surface # | | Curvature Radius | | Thickness | Material | Index | Abbe # | Length |
| 0 | Object | Plano | | D0 | | | | |
| 1 | Prism 1 | Plano | | 8.350 | Glass | 1.847 | 23.8 | — |
| 2 | | Plano | | 2.298 | | | | |
| 3 | Stop | Plano | | −1.618 | | | | |
| 4 | Lens 1 | 8.2862 | (SPH) | 2.184 | Glass | 1.497 | 81.6 | 20.07 |
| 5 | | 44.6175 | (SPH) | D1 | | | | |
| 6 | Stop | Plano | | −0.855 | | | | |
| 7 | Lens 2 | 5.2077 | (ASP) | 0.961 | Plastic | 1.544 | 56.0 | 42.53 |
| 8 | | 6.2832 | (ASP) | 0.920 | | | | |
| 9 | Lens 3 | 13.0540 | (ASP) | 0.430 | Plastic | 1.660 | 20.4 | −28.60 |
| 10 | | 7.6160 | (ASP) | 0.812 | | | | |
| 11 | Stop | Plano | | 0.000 | | | | |
| 12 | Lens 4 | 21.9634 | (ASP) | 0.916 | Plastic | 1.544 | 56.0 | 11.12 |
| 13 | | −8.2257 | (ASP) | D2 | | | | |
| 14 | Stop | Plano | | 0.142 | | | | |
| 15 | Lens 5 | −3.0914 | (ASP) | 0.400 | Plastic | 1.566 | 37.4 | −16.95 |
| 16 | | −4.7739 | (ASP) | 1.178 | | | | |
| 17 | Lens 6 | 244.3416 | (ASP) | 0.507 | Plastic | 1.669 | 19.5 | −113.95 |
| 18 | | 58.0577 | (ASP) | 0.123 | | | | |
| 19 | Lens 7 | −11.2761 | (ASP) | 0.502 | Plastic | 1.544 | 56.0 | −20.87 |
| 20 | | −1679.5438 | (ASP) | 0.380 | | | | |

| | | | | | | | |
|---|---|---|---|---|---|---|---|
| 21 | Prism 2 | Plano | 6.900 | Glass | 1.847 | 23.8 | — |
| 22 | | Plano | 0.180 | | | | |
| 23 | Filter | Plano | 0.210 | Glass | 1.517 | 64.2 | — |
| 24 | | Plano | 0.716 | | | | |
| 25 | Image | Plano | — | | | | |

Note:
Reference wavelength is 587.6 nm (d-line).
An effective radius of the stop S1 (Surface 3) is 5.126 mm.
An effective radius of the stop S2 (Surface 6) is 3.522 mm.
An effective radius of the stop S3 (Surface 11) is 3.097 mm.
An effective radius of the stop S4 (Surface 14) is 2.204 mm.
The imaging optical lens assembly can further include an aperture stop, and the position of the aperture stop can be adjusted depending on the object distance, or can be adjusted depending on the arrangement of the front reflective element (the first reflective element) or the trimmed edge(s) of lens element(s).

In this embodiment, an axial distance between the image-side surface of the fourth lens element E4 and the stop S4 is D2. Values of the object distance, D0, D1 and D2 may change depending on whether the imaging optical lens assembly is in the first state or the second state for focus adjustment (as shown in Table 8B below). Except for the aforementioned definition of D2 in this paragraph, the definitions of the parameters shown in Table 8B are the same as those stated in the 1st embodiment, with corresponding values for the 8th embodiment; therefore, no further explanation will be provided.

TABLE 8B
Values of Optical And Physical Parameters/Definitions

| First State | | Second State | |
|---|---|---|---|
| (Infinite Object Distance) | | (Finite Object Distance) | |
| fL [mm] | 18.95 | fS [mm] | 12.96 |
| FnoL | 1.91 | FnoS | 2.46 |
| HFOVL [deg.] | 14.9 | HFOVS [deg.] | 13.8 |
| Object Distance [mm] | ∞ | Object Distance [mm] | 69.030 |
| D0 [mm] | ∞ | D0 [mm] | 60.000 |
| D1 [mm] | 4.424 | D1 [mm] | 2.324 |
| D2 [mm] | 0.721 | D2 [mm] | 2.821 |

It should be understood that, in this embodiment, only two moving focus states (i.e., the first state and the second state) are disclosed, but the present disclosure is not limited thereto. Besides the first state and the second state, the imaging optical lens assembly in this embodiment can also have other moving focus states with different focal lengths between the first state and the second state to accommodate focusing conditions for other object distances.

In Table 8B, the movable group Gm of the imaging optical lens assembly is moved for focus adjustment according to the change of object distance. For example, the movable group Gm is moved toward the object side along the optical axis for focus adjustment when an imaged object is moved from an infinite object distance to a finite object distance, such that the imaging optical lens assembly is transitioned from the first state to the second state. Specifically, when the object distance changes from infinite to a finite object distance of 69.030 mm, the imaging optical lens assembly is transitioned from the first state to the second state, the axial distance D1 between the image-side surface of the first lens element E1 and the stop S2 decreases from 4.424 mm in the first state to 2.324 mm in the second state, and the axial distance D2 between the image-side surface of the fourth lens element E4 and the stop S4 increases from 0.721 mm in the first state to 2.821 mm in the second state. In other words, when the object distance decreases, the movable group Gm is moved toward the object side along the optical axis during the focus adjustment process.

TABLE 8C
Aspheric Coefficients

| Surface # | 7 | 8 | 9 | 10 |
|---|---|---|---|---|
| k= | 0.0000E+00 | 0.0000E+00 | 0.0000E+00 | 0.0000E+00 |
| A4= | −1.07396381E−03 | −2.48162364E−03 | −1.23728122E−02 | −1.22715988E−02 |
| A6= | 1.75811728E−04 | −1.00987229E−04 | 1.61608507E−03 | 1.79684891E−03 |
| A8= | −1.87320003E−04 | 2.60136807E−04 | −6.57595405E−04 | −8.33352058E−04 |
| A10= | 8.84121229E−05 | −3.05176277E−04 | 3.39902347E−04 | 4.75050358E−04 |
| A12= | −2.69426512E−05 | 1.88173138E−04 | −1.37489059E−04 | −2.19850639E−04 |
| A14= | 4.83882608E−06 | −7.52036922E−05 | 3.74854123E−05 | 7.12452956E−05 |
| A16= | −3.66513967E−07 | 2.04744717E−05 | −6.85928840E−06 | −1.64655460E−05 |
| A18= | −4.65034244E−08 | −3.89368514E−06 | 8.52382860E−07 | 2.80370528E−06 |
| A20= | 1.73692024E−08 | 5.22720204E−07 | −7.13892075E−08 | −3.55277533E−07 |
| A22= | −2.47867013E−09 | −4.93532951E−08 | 3.86689285E−09 | 3.30702515E−08 |
| A24= | 2.09117486E−10 | 3.20727994E−09 | −1.22313534E−10 | −2.18818267E−09 |
| A26= | −1.08380229E−11 | −1.36562322E−10 | 1.71331720E−12 | 9.70885619E−11 |
| A28= | 3.19900116E−13 | 3.42800283E−12 | — | −2.58368575E−12 |
| A30= | −4.12374099E−15 | −3.84209502E−14 | — | 3.11230550E−14 |
| Surface # | 12 | 13 | 15 | 16 |
| k= | 0.0000E+00 | 0.0000E+00 | 0.0000E+00 | 0.0000E+00 |
| A4= | −1.02338039E−03 | 8.00044561E−04 | 7.89411549E−02 | 7.90188571E−02 |
| A6= | 2.06409911E−04 | −8.35569077E−05 | −2.25246967E−02 | −2.18199516E−02 |
| A8= | −1.93816262E−04 | 1.55086278E−04 | 4.43886532E−03 | 7.79070409E−03 |
| A10= | 4.53187309E−05 | −1.77230286E−04 | 2.83305063E−04 | −6.71286769E−03 |
| A12= | 1.50772199E−05 | 1.24916051E−04 | −5.52194088E−04 | 6.08387286E−03 |
| A14= | −1.52038781E−05 | −5.32881001E−05 | 1.95310100E−04 | −3.71513271E−03 |
| A16= | 4.76188534E−06 | 1.41235421E−05 | −3.62913931E−05 | 1.50859831E−03 |
| A18= | −7.64950176E−07 | −2.38534498E−06 | 3.46842562E−06 | −4.13375370E−04 |
| A20= | 6.79511390E−08 | 2.58573538E−07 | −7.38079257E−08 | 7.58053767E−05 |
| A22= | −3.17919260E−09 | −1.75323585E−08 | −1.47790104E−08 | −8.92839233E−06 |
| A24= | 6.13114779E−11 | 6.81498136E−10 | 9.67497370E−10 | 6.10903659E−07 |
| A26= | — | −1.16638370E−11 | — | −1.84583473E−08 |
| Surface # | 17 | 18 | 19 | 20 |
| k= | 0.0000E+00 | 0.0000E+00 | 0.0000E+00 | 0.0000E+00 |
| A4= | 1.82987342E−02 | 3.88438755E−03 | −1.69960851E−02 | −1.10308760E−02 |
| A6= | −2.19995529E−02 | −1.58158650E−02 | 9.24979745E−03 | 9.69317033E−03 |
| A8= | 1.93145226E−02 | 2.02299266E−02 | 5.36639619E−03 | −4.49116406E−03 |
| A10= | −1.81040233E−02 | −1.95232541E−02 | −8.61616335E−03 | 1.60998310E−03 |
| A12= | 1.26120441E−02 | 1.24991190E−02 | 5.15375866E−03 | −4.62022331E−04 |
| A14= | −6.13445174E−03 | −5.55792526E−03 | −1.84150975E−03 | 1.00280121E−04 |
| A16= | 2.06023359E−03 | 1.78210101E−03 | 4.29638399E−04 | −1.61551961E−05 |
| A18= | −4.66546597E−04 | −4.18388586E−04 | −6.68571053E−05 | 1.92710247E−06 |
| A20= | 6.66839076E−05 | 7.17312918E−05 | 6.82347253E−06 | −1.68224194E−07 |
| A22= | −4.80512736E−06 | −8.82270530E−06 | −4.23774593E−07 | 1.03596693E−08 |
| A24= | −7.81768390E−08 | 7.52203615E−07 | 1.19349342E−08 | −4.16129057E−10 |
| A26= | 4.56349018E−08 | −4.18637965E−08 | 2.17034185E−10 | 9.13355178E−12 |
| A28= | −3.37008663E−09 | 1.35650571E−09 | −2.53783632E−11 | −5.03462885E−14 |
| A30= | 8.28044966E−11 | −1.92353442E−11 | 5.30440123E−13 | −1.12652863E−15 |

In the 8th embodiment, the equation of the aspheric surface profiles of the aforementioned lens elements is the same as the equation of the 1st embodiment. Also, the definitions of these parameters shown in Table 8D below are the same as those stated in the 1st embodiment, with corresponding values for the 8th embodiment; therefore, an explanation in this regard will not be provided again.

Moreover, these parameters can be calculated from Table 8A to Table 8C as the following values and satisfy the following conditions:

TABLE 8D
Values of Optical and Physical Parameters/Definitions

| | | | |
|---|---|---|---|
| fL [mm] | 18.95 | fL/fS | 1.46 |
| FnoL | 1.91 | TL/fL | 1.15 |
| HFOVL [deg.] | 14.9 | TL/ImgH | 4.25 |
| FOVL [deg.] | 29.8 | fL/f234 | 1.39 |
| Dr3i/BL (1st state) | 1.91 | f1/f2 | 0.47 |
| T12/f + T12/BL (1st state) | 0.61 | (f4 + f5)/f1 | −0.29 |
| T12/CT1 (1st state) | 1.63 | (\|R8\| + \|R10\|)/fL | 0.69 |
| T56/CT1 (1st state) | 0.54 | R10/R1 | −0.58 |
| T34/T45 (1st state) | 0.94 | R6/R3 | 1.46 |
| fS [mm] | 12.96 | R6/R8 | −0.93 |
| FnoS | 2.46 | ΣCT/ΣAT | 0.79 |
| HFOVS [deg.] | 13.8 | 10 × (CT5 + CT6)/f6 | −0.08 |
| FOVS [deg.] | 27.6 | CT6/CT7 | 1.01 |
| Dr3i/BL (2nd state) | 2.16 | ΣETL/ΣCT | 0.68 |
| T12/f + T12/BL (2nd state) | 0.29 | ET6L/CT6 | 0.83 |
| T12/CT1 (2nd state) | 0.67 | ET7L/CT7 | 1.11 |
| T56/CT1 (2nd state) | 0.54 | Y7R1L/Y6R2L | 1.09 |
| T34/T45 (2nd state) | 0.27 | SAG7R1L/SAG7R2L | 1.23 |

### 9th Embodiment

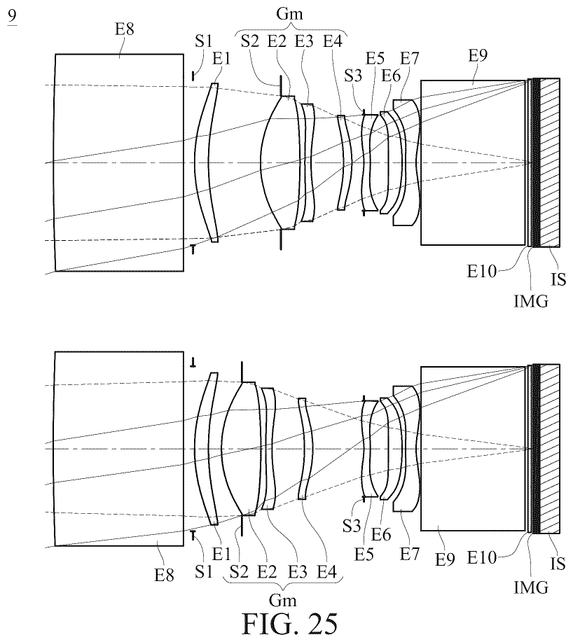

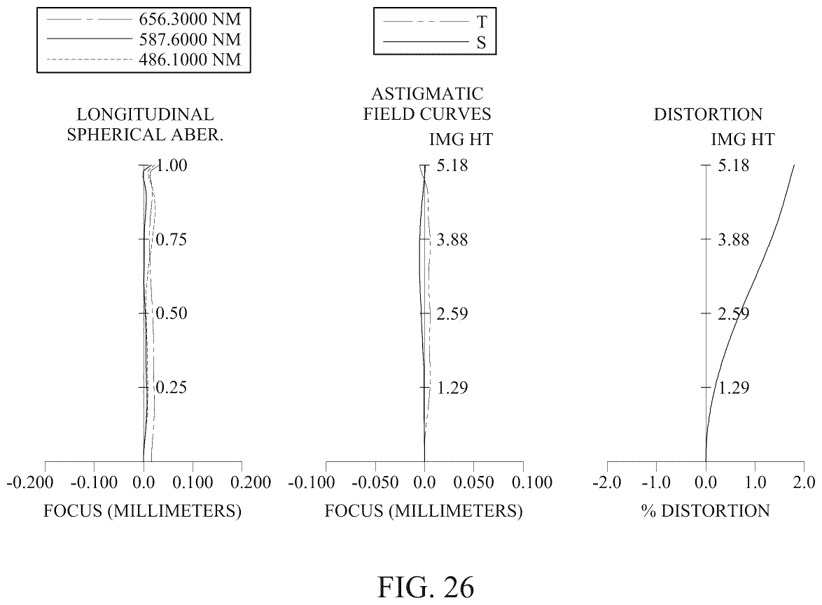

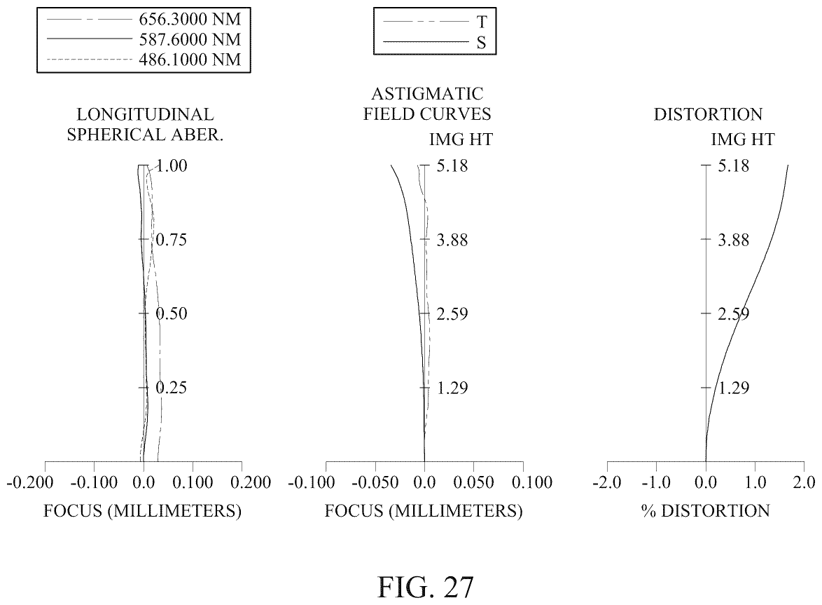

FIG. 25 is a schematic view of an image capturing unit respectively in a first state and a second state according to the 9th embodiment of the present disclosure. FIG. 26 shows, in order from left to right, spherical aberration curves, astigmatic field curves and a distortion curve of the image capturing unit in the first state according to the 9th embodiment. FIG. 27 shows, in order from left to right, spherical aberration curves, astigmatic field curves and a distortion curve of the image capturing unit in the second state according to the 9th embodiment. In FIG. 25, the image capturing unit 9 includes the imaging optical lens assembly (its reference numeral is omitted) of the present disclosure and an image sensor IS. The imaging optical lens assembly includes, in order from an object side to an image side along an optical path, a first reflective element E8, a stop S1, a first lens element E1, a stop S2, a second lens element E2, a third lens element E3, a fourth lens element E4, a stop S3, a fifth lens element E5, a sixth lens element E6, a seventh lens element E7, a second reflective element E9, a filter E10 and an image surface IMG. Furthermore, the imaging optical lens assembly has a movable group Gm, and the movable group Gm includes the stop S2, the second lens element E2, the third lens element E3 and the fourth lens element E4. The imaging optical lens assembly includes seven lens elements (E1, E2, E3, E4, E5, E6 and E7) with no additional lens element disposed between each of the adjacent seven lens elements. In addition, there is no additional lens element located between the first lens element E1 and the first reflective element E8 along an optical axis, and there is no additional lens element located between the seventh lens element E7 and the second reflective element E9 along the optical axis.

When an imaged object is located at an infinite object distance, the imaging optical lens assembly is in the first state as shown in the upper part of FIG. 25. When an imaged object is located at a finite object distance, the imaging optical lens assembly is in the second state as shown in the lower part of FIG. 25. When an imaged object is moved from an infinite object distance to a finite object distance, the movable group Gm is moved along the optical axis for focus adjustment, and the imaging optical lens assembly is transitioned from the first state to the second state. Conversely, when an imaged object is moved from a finite object distance to an infinite object distance, the movable group Gm is moved along the optical axis for focus adjustment, and the imaging optical lens assembly is transitioned from the second state to the first state. Particularly, the movable group Gm is moved towards the object side along the optical axis during the focus adjustment process when the imaging optical lens assembly is transitioned from the first state to the second state. It should be noted that all elements (e.g., the stop, lens element, and/or aperture stop) in the movable group Gm are immovable relative to one another during the focus adjustment process.

The first reflective element E8 with positive refractive power has an object-side surface being convex in a paraxial region thereof and an image-side surface being planar in a paraxial region thereof. The first reflective element E8 is made of glass material and located along the optical path between an imaged object and the first lens element E1. The first reflective element E8 is a prism with optical path folding function.

The first lens element E1 with positive refractive power has an object-side surface being convex in a paraxial region thereof and an image-side surface being concave in a paraxial region thereof. The first lens element E1 is made of glass material and has the object-side surface and the image-side surface being both aspheric. The object-side surface of the first lens element E1 has one inflection point. The image-side surface of the first lens element E1 has one inflection point.

The second lens element E2 with positive refractive power has an object-side surface being convex in a paraxial region thereof and an image-side surface being convex in a paraxial region thereof. The second lens element E2 is made of glass material and has the object-side surface and the image-side surface being both aspheric. The object-side surface of the second lens element E2 has one inflection point.

The third lens element E3 with negative refractive power has an object-side surface being convex in a paraxial region thereof and an image-side surface being concave in a paraxial region thereof. The third lens element E3 is made of plastic material and has the object-side surface and the image-side surface being both aspheric. The object-side surface of the third lens element E3 has one inflection point. The image-side surface of the third lens element E3 has one inflection point. The object-side surface of the third lens element E3 has one critical point in an off-axis region thereof. The image-side surface of the third lens element E3 has one critical point in an off-axis region thereof.

The fourth lens element E4 with positive refractive power has an object-side surface being concave in a paraxial region thereof and an image-side surface being convex in a paraxial region thereof. The fourth lens element E4 is made of plastic material and has the object-side surface and the image-side surface being both aspheric. The object-side surface of the fourth lens element E4 has one inflection point. The image-side surface of the fourth lens element E4 has one inflection point.

The fifth lens element E5 with negative refractive power has an object-side surface being concave in a paraxial region thereof and an image-side surface being convex in a paraxial region thereof. The fifth lens element E5 is made of plastic material and has the object-side surface and the image-side surface being both aspheric. The object-side surface of the fifth lens element E5 has one inflection point. The image-side surface of the fifth lens element E5 has one inflection point. The object-side surface of the fifth lens element E5 has one critical point in an off-axis region thereof. The image-side surface of the fifth lens element E5 has one critical point in an off-axis region thereof.

The sixth lens element E6 with positive refractive power has an object-side surface being concave in a paraxial region thereof and an image-side surface being convex in a paraxial region thereof. The sixth lens element E6 is made of plastic material and has the object-side surface and the image-side surface being both aspheric. The object-side surface of the sixth lens element E6 has one inflection point. The image-side surface of the sixth lens element E6 has one inflection point.

The seventh lens element E7 with negative refractive power has an object-side surface being convex in a paraxial region thereof and an image-side surface being concave in a paraxial region thereof. The seventh lens element E7 is made of plastic material and has the object-side surface and the image-side surface being both aspheric. The object-side surface of the seventh lens element E7 has two inflection points. The image-side surface of the seventh lens element E7 has one inflection point. The object-side surface of the seventh lens element E7 has one critical point in an off-axis region thereof. The image-side surface of the seventh lens element E7 has one critical point in an off-axis region thereof.

The second reflective element E9 is made of glass material and located along the optical path between the seventh lens element E7 and the image surface IMG, and will not affect the focal length of the imaging optical lens assembly. The second reflective element E9 is a prism with optical path folding function. For simplicity in illustration, FIG. 25 does not show the folding effect caused by the first reflective element E8 and the second reflective element E9 on the optical path. However, the first reflective element E8 and the second reflective element E9 can have various configurations depending on the actual design requirements, thereby creating different folding effects on the optical path. Moreover, the first reflective element E8 and the second reflective element E9 of this embodiment each can have a configuration similar to, for example, one of the configurations shown in FIG. 37 and FIG. 38, which can be referred to foregoing descriptions corresponding to FIG. 37 and FIG. 38, and the details in this regard will not be provided again.

The filter E10 is made of glass material and located between the second reflective element E9 and the image surface IMG, and will not affect the focal length of the imaging optical lens assembly. The image sensor IS is disposed on or near the image surface IMG of the imaging optical lens assembly.

The detailed optical data of the 9th embodiment are shown in Table 9A and Table 9B, and the aspheric surface data are shown in Table 9C below.

TABLE 9A
9th Embodiment

| | | | | | | | | Focal |
|---|---|---|---|---|---|---|---|---|
| Surface # | | Curvature Radius | | Thickness | Material | Index | Abbe # | Length |
| 0 | Object | Plano | | D0 | | | | |
| 1 | Prism 1 | 153.846 | | 8.000 | Glass | 1.855 | 36.6 | 179.84 |
| 2 | | Plano | | 0.580 | | | | |
| 3 | Stop | Plano | | 0.100 | | | | |
| 4 | Lens 1 | 9.5402 | (ASP) | 0.854 | Glass | 1.517 | 64.2 | 53.41 |
| 5 | | 14.1342 | (ASP) | D1 | | | | |
| 6 | Stop | Plano | | −1.250 | | | | |
| 7 | Lens 2 | 6.5867 | (ASP) | 2.423 | Glass | 1.517 | 64.2 | 10.75 |
| 8 | | −30.9824 | (ASP) | 0.302 | | | | |
| 9 | Lens 3 | 33.3283 | (ASP) | 0.378 | Plastic | 1.697 | 16.3 | −24.91 |
| 10 | | 11.3636 | (ASP) | 1.996 | | | | |
| 11 | Lens 4 | −9.5563 | (ASP) | 0.513 | Plastic | 1.566 | 37.4 | 36.60 |
| 12 | | −6.6667 | (ASP) | D2 | | | | |
| 13 | Stop | Plano | | 0.000 | | | | |
| 14 | Lens 5 | −4.1182 | (ASP) | 0.400 | Plastic | 1.551 | 44.8 | −21.54 |
| 15 | | −6.5256 | (ASP) | 1.111 | | | | |
| 16 | Lens 6 | −45.6969 | (ASP) | 0.838 | Plastic | 1.697 | 16.3 | 19.53 |
| 17 | | −10.5700 | (ASP) | 0.211 | | | | |
| 18 | Lens 7 | 12.7683 | (ASP) | 0.646 | Plastic | 1.615 | 25.4 | −10.33 |
| 19 | | 4.1592 | (ASP) | 0.300 | | | | |

| | | | | | | | |
|---|---|---|---|---|---|---|---|
| 20 | Prism 2 | Plano | 6.400 | Glass | 1.804 | 46.6 | — |
| 21 | | Plano | 0.180 | | | | |
| 22 | Filter | Plano | 0.210 | Glass | 1.517 | 64.2 | — |
| 23 | | Plano | 0.109 | | | | |
| 24 | Image | Plano | — | | | | |

Note:
Reference wavelength is 587.6 nm (d-line).
An effective radius of the stop S1 (Surface 3) is 5.073 mm.
An effective radius of the stop S2 (Surface 6) is 4.103 mm.
An effective radius of the stop S3 (Surface 13) is 2.948 mm.
The imaging optical lens assembly can further include an aperture stop, and the position of the aperture stop can be adjusted depending on the object distance, or can be adjusted depending on the arrangement of the front reflective element (the first reflective element) or the trimmed edge(s) of lens element(s).

Values of the object distance, D0, D1 and D2 may change depending on whether the imaging optical lens assembly is in the first state or the second state for focus adjustment (as shown in Table 9B below). The definitions of the parameters shown in Table 9B are the same as those stated in the 1st embodiment, with corresponding values for the 9th embodiment; therefore, no further explanation will be provided.

TABLE 9B
Values of Optical And Physical Parameters/Definitions

| First State | | Second State | |
|---|---|---|---|
| (Infinite Object Distance) | | (Finite Object Distance) | |
| fL [mm] | 16.85 | fS [mm] | 12.12 |
| FnoL | 1.76 | FnoS | 2.22 |
| HFOVL [deg.] | 16.8 | HFOVS [deg.] | 14.4 |
| Object Distance [mm] | ∞ | Object Distance [mm] | 63.680 |
| D0 [mm] | ∞ | D0 [mm] | 55.000 |
| D1 [mm] | 4.450 | D1 [mm] | 2.050 |
| D2 [mm] | 0.738 | D2 [mm] | 3.138 |

It should be understood that, in this embodiment, only two moving focus states (i.e., the first state and the second state) are disclosed, but the present disclosure is not limited thereto. Besides the first state and the second state, the imaging optical lens assembly in this embodiment can also have other moving focus states with different focal lengths between the first state and the second state to accommodate focusing conditions for other object distances.

In Table 9B, the movable group Gm of the imaging optical lens assembly is moved for focus adjustment according to the change of object distance. For example, the movable group Gm is moved toward the object side along the optical axis for focus adjustment when an imaged object is moved from an infinite object distance to a finite object distance, such that the imaging optical lens assembly is transitioned from the first state to the second state. Specifically, when the object distance changes from infinite to a finite object distance of 63.680 mm, the imaging optical lens assembly is transitioned from the first state to the second state, the axial distance D1 between the image-side surface of the first lens element E1 and the stop S2 decreases from 4.450 mm in the first state to 2.050 mm in the second state, and the axial distance D2 between the image-side surface of the fourth lens element E4 and the stop S3 increases from 0.738 mm in the first state to 3.138 mm in the second state. In other words, when the object distance decreases, the movable group Gm is moved toward the object side along the optical axis during the focus adjustment process.

TABLE 9C
Aspheric Coefficients

| Surface # | 4 | 5 | 7 | 8 |
|---|---|---|---|---|
| k= | 0.0000E+00 | 0.0000E+00 | 0.0000E+00 | 0.0000E+00 |
| A4= | −2.66491143E−04 | −2.92780669E−04 | −2.18421396E−04 | −4.42500385E−04 |
| A6= | 1.70031018E−05 | 1.99932103E−05 | 3.11770197E−05 | 2.76155610E−04 |
| A8= | −9.36598862E−06 | −1.30767295E−05 | −2.48047968E−05 | 2.77298491E−05 |
| A10= | 2.12242379E−06 | 3.85994734E−06 | 1.12705589E−05 | −5.01308303E−05 |
| A12= | −2.84096209E−07 | −7.07220354E−07 | −3.17582108E−06 | 1.67811703E−05 |
| A14= | 2.14169109E−08 | 8.42443744E−08 | 5.84260315E−07 | −3.20878527E−06 |
| A16= | −6.55104302E−10 | −6.71504721E−09 | −7.27746623E−08 | 4.04633592E−07 |
| A18= | −2.85555399E−11 | 3.59731197E−10 | 6.19020132E−09 | −3.47976691E−08 |
| A20= | 3.70634150E−12 | −1.27036363E−11 | −3.54137028E−10 | 2.02262361E−09 |
| A22= | −1.58509552E−13 | 2.80848795E−13 | 1.30142107E−11 | −7.60146889E−11 |
| A24= | 3.27592411E−15 | −3.47155506E−15 | −2.76941946E−13 | 1.66602311E−12 |
| A26= | −2.73665246E−17 | 1.78726497E−17 | 2.58529280E−15 | −1.61562936E−14 |
| Surface # | 9 | 10 | 11 | 12 |
| k= | 0.0000E+00 | 0.0000E+00 | 0.0000E+00 | 0.0000E+00 |
| A4= | −1.91690331E−03 | −1.43018134E−03 | −7.05582682E−04 | 5.30500986E−04 |
| A6= | 5.82395374E−04 | 2.92279666E−04 | 4.99798907E−05 | 1.14670515E−06 |
| A8= | −1.15317155E−06 | 3.26612091E−05 | 8.83965547E−05 | 1.84076496E−04 |
| A10= | −9.45759681E−05 | −9.08193973E−05 | −3.55934362E−05 | −1.04517294E−04 |
| A12= | 3.52847869E−05 | 3.34991082E−05 | 7.88738108E−06 | 4.19096807E−05 |
| A14= | −7.21096284E−06 | −7.05592446E−06 | −8.76008981E−07 | −1.18827734E−05 |
| A16= | 9.73756571E−07 | 1.00139906E−06 | 2.29383174E−08 | 2.42159397E−06 |
| A18= | −9.05374724E−08 | −9.96844548E−08 | 6.95740563E−09 | −3.48051184E−07 |
| A20= | 5.74971534E−09 | 6.95761554E−09 | −9.75944941E−10 | 3.42044825E−08 |
| A22= | −2.38331146E−10 | −3.31413961E−10 | 5.36460938E−11 | −2.17868901E−09 |
| A24= | 5.80596669E−12 | 1.01461837E−11 | −1.11720745E−12 | 8.07917099E−11 |
| A26= | −6.29497464E−14 | −1.76563172E−13 | — | −1.32067240E−12 |
| A28= | — | 1.28259971E−15 | — | — |
| Surface # | 14 | 15 | 16 | 17 |
| k= | 0.0000E+00 | 0.0000E+00 | 0.0000E+00 | 0.0000E+00 |
| A4= | 4.57883830E−02 | 4.52045105E−02 | 7.66303676E−03 | 1.51046044E−03 |
| A6= | −1.10257014E−02 | −1.02191353E−02 | −5.70781009E−03 | −1.17375500E−03 |
| A8= | 2.70078122E−03 | 2.00418687E−03 | 3.74238367E−03 | 5.43027672E−04 |
| A10= | −6.03944735E−04 | −2.84576863E−04 | −3.24025212E−03 | −8.89805116E−04 |
| A12= | 1.22565804E−04 | 1.12613118E−05 | 2.31820730E−03 | 8.04847726E−04 |
| A14= | −2.12456579E−05 | 9.33489184E−06 | −1.19899526E−03 | −4.32818124E−04 |
| A16= | 2.90768858E−06 | −3.58679510E−06 | 4.41275653E−04 | 1.52338257E−04 |
| A18= | −2.89994789E−07 | 7.39066747E−07 | −1.16265782E−04 | −3.68457969E−05 |
| A20= | 1.93714821E−08 | −9.70915035E−08 | 2.19743545E−05 | 6.24934161E−06 |
| A22= | −7.65521884E−10 | 8.08235284E−09 | −2.95312175E−06 | −7.43190658E−07 |
| A24= | 1.34334994E−11 | −3.89790869E−10 | 2.75276575E−07 | 6.07225090E−08 |
| A26= | — | 8.32172158E−12 | −1.69078147E−08 | −3.24579016E−09 |
| A28= | — | — | 6.14980757E−10 | 1.02130654E−10 |
| A30= | — | — | −1.00268396E−11 | −1.43257357E−12 |

| Surface # | 18 | 19 |
|---|---|---|
| k= | 0.0000E+00 | 0.0000E+00 |
| A4= | −3.08710157E−02 | −3.41827251E−02 |
| A6= | 8.13475401E−03 | 8.43316228E−03 |
| A8= | −2.29538378E−03 | −2.28110373E−03 |
| A10= | 4.57896593E−04 | 5.36261939E−04 |
| A12= | 3.71299373E−05 | −1.05739034E−04 |
| A14= | −7.80010207E−05 | 1.70146806E−05 |
| A16= | 3.41989690E−05 | −2.20140603E−06 |
| A18= | −8.88007793E−06 | 2.25294929E−07 |
| A20= | 1.54068799E−06 | −1.78210348E−08 |
| A22= | −1.83566016E−07 | 1.05407363E−09 |
| A24= | 1.48713998E−08 | −4.44692429E−11 |
| A26= | −7.83881568E−10 | 1.24476380E−12 |
| A28= | 2.42542390E−11 | −2.03257115E−14 |
| A30= | −3.34168062E−13 | 1.42348955E−16 |

In the 9th embodiment, the equation of the aspheric surface profiles of the aforementioned lens elements is the same as the equation of the 1st embodiment. Also, the definitions of these parameters shown in Table 9D below are the same as those stated in the 1st embodiment, with corresponding values for the 9th embodiment; therefore, an explanation in this regard will not be provided again.

Moreover, these parameters can be calculated from Table 9A to Table 9C as the following values and satisfy the following conditions:

TABLE 9D
Values of Optical and Physical Parameters/Definitions

| | | | |
|---|---|---|---|
| fL [mm] | 16.85 | fL/fS | 1.39 |
| FnoL | 1.76 | TL/fL | 1.23 |
| HFOVL [deg.] | 16.8 | TL/ImgH | 4.02 |
| FOVL [deg.] | 33.6 | fL/f234 | 1.31 |
| Dr3i/BL (1st state) | 2.33 | f1/f2 | 4.97 |
| T12/f + T12/BL (1st state) | 0.63 | (f4 + f5)/f1 | 0.28 |
| T12/CT1 (1st state) | 3.75 | (\|R8\| + \|R10\|)/fL | 0.78 |
| T56/CT1 (1st state) | 1.30 | R10/R1 | −0.68 |
| T34/T45 (1st state) | 2.70 | R6/R3 | 1.73 |
| fS [mm] | 12.12 | R6/R8 | −1.70 |
| FnoS | 2.22 | ΣCT/ΣAT | 0.80 |
| HFOVS [deg.] | 14.4 | 10 × (CT5 + CT6)/f6 | 0.63 |
| FOVS [deg.] | 28.8 | CT6/CT7 | 1.30 |
| Dr3i/BL (2nd state) | 2.66 | ΣETL/ΣCT | 0.77 |
| T12/f + T12/BL (2nd state) | 0.18 | ET6L/CT6 | 0.52 |
| T12/CT1 (2nd state) | 0.94 | ET7L/CT7 | 1.78 |
| T56/CT1 (2nd state) | 1.30 | Y7R1L/Y6R2L | 1.04 |
| T34/T45 (2nd state) | 0.64 | SAG7R1L/SAG7R2L | 3.06 |

### 10th Embodiment

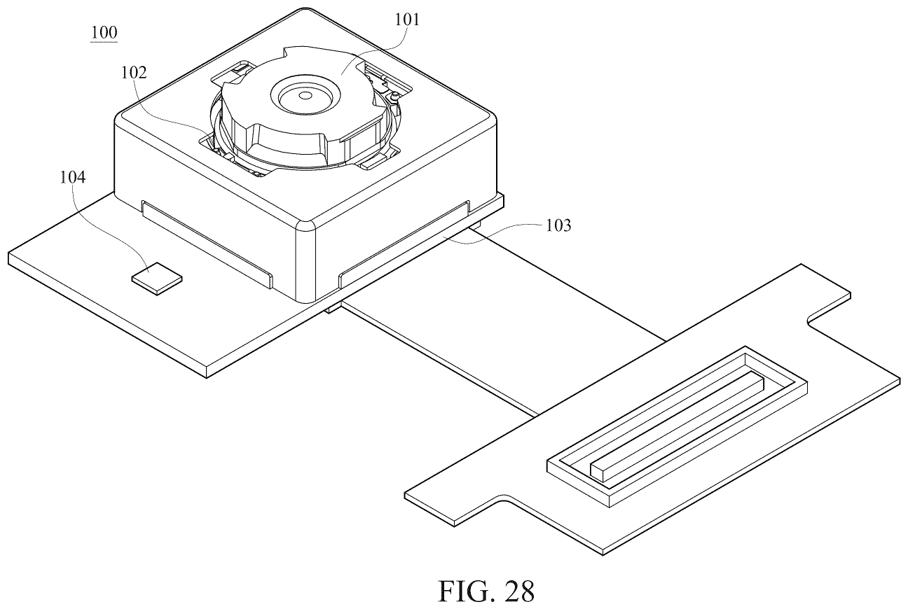

FIG. 28 is a perspective view of an image capturing unit according to the 10th embodiment of the present disclosure. In this embodiment, an image capturing unit 100 is a camera module including a lens unit 101, a driving device 102, an image sensor 103 and an image stabilizer 104. The lens unit 101 includes the imaging optical lens assembly as disclosed in the 1st embodiment, a barrel and a holder member (their reference numerals are omitted) for holding the imaging optical lens assembly. However, the lens unit 101 may alternatively be provided with the imaging optical lens assembly as disclosed in other embodiments of the present disclosure, and the present disclosure is not limited thereto. The imaging light converges in the lens unit 101 of the image capturing unit 100 to generate an image with the driving device 102 utilized for image focusing on the image sensor 103, and the generated image is then digitally transmitted to other electronic component for further processing.

The driving device 102 can have an auto-focusing function, and the driving device 102 can utilize various driving configurations, such as lead screws, voice coil motors (VCM), micro electro-mechanical systems (MEMS), piezoelectric systems, shape memory alloys, spring type, or ball type driving systems, but the present disclosure is not limited thereto. The driving device 102 is favorable for obtaining a better imaging position for the lens unit 101, so that a clear image of the imaged object can be captured by the lens unit 101 with different object distances. The image sensor 103 (for example, CMOS or CCD), which can feature high photosensitivity and low noise, is disposed on the image surface of the imaging optical lens assembly to provide higher image quality.

The image stabilizer 104, such as an accelerometer, a gyro sensor and a Hall Effect sensor, is configured to work with the driving device 102 to provide optical image stabilization (OIS). The driving device 102 working with the image stabilizer 104 is favorable for compensating for pan and tilt of the lens unit 101 to reduce blurring associated with motion during exposure. In some cases, the compensation can be provided by electronic image stabilization (EIS) with image processing software, thereby improving image quality while in dynamic or low-light scenarios. Some movable elements in the image capturing unit 100 can be driven by the driving device 102 to compensate for image tilt in real-time, achieving optical image stabilization. For example, the driving device 102 can drive the movable elements such as the movable group of the imaging optical lens assembly and the image sensor 103 to move in directions parallel to, inclined to, or perpendicular to the optical axis. However, the present disclosure is not limited to the driving configurations mentioned above.

### 11th Embodiment

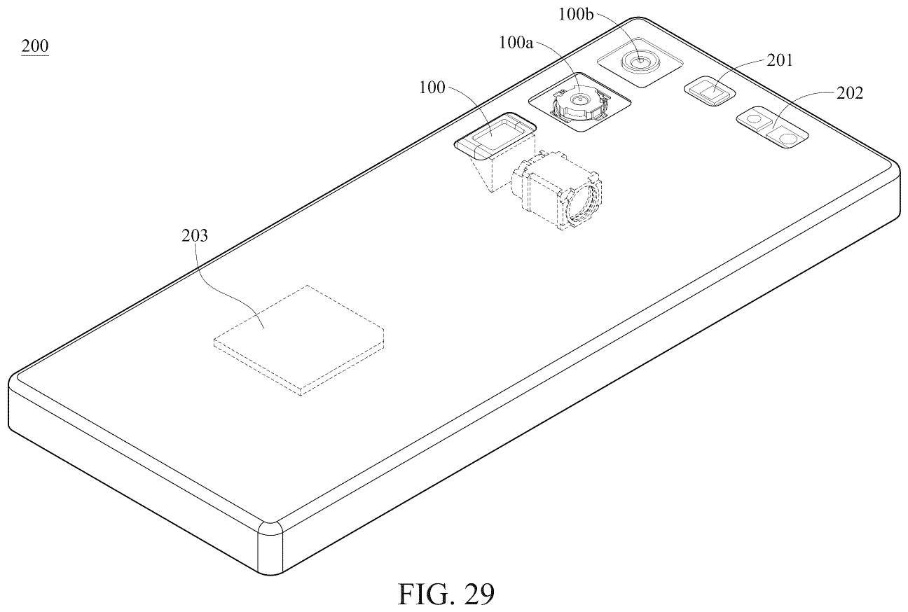

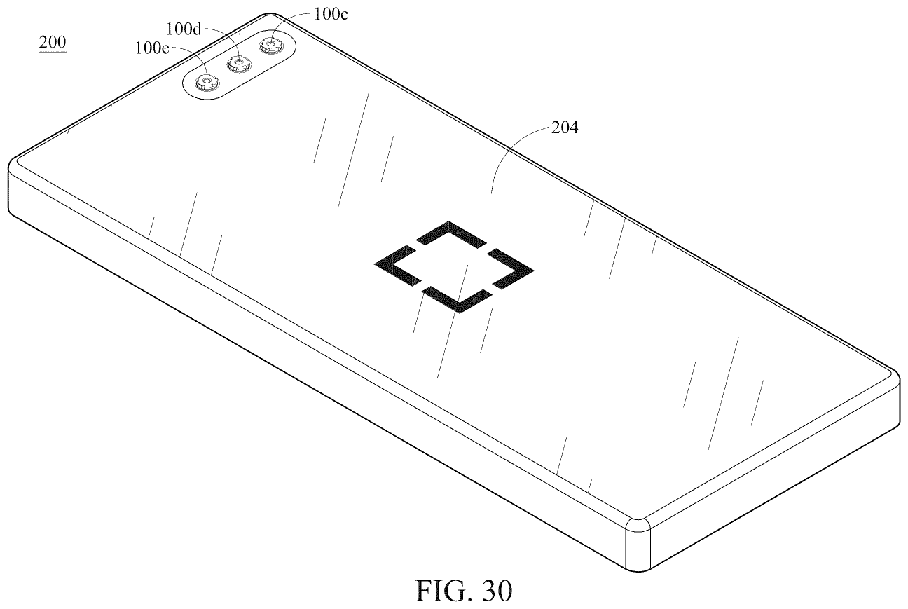

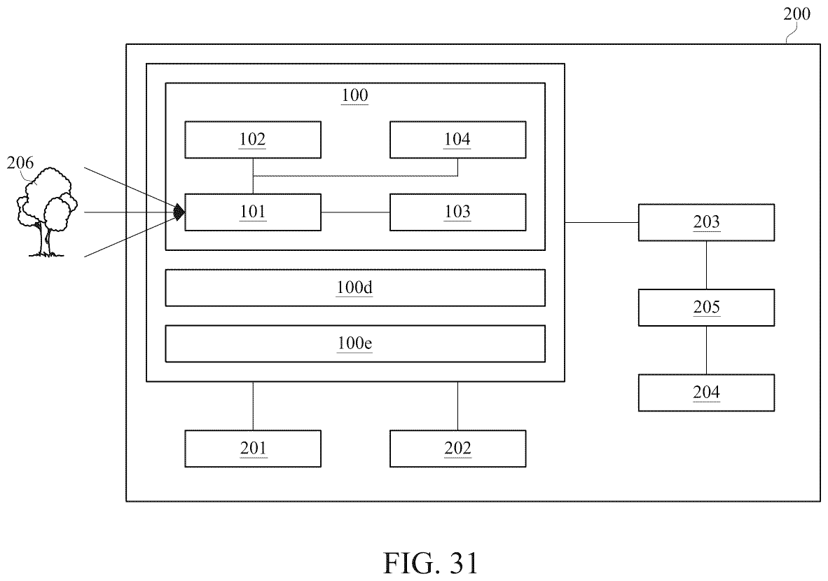

FIG. 29 is one perspective view of an electronic device according to the 11th embodiment of the present disclosure, FIG. 30 is another perspective view of the electronic device in FIG. 29, and FIG. 31 is a block diagram of the electronic device in FIG. 29.

In this embodiment, an electronic device 200 is a smartphone including the image capturing unit 100 as disclosed in the 10th embodiment, an image capturing unit 100a, an image capturing unit 100b, an image capturing unit 100c, an image capturing unit 100d, an image capturing unit 100e, a flash module 201, a focus assist module 202, an image signal processor 203, a display module 204 and an image software processor 205. The image capturing unit 100, the image capturing unit 100a and the image capturing unit 100b are disposed on the same side of the electronic device 200, and each of the image capturing units 100, 100a and 100b has a single focal point. The focus assist module 202 can be a laser rangefinder or a ToF (time of flight) module, but the present disclosure is not limited thereto. The image capturing unit 100c, the image capturing unit 100d, the image capturing unit 100e and the display module 204 are disposed on the opposite side of the electronic device 200, and the display module 204 can be a user interface, such that the image capturing units 100c, 100d and 100e can be front-facing cameras of the electronic device 200 for taking selfies, but the present disclosure is not limited thereto. Furthermore, each of the image capturing units 100a, 100b, 100c, 100d and 100e can include the imaging optical lens assembly of the present disclosure and can have a configuration similar to that of the image capturing unit 100. In detail, each of the image capturing units 100a, 100b, 100c, 100d and 100e can include a lens unit, a driving device, an image sensor and an image stabilizer, and can also include a reflective element for folding optical path. In addition, each lens unit of the image capturing units 100a, 100b, 100c, 100d and 100e can include the imaging optical lens assembly of the present disclosure, a barrel and a holder member for holding the imaging optical lens assembly.

The image capturing unit 100 is a telephoto image capturing unit with optical path folding function, the image capturing unit 100a is a wide-angle image capturing unit, the image capturing unit 100b is an ultra-wide-angle image capturing unit, the image capturing unit 100c is a wide-angle image capturing unit, the image capturing unit 100d is an ultra-wide-angle image capturing unit, and the image capturing unit 100e is a ToF image capturing unit. In this embodiment, the image capturing units 100, 100a and 100b have different fields of view, such that the electronic device 200 can have various magnification ratios so as to meet the requirement of optical zoom functionality. In addition, the image capturing unit 100e can determine depth information of the imaged object. Moreover, the light-folding configuration of the image capturing unit 100 can be similar to, for example, one of the configurations as shown in FIG. 41 to FIG. 45, which can be referred to foregoing descriptions corresponding to FIG. 41 to FIG. 45, and the details in this regard will not be provided again. In addition, each of the image capturing units 100a, 100b, 100c, 100d and 100e can also have a light-folding configuration similar to, for example, one of the configurations as shown in FIG. 41 to FIG. 45, which can be referred to foregoing descriptions corresponding to FIG. 41 to FIG. 45, and the details in this regard will not be provided again. In this embodiment, the electronic device 200 includes multiple image capturing units 100, 100a, 100b, 100c, 100d and 100e, but the present disclosure is not limited to the number and arrangement of image capturing units.

When a user captures images of an object 206, the light rays converge in the image capturing unit 100, the image capturing unit 100a or the image capturing unit 100b to generate images, and the flash module 201 is activated for light supplement. The focus assist module 202 detects the object distance of the imaged object 206 to achieve fast auto focusing. The image signal processor 203 is configured to optimize the captured image to improve image quality. The light beam emitted from the focus assist module 202 can be either conventional infrared or laser. In addition, the light rays may converge in the image capturing unit 100c, 100d or 100e to generate images. The display module 204 can include a touch screen, and the user is able to interact with the display module 204 and the image software processor 205 having multiple functions to capture images and complete image processing. Alternatively, the user may capture images via a physical button. The image processed by the image software processor 205 can be displayed on the display module 204.

### 12th Embodiment

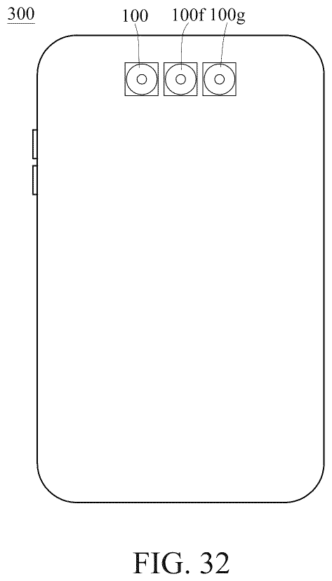

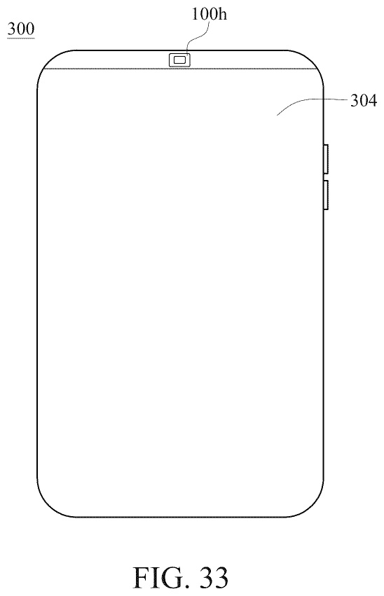

FIG. 32 is one schematic view of an electronic device according to the 12th embodiment of the present disclosure, and FIG. 33 is another schematic view of the electronic device in FIG. 32.

In this embodiment, an electronic device 300 is a smartphone including the image capturing unit 100 as disclosed in the 10th embodiment, an image capturing unit 100f, an image capturing unit 100g, an image capturing unit 100h and a display module 304. As shown in FIG. 32, the image capturing unit 100, the image capturing unit 100f and the image capturing unit 100g are disposed on the same side of the electronic device 300, and each of the image capturing units 100, 100f and 100g has a single focal point. As shown in FIG. 33, the image capturing unit 100h and the display module 304 are disposed on the opposite side of the electronic device 300, such that the image capturing unit 100h can be a front-facing camera of the electronic device 300 for taking selfies, but the present disclosure is not limited thereto. Furthermore, each of the image capturing units 100f, 100g and 100h can include the imaging optical lens assembly of the present disclosure and can have a configuration similar to that of the image capturing unit 100. In detail, each of the image capturing units 100f, 100g and 100h can include a lens unit, a driving device, an image sensor and an image stabilizer. In addition, each lens unit of the image capturing units 100f, 100g and 100h can include the imaging optical lens assembly of the present disclosure, a barrel and a holder member for holding the imaging optical lens assembly.

The image capturing unit 100 is a telephoto image capturing unit, the image capturing unit 100f is a wide-angle image capturing unit, the image capturing unit 100g is an ultra-wide-angle image capturing unit, and the image capturing unit 100h is a wide-angle image capturing unit. In this embodiment, the image capturing units 100, 100f and 100g have different fields of view, such that the electronic device 300 can have various magnification ratios so as to meet the requirement of optical zoom functionality. Moreover, as shown in FIG. 33, the image capturing unit 100h can have a non-circular opening, and the barrel or lens elements in the image capturing unit 100h can have trimmed edges at their peripheries so as to coordinate with the shape of the non-circular opening. Therefore, the length of the major axis and/or the minor axis of the image capturing unit 100h can be further reduced, which is favorable for reducing the size of the image capturing unit 100h so as to increase the ratio of the area of the display module 304 relative to that of the electronic device 300, and reduce the thickness of the electronic device 300, thereby achieving compactness. In addition, at least one lens element of the imaging optical lens assembly can have a non-circular optically effective area after the at least one lens element is cut at its periphery. In this embodiment, the electronic device 300 includes multiple image capturing units 100, 100f, 100g and 100h, but the present disclosure is not limited to the number and arrangement of image capturing units.

### 13th Embodiment

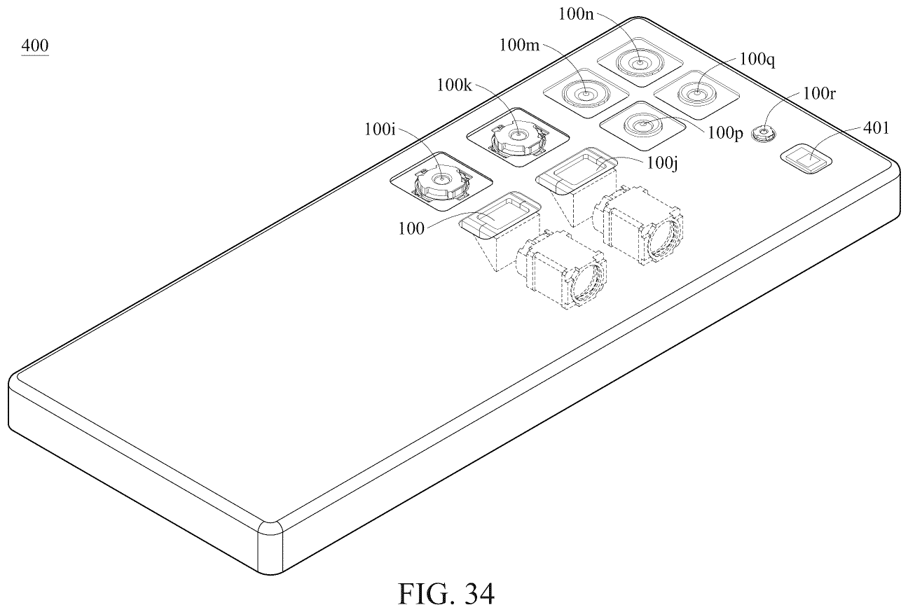

FIG. 34 is one perspective view of an electronic device according to the 13th embodiment of the present disclosure.

In this embodiment, an electronic device 400 is a smartphone including the image capturing unit 100 as disclosed in the 10th embodiment, an image capturing unit 100i, an image capturing unit 100j, an image capturing unit 100k, an image capturing unit 100m, an image capturing unit 100n, an image capturing unit 100p, an image capturing unit 100q, an image capturing unit 100r, a flash module 401, a focus assist module, an image signal processor, a display module and an image software processor (not shown). The image capturing units 100, 100i, 100j, 100k, 100m, 100n, 100p, 100q and 100r are disposed on the same side of the electronic device 400, while the display module is disposed on the opposite side of the electronic device 400. Furthermore, each of the image capturing units 100i, 100j, 100k, 100m, 100n, 100p, 100q and 100r can include the imaging optical lens assembly of the present disclosure and can have a configuration similar to that of the image capturing unit 100, and the details in this regard will not be provided again.

The image capturing unit 100 is a telephoto image capturing unit with optical path folding function, the image capturing unit 100i is a wide-angle image capturing unit, the image capturing unit 100j is a telephoto image capturing unit with optical path folding function, the image capturing unit 100k is a wide-angle image capturing unit, the image capturing unit 100m is an ultra-wide-angle image capturing unit, the image capturing unit 100n is an ultra-wide-angle image capturing unit, the image capturing unit 100p is a telephoto image capturing unit, the image capturing unit 100q is a telephoto image capturing unit, and the image capturing unit 100r is a ToF image capturing unit. In this embodiment, the image capturing units 100, 100i, 100j, 100k, 100m, 100n, 100p and 100q have different fields of view, such that the electronic device 400 can have various magnification ratios so as to meet the requirement of optical zoom functionality. In addition, the image capturing unit 100r can determine depth information of the imaged object. Moreover, the light-folding configuration of the image capturing units 100 and 100j can be similar to, for example, one of the structures shown in FIG. 41 to FIG. 45, which can be referred to foregoing descriptions corresponding to FIG. 41 to FIG. 45, and the details in this regard will not be provided again. In this embodiment, the electronic device 400 includes multiple image capturing units 100, 100i, 100j, 100k, 100m, 100n, 100p, 100q and 100r, but the present disclosure is not limited to the number and arrangement of image capturing units. When a user captures images of an object, the light rays converge in the image capturing unit 100, 100i, 100j, 100k, 100m, 100n, 100p, 100q or 100r to generate images, and the flash module 401 is activated for light supplement. Further, the subsequent processes are performed in a manner similar to the abovementioned embodiments, and the details in this regard will not be provided again.

The smartphones in the embodiments are only exemplary for showing the image capturing unit of the present disclosure installed in an electronic device, and the present disclosure is not limited thereto. The image capturing unit can be optionally applied to optical systems with a movable focus. Furthermore, the imaging optical lens assembly of the image capturing unit features good capability in aberration corrections and high image quality, and can be applied to 3D (three-dimensional) image capturing applications, in products such as digital cameras, mobile devices, digital tablets, smart televisions, network surveillance devices, dashboard cameras, vehicle backup cameras, multi-camera devices, image recognition systems, motion sensing input devices, unmanned aerial vehicles, wearable devices, portable video recorders and other electronic imaging devices.

The foregoing description, for the purpose of explanation, has been described with reference to specific embodiments. It is to be noted that TABLES 1A-9D show different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. An imaging optical lens assembly comprising seven lens elements, the seven lens elements being, in order from an object side to an image side along an optical path, a first lens element, a second lens element, a third lens element, a fourth lens element, a fifth lens element, a sixth lens element and a seventh lens element, and each of the seven lens elements having an object-side surface facing toward the object side and an image-side surface facing toward the image side;
wherein the first lens element has positive refractive power, the object-side surface of the second lens element is convex in a paraxial region thereof, the fourth lens element has positive refractive power, the image-side surface of the fourth lens element is convex in a paraxial region thereof, the image-side surface of the fifth lens element is convex in a paraxial region thereof, the image-side surface of the fifth lens element has at least one inflection point; wherein when an imaged object is located at an infinite object distance, the imaging optical lens assembly is in a first state; and
wherein a sum of central thicknesses of all lens elements of the imaging optical lens assembly is ΣCT, a central thickness of the first lens element is CT1, a sum of axial distances between each of all adjacent lens elements of the imaging optical lens assembly is ΣAT, an axial distance between the first lens element and the second lens element is T12, an axial distance between the object-side surface of the second lens element and an image surface is Dr3i, an axial distance between the image-side surface of the seventh lens element and the image surface is BL, a focal length of the imaging optical lens assembly in the first state is fL, a composite focal length of the second lens element, the third lens element and the fourth lens element is f234, and the following conditions are satisfied:
$$0.4 < \sum CT / \sum AT < 1.58 ;$$
$$1.1 < Dr 3 i / BL < 3.5 ;$$
$$0.5 < fL / f 234 < 2 \text{.30} ; and$$
$$0.05 < T 12 / CT 1 < 6.00 .$$

2. The imaging optical lens assembly of claim 1, wherein the fifth lens element has negative refractive power.

3. The imaging optical lens assembly of claim 1, wherein an axial distance between the object-side surface of the first lens element and the image surface is TL, the focal length of the imaging optical lens assembly in the first state is fL, and the following condition is satisfied:
$$0.7 < TL / fL < 1.9 .$$

4. The imaging optical lens assembly of claim 1, wherein a central thickness of the sixth lens element is CT6, a central thickness of the seventh lens element is CT7, an axial distance between the object-side surface of the first lens element and the image surface is TL, a maximum image height of the imaging optical lens assembly is ImgH, and the following conditions are satisfied:
$$0.2 < CT 6 / CT 7 < 1.45 ; and$$
$$3. 70 < TL / ImgH < 4.7 .$$

5. The imaging optical lens assembly of claim 1, wherein each of at least two lens elements in the imaging optical lens assembly has an Abbe number smaller than 30.0; and
wherein a curvature radius of the object-side surface of the second lens element is R3, a curvature radius of the image-side surface of the third lens element is R6, and the following condition is satisfied:
$$0.10 < R 6 / R 3 < 2.30 .$$

6. The imaging optical lens assembly of claim 1, wherein a curvature radius of the object-side surface of the first lens element is R1, a curvature radius of the image-side surface of the fifth lens element is R10, and the following condition is satisfied:
$$- 1.8 < R 10 / R 1 < 0.6 .$$

7. The imaging optical lens assembly of claim 1, wherein an axial distance between the fifth lens element and the sixth lens element is T56, the central thickness of the first lens element is CT1, and the following condition is satisfied:
$$0.15 < T 56 / CT 1 < 3.5 .$$

8. The imaging optical lens assembly of claim 1, wherein a central thickness of the fifth lens element is CT5, a central thickness of the sixth lens element is CT6, a focal length of the sixth lens element is f6, and the following condition is satisfied:
$$- 0.8 < 10 \times ( CT 5 + CT 6 ) / f 6 < 0.9 .$$

9. The imaging optical lens assembly of claim 1, wherein a displacement in parallel with an optical axis from an axial vertex of the object-side surface of the seventh lens element to a maximum effective radius position of the object-side surface of the seventh lens element as the imaging optical lens assembly is in the first state is SAG7R1L, a displacement in parallel with the optical axis from an axial vertex of the image-side surface of the seventh lens element to a maximum effective radius position of the image-side surface of the seventh lens element as the imaging optical lens assembly is in the first state is SAG7R2L, a distance in parallel with the optical axis between a maximum effective radius position of the object-side surface of the sixth lens element and a maximum effective radius position of the image-side surface of the sixth lens element as the imaging optical lens assembly is in the first state is ET6L, a central thickness of the sixth lens element is CT6, and the following conditions are satisfied:
$$\begin{matrix}- 0.8 < SAG 7 R 1 L / SAG 7 R 2 L << 3.8 ; and \\ 0.3 < ET 6 L / CT 6 < 2.7 .\end{matrix}$$

10. The imaging optical lens assembly of claim 1, wherein when an imaged object is located at a finite object distance, the imaging optical lens assembly is in a second state; and
wherein when an imaged object is moved from an infinite object distance to a finite object distance within 150 mm, some of the seven lens elements in the imaging optical lens assembly are moved along an optical axis for focus adjustment, and the imaging optical lens assembly is transitioned from the first state to the second state.

11. The imaging optical lens assembly of claim 1, further comprising a reflective element located along the optical path between an imaged object and the first lens element.

12. An image capturing unit comprising:
the imaging optical lens assembly of claim 1; and
an image sensor disposed on the image surface of the imaging optical lens assembly.

13. An electronic device comprising:
the image capturing unit of claim 12.

14. An imaging optical lens assembly comprising seven lens elements, the seven lens elements being, in order from an object side to an image side along an optical path, a first lens element, a second lens element, a third lens element, a fourth lens element, a fifth lens element, a sixth lens element and a seventh lens element, and each of the seven lens elements having an object-side surface facing toward the object side and an image-side surface facing toward the image side;
wherein the first lens element has positive refractive power, the object-side surface of the first lens element is convex in a paraxial region thereof, the fifth lens element has negative refractive power, the object-side surface of the fifth lens element is concave in a paraxial region thereof, the image-side surface of the fifth lens element is convex in a paraxial region thereof, and the image-side surface of the fifth lens element has at least one inflection point; and
wherein a sum of central thicknesses of all lens elements of the imaging optical lens assembly is ΣCT, a sum of axial distances between each of all adjacent lens elements of the imaging optical lens assembly is ΣAT, an axial distance between the object-side surface of the second lens element and an image surface is Dr3i, an axial distance between the image-side surface of the seventh lens element and the image surface is BL, a curvature radius of the image-side surface of the third lens element is R6, a curvature radius of the image-side surface of the fourth lens element is R8, a focal length of the first lens element is f1, a focal length of the fourth lens element is f4, a focal length of the fifth lens element is f5, and the following conditions are satisfied:
$$\begin{matrix}0.6 < \sum CT / \sum AT < 1.58 ; \\ 1.1 < Dr 3 i / BL < 3.5 ; \\ - 5. < R 6 / R 8 < - 0.05 ; and \\ - 2.5 < ( f 4 + f 5 ) f 1 < 1.2 .\end{matrix}$$

15. The imaging optical lens assembly of claim 14, wherein the fourth lens element has positive refractive power, and the image-side surface of the third lens element is concave in a paraxial region thereof.

16. The imaging optical lens assembly of claim 14, wherein at least one of the object-side surface and the image-side surface of at least one of the first lens element, the second lens element, the third lens element, the fourth lens element and the fifth lens element has at least one critical point in an off-axis region thereof.

17. The imaging optical lens assembly of claim 14, wherein the object-side surface of the fifth lens element has at least one inflection point; and
wherein an axial distance between the first lens element and the second lens element is T12, a central thickness of the first lens element is CT1, and the following condition is satisfied:
$$0.05 < T 12 / CT 1 < 6. .$$

18. The imaging optical lens assembly of claim 14, wherein an axial distance between the first lens element and the second lens element is T12, an axial distance between the third lens element and the fourth lens element is T34, an axial distance between the fourth lens element and the fifth lens element is T45, a focal length of the imaging optical lens assembly is f, the axial distance between the image-side surface of the seventh lens element and the image surface is BL, and the following conditions are satisfied:
$$\begin{matrix}0. \leq T 34 / T 45 < 3.5 ; and \\ 0. \leq T 12 / f + T 12 / BL < 1.25 .\end{matrix}$$

19. The imaging optical lens assembly of claim 14, wherein when an imaged object is located at an infinite object distance, the imaging optical lens assembly is in a first state; and
wherein the curvature radius of the image-side surface of the fourth lens element is R8, a curvature radius of the image-side surface of the fifth lens element is R10, a focal length of the imaging optical lens assembly in the first state is fL, and the following condition is satisfied:
$$0.2 < ( \vert R 8 \vert + \vert R 10 \vert ) / fL < 2. .$$

20. The imaging optical lens assembly of claim 14, wherein the focal length of the first lens element is f1, a focal length of the second lens element is f2, the focal length of the fourth lens element is f4, the focal length of the fifth lens element is f5, and the following conditions are satisfied:
$$\begin{matrix}- 2. < f 1 / f 2 < 6. ; and \\ - 1.7 < ( f 4 + f 5 ) / f 1 < 0.7 .\end{matrix}$$

21. The imaging optical lens assembly of claim 14, wherein an axial distance between the object-side surface of the first lens element and the image surface is TL, a maximum image height of the imaging optical lens assembly is ImgH, and the following condition is satisfied:
$$3.6 < TL / ImgH < 4.8 .$$

22. The imaging optical lens assembly of claim 14, wherein a maximum field of view of the imaging optical lens assembly is FOV, and the following condition is satisfied:
$$15. degrees \leq FOV \leq 40. degrees .$$

23. The imaging optical lens assembly of claim 22, further comprising two reflective elements, wherein one of the two reflective elements is located along the optical path between an imaged object and the first lens element, and other of the two reflective elements is located along the optical path between the seventh lens element and the image surface.

24. The imaging optical lens assembly of claim 14, wherein when an imaged object is located at an infinite object distance, the imaging optical lens assembly is in a first state; when an imaged object is located at a finite object distance, the imaging optical lens assembly is in a second state; and
wherein when an imaged object is moved from an infinite object distance to a finite object distance within 100 mm, some of the seven lens elements in the imaging optical lens assembly are moved along an optical axis for focus adjustment, and the imaging optical lens assembly is transitioned from the first state to the second state.

25. The imaging optical lens assembly of claim 24, wherein a focal length of the imaging optical lens assembly in the first state is fL, a focal length of the imaging optical lens assembly in the second state is fS, and the following condition is satisfied:
$$1.1 < fL / fS < 1.8 .$$

26. The imaging optical lens assembly of claim 14, wherein when an imaged object is located at an infinite object distance, the imaging optical lens assembly is in a first state; and
wherein a sum of distances in parallel with an optical axis between a maximum effective radius position of the object-side surface and a maximum effective radius position of the image-side surface of each lens element of the imaging optical lens assembly as the imaging optical lens assembly is in the first state is ΣETL, the sum of central thicknesses of all lens elements of the imaging optical lens assembly is λCT, and the following condition is satisfied:
$$0.4 < \sum ETL / \sum CT < 1.2 .$$

27. The imaging optical lens assembly of claim 14, wherein when an imaged object is located at an infinite object distance, the imaging optical lens assembly is in a first state; and
wherein a distance in parallel with an optical axis between a maximum effective radius position of the object-side surface of the seventh lens element and a maximum effective radius position of the image-side surface of the seventh lens element as the imaging optical lens assembly is in the first state is ET7L, a central thickness of the seventh lens element is CT7, a maximum effective radius of the image-side surface of the sixth lens element as the imaging optical lens assembly is in the first state is Y6R2L, a maximum effective radius of the object-side surface of the seventh lens element as the imaging optical lens assembly is in the first state is Y7R1L, and the following conditions are satisfied:
$$\begin{matrix}0.3 < ET 7 L / CT 7 < 2.2 ; and \\ 0.7 < Y 7 R 1 L / Y 6 R 2 L < 1.5 .\end{matrix}$$

28. The imaging optical lens assembly of claim 14, wherein when an imaged object is located at an infinite object distance, the imaging optical lens assembly is in a first state; and
wherein the sum of central thicknesses of all lens elements of the imaging optical lens assembly is ΣCT, a central thickness of the first lens element is CT1, the sum of axial distances between each of all adjacent lens elements of the imaging optical lens assembly is ΣAT, an axial distance between the first lens element and the second lens element is T12, the axial distance between the object-side surface of the second lens element and the image surface is Dr3i, the axial distance between the image-side surface of the seventh lens element and the image surface is BL, a focal length of the imaging optical lens assembly in the first state is fL, the focal length of the first lens element is f1, the focal length of the fourth lens element is f4, the focal length of the fifth lens element is f5, a composite focal length of the second lens element, the third lens element and the fourth lens element is f234, the curvature radius of the image-side surface of the third lens element is R6, the curvature radius of the image-side surface of the fourth lens element is R8, and the following conditions are satisfied:
$$\begin{matrix}0.7 \leq \sum CT / \sum AT \leq 1.31 ; \\ 1.91 \leq Dr 3 i / BL \leq 2.74 ; \\ 1.2 \leq fL / f 234 \leq 1.84 ; \\ 0.18 \leq T 12 / CT 1 \leq 4.49 ; \\ - 1.7 \leq R 6 / R 8 \leq - 0.24 ; and \\ - 0.73 \leq ( f 4 + f 5 ) / f 1 \leq 0.28 .\end{matrix}$$
